(19) United States
(12) Patent Application Publication
(10) Pub. No.: US 2021/0361389 A1
(43) Pub. Date: Nov. 25, 2021

(54) HYDRATED ORTHODONTIC ARTICLES, KITS, AND METHODS OF MAKING SAME

(71) Applicant: 3M INNOVATIVE PROPERTIES COMPANY, St. Paul, MN (US)

(72) Inventors: Benjamin C. Mac Murray, St. Paul, MN (US); Saswata Chakraborty, Cottage Grove, MN (US); John M. Riedesel, San Jose, CA (US); Thomas P. Klun, Lakeland, MN (US); Chad M. Amb, Roberts, WI (US); Karl J.L. Geisler, St. Paul, MN (US); Zeba Parkar, Marietta, GA (US); Adrian S. Eckert, Herrsching (DE); Mark T. Gibson, Stillwater, MN (US); Tianyu Wu, St. Paul, MN (US)

(21) Appl. No.: 17/052,536

(22) PCT Filed: Jun. 25, 2019
(86) PCT No.: PCT/IB2019/055361

§ 371 Date: Nov. 3, 2020

Related U.S. Application Data
(63) Continuation-in-part of application No. PCT/US2018/062074, filed on Nov. 20, 2018.
Application No. PCT/US2018/062074 is a continuation-in-part of application No. PCT/US2018/062085, filed on Nov. 20, 2018.
Application No. PCT/US2018/062085 is a continuation-in-part of application No. PCT/US2019/033241, filed on May 21, 2019.
Application No. PCT/US2019/033241 is a continuation-in-part of application No. PCT/US2019/033252, filed on May 21, 2019.
(60) Provisional application No. 62/692,456, filed on Jun. 29, 2018.
(60) Provisional application No. 62/692,466, filed on Jun. 29, 2018.
(60) Provisional application No. 62/736,027, filed on Sep. 25, 2018.
(60) Provisional application No. 62/736,031, filed on Sep. 25, 2018.
(60) Provisional application No. 62/769,081, filed on Nov. 19, 2018.
(60) Provisional application No. 62/769,305, filed on Nov. 19, 2018.
(60) Provisional application No. 62/769,375, filed on Nov. 19, 2018.
(60) Provisional application No. 62/769,421, filed on Nov. 19, 2018.
(60) Provisional application No. 62/769,434, filed on Nov. 19, 2018.
(60) Provisional application No. 62/798,083, filed on Jan. 29, 2019.
(60) Provisional application No. 62/850,804, filed on May 21, 2019.

(51) Int. Cl. A61C 7/08; B33Y 10/00; B33Y 40/20; B33Y 80/00; B29C 64/124; B29C 64/35; B29C 71/00

(52) U.S. Cl. CPC A61C 7/08; B33Y 10/00; B33Y 40/20; B33Y 30/00; B29C 64/124; B29C 64/35; B29C 71/0009; B33Y 80/00

(57) ABSTRACT

The present disclosure provides methods of making a hydrated orthodontic article is provided. One method includes a) providing a photopolymerizable composition; b) selectively curing the photopolymerizable composition using actinic radiation to form an article in the shape of an orthodontic article having a plurality of layers of at least one photopolymerized polymer; and c) exposing the article to water by submersion in water, thereby hydrating the article. A sheet of the at least one photopolymerized polymer has a bending modulus when hydrated of 100 MPa or greater and 2200 MPa or less. Another method includes exposing the orthodontic article to water vapor and hermetically sealing the hydrated orthodontic article in a container. Hydrated orthodontic articles are also provided, including an orthodontic article that is prepared according to one of the methods. The present disclosure further provides kits, including an orthodontic article and instructions for exposing the orthodontic article to water to hydrate the orthodontic article, as well as including a hydrated orthodontic article hermetically sealed in a container.

### TECHNICAL FIELD

The present disclosure broadly relates to orthodontic articles and methods of making the orthodontic articles, such as additive manufacturing methods.

### BACKGROUND

The field of orthodontics relates to the supervision, guidance and correction of teeth towards proper positions in the oral cavity. Various orthodontic devices and treatment methods have been developed to address dental alignment issues. Traditional approaches generally involve the application of forces to move teeth into a proper bite configuration, or occlusion. Dental aligners and other dental articles have been produced using polymer-based components. In some such examples, the polymer-based components may be relatively clear or transparent to provide a less conspicuous appearance than a metal, ceramic, or similar type of device.

### SUMMARY

In a first aspect, a method of making a hydrated orthodontic article is provided. The method includes a) providing a photopolymerizable composition; b) selectively curing the photopolymerizable composition using actinic radiation to form an article in the shape of an orthodontic article having a plurality of layers of at least one photopolymerized polymer; and c) exposing the article to water by submersion in water, thereby hydrating the article. A sheet of the at least one photopolymerized polymer has a bending modulus when hydrated of 100 MPa or greater and 2200 MPa or less.

In a second aspect, another method of making a hydrated orthodontic article is provided. The method includes a) providing a photopolymerizable composition; b) selectively curing the photopolymerizable composition using actinic radiation to form an article in the shape of an orthodontic article having a plurality of layers of at least one photopolymerized polymer; c) exposing the article to water vapor, thereby hydrating the article; and d) hermetically sealing the hydrated orthodontic article in a container. A sheet of the at least one photopolymerized polymer has a bending modulus when hydrated of 100 MPa or greater and 2200 MPa or less.

In a third aspect, a hydrated orthodontic article is provided. The hydrated orthodontic article is prepared by the method according to the first aspect or the second aspect.

In a fourth aspect, another orthodontic article is provided. The orthodontic article includes a) a plurality of layers of at least one photopolymerized polymer in the shape of an orthodontic article; and b) water contained in the hydrated orthodontic article in an amount of 0.2 wt. % or greater, based on the total mass of the hydrated orthodontic article. A sheet of the at least one photopolymerized polymer has a bending modulus when hydrated of 100 MPa or greater and 2200 MPa or less.

In a fifth aspect, a kit is provided. The kit includes a) a container; b) an orthodontic article disposed in the container; and c) instructions for exposing the orthodontic article to water to hydrate the orthodontic article. The orthodontic article includes a plurality of layers of at least one photopolymerized polymer in the shape of an orthodontic article. A sheet of the at least one photopolymerized polymer has a bending modulus when hydrated of 100 MPa or greater and 2200 MPa or less.

In a sixth aspect, another kit is provided. The kit includes a) a container; and b) a hydrated orthodontic article disposed in the container, wherein the container is hermetically sealed. The hydrated orthodontic article includes a plurality of layers of at least one photopolymerized polymer in the shape of an orthodontic article. A sheet of the at least one photopolymerized polymer has a bending modulus when hydrated of 100 MPa or greater and 2200 MPa or less.

It has been discovered that pre-hydrating photopolymerized (e.g., crosslinked) polymers (e.g., rectangular test articles), according to at least certain embodiments of this disclosure resulted in exhibiting decreased modulus (e.g., bending or initial relaxation modulus) within a desirable range, as compared to the same materials that were not pre-hydrated. In some select embodiments, pre-hydration to a plateau of water content of the material can be achieved in under 6 hours, 5, 4, or 3 hours. In some embodiments, an advantage of pre-hydrating an orthodontic article is that it may make the orthodontic article easier to insert in a patient's mouth, and potentially also easier to remove.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

FIG. 1 is a flowchart of a process for building an article using the photopolymerizable compositions disclosed herein.

FIG. 2 is a generalized schematic of a stereolithography apparatus.

FIG. 3 is an isometric view of a printed orthodontic aligner, according to one embodiment of the present disclosure.

FIG. 4 is a flowchart of a process for manufacturing a printed orthodontic appliance according to the present disclosure.

FIG. 5 is a generalized schematic of an apparatus in which radiation is directed through a container.

FIG. 6 is a block diagram of a generalized system 600 for additive manufacturing of an article.

FIG. 7 is a block diagram of a generalized manufacturing process for an article.

FIG. 8 is a high-level flow chart of an exemplary article manufacturing process.

FIG. 9 is a high-level flow chart of an exemplary article additive manufacturing process.

FIG. 10 is a schematic front view of an exemplary computing device 1000.

FIG. 11 is a graph of stress-strain curves for two different materials.

While the above-identified figures set forth several embodiments of the disclosure other embodiments are also contemplated, as noted in the description. The figures are not necessarily drawn to scale. In all cases, this disclosure presents the invention by way of representation and not limitation. It should be understood that numerous other modifications and embodiments can be devised by those skilled in the art, which fall within the scope and spirit of the principles of the invention.

### DETAILED DESCRIPTION OF ILLUSTRATIVE EMBODIMENTS

As used herein, “aliphatic group” means a saturated or unsaturated linear, branched, or cyclic hydrocarbon group. This term is used to encompass alkyl, alkenyl, and alkynyl groups, for example.

As used herein, “alkyl” means a linear or branched, cyclic or acyclic, saturated monovalent hydrocarbon having from one to thirty-two carbon atoms, e.g., methyl, ethyl, 1-propyl, 2-propyl, pentyl, and the like.

As used herein, “alkylene” means a linear saturated divalent hydrocarbon having from one to twelve carbon atoms or a branched saturated divalent hydrocarbon radical having from three to twelve carbon atoms, e.g., methylene, ethylene, propylene, 2-methylpropylene, pentylene, hexylene, and the like.

As used herein, each of “alkenyl” and “ene” refers to a monovalent linear or branched unsaturated aliphatic group with one or more carbon-carbon double bonds, e.g., vinyl.

As used herein, the term “arylene” refers to a divalent group that is carbocyclic and aromatic. The group has one to five rings that are connected, fused, or combinations thereof. The other rings can be aromatic, non-aromatic, or combinations thereof. In some embodiments, the arylene group has up to 5 rings, up to 4 rings, up to 3 rings, up to 2 rings, or one aromatic ring. For example, the arylene group can be phenylene.

As used herein, “aralkylene” refers to a divalent group that is an alkylene group substituted with an aryl group or an alkylene group attached to an arylene group. The term “alkarylene” refers to a divalent group that is an arylene group substituted with an alkyl group or an arylene group attached to an alkylene group. Unless otherwise indicated, for both groups, the alkyl or alkylene portion typically has from 1 to 20 carbon atoms, 1 to 10 carbon atoms, 1 to 6 carbon atoms, or 1 to 4 carbon atoms. Unless otherwise indicated, for both groups, the aryl or arylene portion typically has from 6 to 20 carbon atoms, 6 to 18 carbon atoms, 6 to 16 carbon atoms, 6 to 12 carbon atoms, or 6 to 10 carbon atoms.

As used herein, “aqueous solution” refers to a composition that comprises one or more components dissolved in a solvent that is at least 50 volume percent water.

As used herein, the term “essentially free” in the context of a composition being essentially free of a component, refers to a composition containing less than 1% by weight (wt. %), 0.5 wt. % or less, 0.25 wt. % or less, 0.1 wt. % or less, 0.05 wt. % or less, 0.001 wt. % or less, or 0.0001 wt. % or less of the component, based on the total weight of the composition.

As used herein, the term “glass transition temperature” (T_{g}), of a polymer refers to the transition of a polymer from a glassy state to a rubbery state and can be measured using Differential Scanning Calorimetry (DSC), such as at a heating rate of 10° C. per minute in a nitrogen stream. When the T_{g} of a monomer is mentioned, it is the T_{g} of a homopolymer of that monomer. The homopolymer must be sufficiently high molecular weight such that the T_{g} reaches a limiting value, as it is generally appreciated that a T_{g} of a homopolymer will increase with increasing molecular weight to a limiting value. The homopolymer is also understood to be substantially free of moisture, residual monomer, solvents, and other contaminants that may affect the T_{g}. A suitable DSC method and mode of analysis is as described in Matsumoto, A. et. al., J. Polym. Sci. A., Polym. Chem. 1993, 31, 2531-2539.

As used herein, the terms “hardenable” refers to a material that can be cured or solidified, e.g., by heating to remove solvent, heating to cause polymerization, chemical crosslinking, radiation-induced polymerization or crosslinking, or the like.

As used herein, “curing” means the hardening or partial hardening of a composition by any mechanism, e.g., by heat, light, radiation, e-beam, microwave, chemical reaction, or combinations thereof.

As used herein, “cured” refers to a material or composition that has been hardened or partially hardened (e.g., polymerized or crosslinked) by curing.

As used herein, “integral” refers to being made at the same time or being incapable of being separated without damaging one or more of the (integral) parts.

As used herein, “liquid” refers to the state of matter that is not solid or gas, which has a definite volume and an indefinite shape. Liquids encompass emulsions, suspensions, solutions, and pure components, and exclude (e.g., solid) powders and particulates.

As used herein, the term “(meth)acrylate” is a shorthand reference to acrylate, methacrylate, or combinations thereof, “(meth)acrylic” is a shorthand reference to acrylic, methacrylic, or combinations thereof, and “(meth)acryl” is a shorthand reference to acryl and methacryl groups. “Acryl” refers to derivatives of acrylic acid, such as acrylates, methacrylates, acrylamides, and methacrylamides. By “(meth)acryl” is meant a monomer or oligomer having at least one acryl or methacryl groups, and linked by an aliphatic segment if containing two or more groups. As used herein, “(meth)acrylate-functional compounds” are compounds that include, among other things, a (meth)acrylate moiety.

The term “mass inertial force” as referred to herein may be specified as force per unit mass and therefore may be specified in the unit m/s². Further, the mass inertial force can be expressed by the G-force which is a factor of the acceleration of gravity. For the purposes of the present specification the acceleration of gravity is 9.81 m/s². Consequently, for example a mass inertial force of 9.81 m/s² can be expressed as 1 G.

As used herein, “polymerizable composition” means a hardenable composition that can undergo polymerization upon initiation (e.g., free-radical polymerization initiation). Typically, prior to polymerization (e.g., hardening), the polymerizable composition has a viscosity profile consistent with the requirements and parameters of one or more 3D printing systems. In some embodiments, for instance, hardening comprises irradiating with actinic radiation having sufficient energy to initiate a polymerization or cross-linking reaction. For instance, in some embodiments, ultraviolet (UV) radiation, e-beam radiation, or both, can be used. When actinic radiation can be used, the polymerizable composition is referred to as a “photopolymerizable composition”.

As used herein, a “resin” contains all polymerizable components (monomers, oligomers and/or polymers) being present in a hardenable composition. The resin may contain only one polymerizable component compound or a mixture of different polymerizable compounds.

As used herein, the “residue of a diisocyanate”, is the structure of the diisocyanate after the —NCO groups are removed. For example, 1,6-hexamethylene diisocyanate has the structure OCN—(CH₂)₆—NCO, and its residue, R_{di}, after removal of the isocyanate groups is —(CH₂)₆—.

As used herein, the “residue of a polycarbonate polyol”, is the structure of the polycarbonate polyol after the —OH groups are removed. For example, a polycarbonate diol having the structure H(O—R₁—O—C(═O))ₘ—O—R₂—OH, has a residue, (e.g., R_{dOH}, R_{dOH1}, or R_{dOH2}) after removal of the end —OH groups, of —R₁—O—C(═O)—(O—R₁—O—C(═O))ₘ₋₁—O—R₂—, wherein each R₁ in each repeat unit and R₂ is independently an aliphatic, cycloaliphatic, or aliphatic/cycloaliphatic alkylene group and m is 2 to 23. Examples of R₁ and R₂ groups include —CH₂—CH₂—CH(CH₃)—CH₂—CH₂—, —CH₂—C(CH₃)₂—CH₂—, —(CH₂)₆—, —(CH₂)₉—, and —(CH₂)₁₀—.

As used herein, the “residue of a (meth)acrylated diol” is the structure of the (meth)acrylated diol after the —OH groups are removed. For example, a (meth)acrylated diol having the structure HO-Q₁(A)-OH has a residue, R_{AD}, after removal of the end —OH groups, of -Q₁(A)-, wherein Q₁ is a straight or branched chain or cycle-containing aliphatic polyvalent connecting group and A is a (meth)acryl functional group of the formula —XC(═O)C(R₁)═CH₂, wherein X is O, S, or NR₄, R₄ is H or alkyl of 1 to 4 carbon atoms, and R₁ is a lower alkyl of 1 to 4 carbon atoms or H. An example of a methacrylated diol is

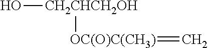

and an example of R_{AD is}

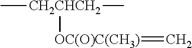

As used herein, the “residue of a polyester polyol” is the structure of the polyester polyol after the —OH groups are removed. For example, a polyester polyol having the structure H[O—R₃—O—C(═O)—R₄—C(═O)]ₘ₁—O—R₃—OH, has a residue, (e.g., R_{dOH2} or R_{dOH3}) after removal of the end —OH groups, of —R₃—O—C(═O)—R₄—C(═O)—[O—R₃—O—C(═O)—R₄—C(═O)]ₘ₋₁—O—R₃—, wherein R₃ and R₄ are independently straight or branched chain or cycle-containing alkylene, groups, that optionally include heteroatoms, such as oxygen. R₃ and R₄ independently comprise 2 to 40 carbon atoms. The subscript “m1” is typically at least 2, 3, 4, 5, 6, or 7.

As used herein, “thermoplastic” refers to a polymer that flows when heated sufficiently above its glass transition point and become solid when cooled.

As used herein, “thermoset” refers to a polymer that permanently sets upon curing and does not flow upon subsequent heating. Thermoset polymers are typically crosslinked polymers.

As used herein, “water-resistant coating” refers to a coating that acts as a barrier to water, reducing or substantially preventing the ingress of water through the coating.

As used herein, “occlusal” means in a direction toward the outer tips of the patient's teeth or where the upper and lower teeth come together; “facial” or “labial” means in a direction toward the patient's lips or cheeks; and “lingual” means in a direction toward the patient's tongue.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a”, “an”, and “the” are not intended to refer to only a singular entity, but include the general class of which a specific example may be used for illustration. The terms “a”, “an”, and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and preferably by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

In a first aspect, the present disclosure provides a method of making a hydrated orthodontic article. The method comprises:
a) providing a photopolymerizable composition;
b) selectively curing the photopolymerizable composition using actinic radiation to form an article in the shape of an orthodontic article comprising a plurality of layers of at least one photopolymerized polymer; and
c) exposing the article to water by submersion in water, thereby hydrating the article,
   wherein a sheet of the at least one photopolymerized polymer has a bending modulus when hydrated of 100 MPa or greater and 2200 MPa or less.

In a second aspect, the present disclosure provides another method of making a hydrated orthodontic article. The method comprises:
a) providing a photopolymerizable composition;
b) selectively curing the photopolymerizable composition using actinic radiation to form an article in the shape of an orthodontic article having a plurality of layers of at least one photopolymerized polymer;
c) exposing the article to water vapor, thereby hydrating the article; and
d) hermetically sealing the hydrated orthodontic article in a container,

wherein a sheet of the at least one photopolymerized polymer has a bending modulus when hydrated of 100 MPa or greater and 2200 MPa or less.

In some embodiments, the method further comprises, prior to step c), e) moving the article and thereby generating a mass inertial force in uncured photopolymerizable composition disposed on the article, thereby forming a coating layer of uncured photopolymerizable composition on the article, wherein the mass inertial force is generated using a centrifuge, a shaker, or a mixer that spins along one or more axes. Suitable ways of generating a mass inertial force are described, for instance, in co-owned application Ser. No. ______ (Docket No. 81682), incorporated herein by reference in its entirety. For instance, the source of the mass inertial force may be generated using a centrifuge, a shaker, or a mixer that spins along one or more axes. In some embodiments, the moving of the object is a rotation or spinning of the object. Accordingly, the mass inertial force may be generated by a centrifugal force. One suitable mixer that spins along more than one axis is a dual asymmetric centrifugal mixer, such as the DAC 400 FVZ available from Flacktek, Landrum, S.C. A dual asymmetric centrifugal mixer provides simultaneous dual axis spinning that automatically reorients the article during spinning, which tends to pull uncured composition out of concave features of the article in a short period of time (e.g., 20, 15, or 10 seconds or less).

Optionally, the method further comprises, prior to step c), f) removing excess first composition from the article by washing with at least one solvent. Suitable solvents include, for instance and without limitation, includes propylene carbonate, isopropanol, methanol, di(ethylene glycol) ethyl ether, tripropylene glycol monomethyl ether, diethylene glycol monobutyl ether, a blend of dipropylene glycol monomethyl ether with [2-(2-methoxymethylethoxy)methylethoxy]propanol, and combinations thereof.

In some embodiments, the method further comprises g) subjecting the article to actinic radiation to photopolymerize uncured photopolymerizable composition before step c) and/or h) subjecting the article to heat before step c) and during, and/or after step g) if step g) is performed. For instance, heating the article at any point may be used to decrease the viscosity of uncured photopolymerizable composition present on the article, as well as removing low viscosity components.

Typically, the exposing to water comprises contacting the article with water in liquid form or in vapor form. In some embodiments, the water is liquid, for instance deionized water, distilled water, filtered water, tap water, or an aqueous solution (e.g., water comprising a buffer). When the water is liquid, the article is preferably submersed in the water (e.g., all surfaces of the article are in contact with the water). When the water is vapor, the article is preferably contacted with atmosphere containing 50% or greater relative humidity (RH), 60%, 70%, 80%, 90%, 95%, 98%, 99%, or even 100% RH.

The temperature of the water (e.g., liquid or vapor) can vary, for instance the article can be exposed to water at a temperature of 20° C. or greater, 22° C., 25° C., 27° C., 30° C., 32° C., or 35° C. or greater; and 40° C. or less, 39° C., 38° C., 37° C., or 36° C. or less. In select embodiments, the article is exposed to water at a temperature of 37° C. or 22° C.

The article is usually exposed to water for 0.5 hours or more, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, or 36 hours or more. In certain embodiments, the article is exposed to water for 72 hours or less, 72, 70, 68, 66, 64, 62, 60, 58, 56, 54, 52, 50, 48, 46, 44, 42, or 40 hours or less. It has been discovered that articles according to certain embodiments of the present disclosure take up water within a short period of time (e.g., 2 hours, 4, 6, 8, or 10 hours), then absorb little additional water. Stated another way, in some embodiments, a water content of the hydrated article reaches a plateau after exposure to water for 20 hours or less, 18 hours, 16 hours, 14 hours, 12 hours 10 hours, 8 hours, 6 hours, 4 hours, or 2 hours or less. By “plateau”, it is meant that the water content of a hydrated article does not increase by more than 10%, 5%, or 2% upon additional exposure to water beyond the plateau exposure time.

The hydrated orthodontic article often contains 0.2 weight percent (wt. %) or more water, based on the total mass of the hydrated orthodontic article, 0.3 wt. %, 0.4 wt. %, 0.5 wt. %, 0.6 wt. %, 0.7 wt. %, 0.8 wt. %, 0.9 wt. %, 1.0 wt. %, 1.2 wt. %, 1.4 wt. %, 1.6 wt. %, 1.8 wt. %, 2 wt. %, 2.2 wt. %, 2.4 wt. %, 2.6 wt. %, 2.8 wt. %, 3 wt. %, 3.2 wt. %, 3.4 wt. %, 3.6 wt. %, 3.8 wt. %, 4 wt. %, 4.2 wt. %, 4.4 wt. %, 4.6 wt. %, 4.8 wt. %, or 5 wt. % or more, based on the total mass of the hydrated orthodontic article. Generally, the hydrated orthodontic article contains 8 wt. % or less water, based on the total mass of the hydrated orthodontic article, 7.8 wt. %, 7.6 wt. %, 7.4 wt. %, 7.2 wt. %, 7.0 wt. %, 6.8 wt. %, 6.6 wt. %, 6.4 wt. %, 6.2 wt. %, 6.0 wt. %, 5.8 wt. %, 5.6 wt. %, or 5.4 wt. % or less water, based on the total mass of the hydrated orthodontic article.

It has been discovered that hydration of orthodontic articles according to at least certain embodiments of the disclosure is comparable when hydrated via submersion in (e.g., liquid) water or aqueous solution or via exposure to water vapor, as indicated in the Examples below. The use of water vapor for hydration may provide less variable measurements of hydration than the use of liquid water, though, due to the need to remove excess liquid water from an article surface prior to taking a measurement.

### Fabricating an Orthodontic Article

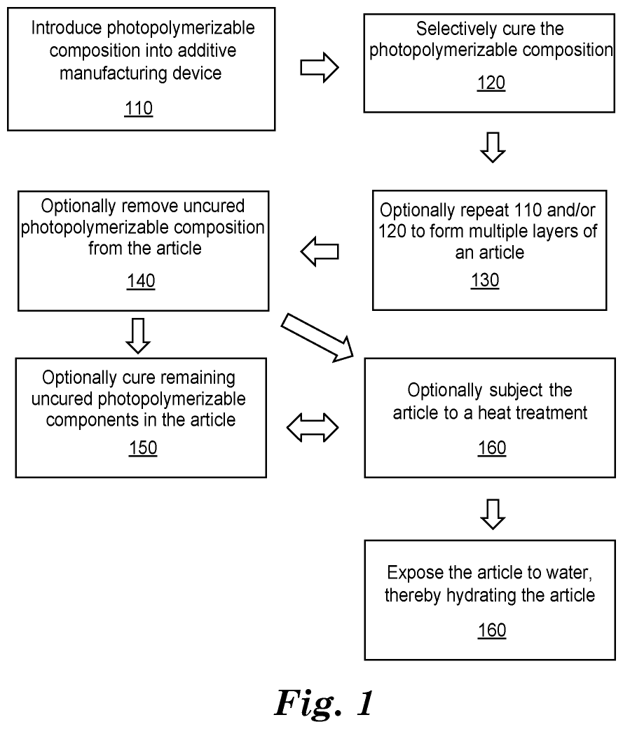

A generalized method 100 for creating three-dimensional articles from photopolymerizable compositions is illustrated in FIG. 1. Each step in the method will be discussed in greater detail below. First, in Step 110 the desired photopolymerizable composition is provided and introduced into a reservoir, cartridge, or other suitable container for use by or in an additive manufacturing device. The additive manufacturing device selectively cures the photopolymerizable composition according to a set of computerized design instructions in Step 120. The term “selectively cure” as used herein refers to the location(s) of photopolymerizable composition in the container that is subjected to actinic radiation, to cure selected area(s) of the photopolymerizable composition. In Step 130, Step 110 and/or Step 120 is repeated to form multiple layers to create the article comprising a three-dimensional structure (i.e., an orthodontic article). Uncured photopolymerizable composition is optionally removed in Step 140. Also optionally, the article is subjected to additional curing to polymerize remaining uncured photopolymerizable components in the article in Step 150, and further optionally, the article is subjected to a heat treatment in Step 160. In some embodiments, Step 160 is performed before, during, and/or after Step 150. In Step 170, the article is exposed to water, thereby hydrating the article.

Methods of printing a three-dimensional article or object described herein can include forming the article from a plurality of layers of a photopolymerizable composition described herein in a layer-by-layer manner. Further, the layers of a build material composition can be deposited according to an image of the three-dimensional article in a computer readable format. In some or all embodiments, the photopolymerizable composition is deposited according to preselected computer aided design (CAD) parameters (e.g., a data file).

Additionally, it is to be understood that methods of manufacturing a 3D article described herein can include so-called “stereolithography/vat polymerization” 3D printing methods. Other techniques for three-dimensional manufacturing are known, and may be suitably adapted to use in the applications described herein. More generally, three-dimensional fabrication techniques continue to become available. All such techniques may be adapted to use with photopolymerizable compositions described herein, provided they offer compatible fabrication viscosities and resolutions for the specified article properties. Fabrication may be performed using any of the fabrication technologies described herein, either alone or in various combinations, using data representing a three-dimensional object, which may be reformatted or otherwise adapted as necessary for a particular printing or other fabrication technology.

It is entirely possible to form a 3D article from a photopolymerizable composition described herein using vat polymerization (e.g., stereolithography). For example, in some cases, a method of printing a 3D article comprises retaining a photopolymerizable composition described herein in a fluid state in a container and selectively applying energy to the photopolymerizable composition in the container to solidify at least a portion of a fluid layer of the photopolymerizable composition, thereby forming a hardened layer that defines a cross-section of the 3D article. Additionally, a method described herein can further comprise raising or lowering the hardened layer of photopolymerizable composition to provide a new or second fluid layer of unhardened photopolymerizable composition at the surface of the fluid in the container, followed by again selectively applying energy to the photopolymerizable composition in the container to solidify at least a portion of the new or second fluid layer of the photopolymerizable composition to form a second solidified layer that defines a second cross-section of the 3D article. Further, the first and second cross-sections of the 3D article can be bonded or adhered to one another in the z-direction (or build direction corresponding to the direction of raising or lowering recited above) by the application of the energy for solidifying the photopolymerizable composition. Moreover, selectively applying energy to the photopolymerizable composition in the container can comprise applying actinic radiation, such as UV radiation, visible radiation, or e-beam radiation, having a sufficient energy to cure the photopolymerizable composition. A method described herein can also comprise planarizing a new layer of fluid photopolymerizable composition provided by raising or lowering an elevator platform. Such planarization can be carried out, in some cases, by utilizing a wiper or roller or a recoater. Planarization corrects the thickness of one or more layers prior to curing the material by evening the dispensed material to remove excess material and create a uniformly smooth exposed or flat up-facing surface on the support platform of the printer.

It is further to be understood that the foregoing process can be repeated a selected number of times to provide the 3D article. For example, in some cases, this process can be repeated “n” number of times. Further, it is to be understood that one or more steps of a method described herein, such as a step of selectively applying energy to a layer of photopolymerizable composition, can be carried out according to an image of the 3D article in a computer-readable format. Suitable stereolithography printers include the Viper Pro SLA, available from 3D Systems, Rock Hill, S.C. and the Asiga PICO PLUS 39, available from Asiga USA, Anaheim Hills, Calif.

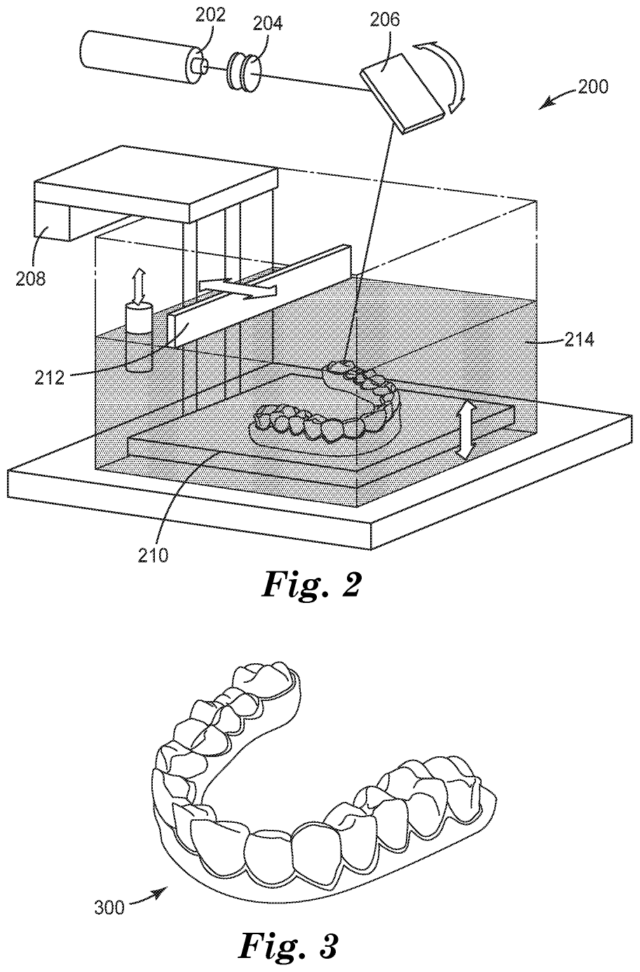

FIG. 2 shows an exemplary stereolithography apparatus (“SLA”) that may be used with the photopolymerizable compositions and methods described herein. In general, the SLA 200 may include a laser 202, optics 204, a steering lens 206, an elevator 208, a platform 210, and a straight edge 212, within a vat 214 filled with the photopolymerizable composition. In operation, the laser 202 is steered across a surface of the photopolymerizable composition to cure a cross-section of the photopolymerizable composition, after which the elevator 208 slightly lowers the platform 210 and another cross section is cured. The straight edge 212 may sweep the surface of the cured composition between layers to smooth and normalize the surface prior to addition of a new layer. In other embodiments, the vat 214 may be slowly filled with liquid resin while an article is drawn, layer by layer, onto the top surface of the photopolymerizable composition.

A related technology, vat polymerization with Digital Light Processing (“DLP”), also employs a container of curable polymer (e.g., photopolymerizable composition). However, in a DLP based system, a two-dimensional cross section is projected onto the curable material to cure the desired section of an entire plane transverse to the projected beam at one time. All such curable polymer systems as may be adapted to use with the photopolymerizable compositions described herein are intended to fall within the scope of the term “vat polymerization system” as used herein. In certain embodiments, an apparatus adapted to be used in a continuous mode may be employed, such as an apparatus commercially available from Carbon 3D, Inc. (Redwood City, Calif.), for instance as described in U.S. Pat. Nos. 9,205,601 and 9,360,757 (both to DeSimone et al.).

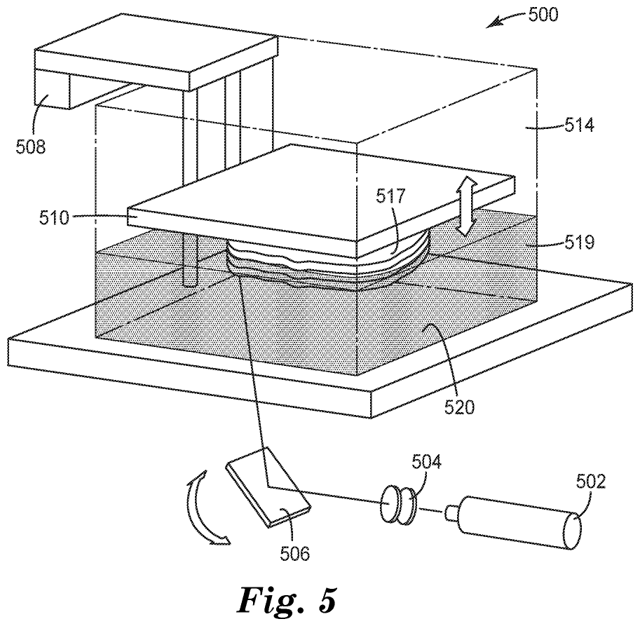

Referring to FIG. 5, a general schematic is provided of another SLA apparatus that may be used with photopolymerizable compositions and methods described herein. In general, the apparatus 500 may include a laser 502, optics 504, a steering lens 506, an elevator 508, and a platform 510, within a vat 514 filled with the photopolymerizable composition 519. In operation, the laser 502 is steered through a wall 520 (e.g., the floor) of the vat 514 and into the photopolymerizable composition to cure a cross-section of the photopolymerizable composition 519 to form an article 517, after which the elevator 508 slightly raises the platform 510 and another cross section is cured.

More generally, the photopolymerizable composition is typically cured using actinic radiation, such as UV radiation, e-beam radiation, visible radiation, or any combination thereof. The skilled practitioner can select a suitable radiation source and range of wavelengths for a particular application without undue experimentation.

In certain embodiments, the curing of layers of a photopolymerizable composition can leave evidence of the computer-readable data file of the image of the 3D article. For instance, a plurality of voxels in the layers of the article may be visible either to a human observer or under a microscope, evidencing the volume of polymeric material cured in a discrete three-dimensional space.

It is expected in certain embodiments of the present disclosure that the formed article obtained in Step 120 will shrink (i.e., reduce in volume) such that the dimensions of the article after (optional) Step 150 will be smaller than expected. For example, a cured article may shrink less than 5% in volume, less than 4%, less than 3%, less than 2%, or even less than 1% in volume, which is contrast to other compositions that provide articles that shrink about 6-8% in volume upon optional post curing. The amount of volume percent shrinkage will not typically result in a significant distortion in the shape of the final object. It is particularly contemplated, therefore, that dimensions in the digital representation of the eventual cured article may be scaled according to a global scale factor to compensate for this shrinkage. For example, in some embodiments, at least a portion of the digital article representation can be at least 101% of the desired size of the printed appliance, in some embodiments at least 102%, in some embodiments at least 104%, in some embodiments, at least 105%, and in some embodiments, at least 110%.

A global scale factor may be calculated for any given photopolymerizable composition formulation by creating a calibration part according to Steps 110 and 120 above. The dimensions of the calibration article can be measured prior to post curing.

After the 3D article has been formed, it is typically removed from the additive manufacturing apparatus and at least a portion of the uncured photopolymerizable composition is removed from the cured, solid state article (e.g., green body). Conventional methods of removing uncured photopolymerizable composition include rinsing, (e.g., an ultrasonic, or bubbling, or spray rinse in a solvent, which would dissolve a portion of the uncured photopolymerizable composition but not the solid state article. Suitable solvents include for instance, propylene carbonate, isopropanol, methanol, di(ethylene glycol) ethyl ether, tripropylene glycol monomethyl ether, diethylene glycol monobutyl ether, a blend of dipropylene glycol monomethyl ether with [2-(2-methoxymethylethoxy)methylethoxy]propanol, or any combination thereof. At this stage, the three-dimensional article typically has sufficient green strength for handling in the remaining optional steps of method 100.

In general, the three-dimensional article formed by initial additive manufacturing in Step 120, as discussed above, is not fully cured, by which is meant that not all of the photopolymerizable material in the composition has polymerized even after rinsing. Some uncured photopolymerizable material is typically removed from the surface of the printed article during a cleaning process. The article surface, as well as the bulk article itself, typically still retains uncured photopolymerizable material, suggesting further cure. Removing residual uncured photopolymerizable composition is particularly useful when the article is going to subsequently be post cured, to minimize uncured residual photopolymerizable composition from undesirably curing directly onto the article, for instance pooling in a concave shaped portion of the article.

Further curing can be accomplished by further irradiating with actinic radiation, heating, or both. Exposure to actinic radiation can be accomplished with any convenient radiation source, generally UV radiation, visible radiation, and/or e-beam radiation, for a time ranging from about 10 to over 60 minutes. Heating is generally carried out at a temperature in the range of about 75-150° C., for a time ranging from about 10 to over 60 minutes in an inert atmosphere. So called post cure ovens, which combine UV radiation and thermal energy, are particularly well suited for use in the post cure processes of Step 150 and/or Step 160. In general, post curing improves the mechanical properties and stability of the three-dimensional article relative to the same three-dimensional article that is not post cured.

Additionally, post processing of an article may include subjecting the article to vacuum, for a time of about 30 minutes to 24 hours, such as about 2 hours, either at ambient temperature or at an elevated temperature, e.g., in a vacuum oven set at a temperature of 50° C. or greater, 60° C., 80° C., 100° C., or even 120° C. or greater, such as up to 150° C. Vacuum treatment of an article is usually performed following any post curing processes, and may assist in decreasing the total amount of extractable components in the final article.

One particularly attractive opportunity for 3D printing is in the direct creation of orthodontic (e.g., clear tray) aligners. These aligners, also known as polymeric or shell appliances, are provided in a series and are intended to be worn in succession, over a period of months, in order to gradually move the teeth in incremental steps towards a desired target arrangement. Some types of orthodontic aligners have a row of tooth-shaped receptacles for receiving each tooth of the patient's dental arch, and the receptacles are oriented in slightly different positions from one appliance to the next in order to incrementally urge each tooth toward its desired target position by virtue of the resilient properties of the polymeric material. A variety of methods have been proposed in the past for manufacturing orthodontic aligners and other resilient appliances. Typically, positive dental arch models are fabricated for each dental arch using additive manufacturing methods such as stereolithography described above. Subsequently, a sheet of polymeric material is placed over each of the arch models and formed under heat, pressure and/or vacuum to conform to the model teeth of each model arch. The formed sheet is cleaned and trimmed as needed and the resulting arch-shaped appliance is shipped along with the desired number of other appliances to the treating professional.

Other orthodontic articles that may be prepared using additive manufacturing include retainers and splints. An aligner or other resilient appliance created directly by 3D printing would eliminate the need to print a mold of the dental arch and further thermoform the appliance. It also would allow new aligner designs and give more degrees of freedom in the treatment plan. Exemplary methods of direct printing orthodontic aligners and other resilient orthodontic apparatuses are set forth in PCT Publication Nos. WO2016/109660 (Raby et al.), WO2016/148960 (Cinader et al.), and WO2016/149007 (Oda et al.) as well as US Publication Nos. US2011/0091832 (Kim, et al.) US2013/0095446 (Kitching), WO2013/134031 (Lai et al.), and WO2016/148961 (Cinader et al.).

Orthodontic articles according to the present disclosure may comprise one or more various suitable polymers, such as a (meth)acryl polymer. For instance, in some embodiments, one or more photopolymerized polymers include a urethane (meth)acryl polymer. In some embodiments, one or more photopolymerized polymers include a polyalkylene oxide (meth)acryl polymer. In some embodiments, one or more photopolymerized polymers include a polyalkylene oxide urethane (meth)acryl polymer. In some embodiments, one or more photopolymerized polymers include a polyester urethane (meth)acryl polymer. In some embodiments, one or more photopolymerized polymers include a polycarbonate urethane (meth)acryl polymer. In some embodiments, one or more photopolymerized polymers include a polyamide polymer. Any combination of the aforementioned polymers is contemplated. In select embodiments, the photopolymerized polymer includes a polycarbonate urethane (meth)acryl polymer. Suitable components for inclusion in photopolymerizable compositions are described in detail below.

Photopolymerizable compositions described herein can be mixed by known techniques. In some embodiments, for instance, a method for the preparation of a photopolymerizable composition described herein comprises the steps of mixing all or substantially all of the components of the photopolymerizable composition, heating the mixture, and optionally filtering the heated mixture. Softening the mixture, in some embodiments, is carried out at a temperature in a range from about 35° C. to about 85° C. In some embodiments, a photopolymerizable composition described herein is produced by placing all or substantially all components of the composition in a reaction vessel and heating the resulting mixture to a temperature ranging from about 35° C. to about 50° C. with stirring. The heating and stirring are continued until the mixture attains a substantially homogenized state.

In many embodiments, the photopolymerizable composition is vat polymerized, as discussed in detail above.

Orthodontic articles according to the present disclosure preferably exhibit at least one desirable physical property. The conformability and durability of a cured orthodontic article made from the photopolymerizable compositions of the present disclosure can be determined in part by standard tensile, modulus, and/or elongation testing. Desirable physical properties include any one or more of the following: bending modulus, initial relaxation modulus, elongation at break, tensile strength, relaxation modulus at 30 minutes, and percent loss of relaxation modulus. Preferably, the orthodontic article exhibits at least two different desirable physical properties, more preferably at least three different desirable physical properties, and most preferably at least initial relaxation modulus, elongation at break, and tensile strength. The values of these different physical properties are described below.

An orthodontic article optionally exhibits a bending or initial relaxation modulus when hydrated of 100 megapascals (MPa) or greater measured at 37° C. and 2% strain, as determined by Dynamic Mechanical Analysis (DMA). Bending modulus is determined without preconditioning, whereas initial relaxation modulus is determined following conditioning (i.e., soaking) of a sample of the material of the orthodontic article in deionized water for 48 hours at room temperature (i.e., 22 to 25° C.) (“Water Conditioning”). The DMA procedure is described in detail in the Examples below. A sheet of the at least one photopolymerized polymer of which an orthodontic article is made, (e.g., having a thickness of 1 millimeter (mm)), has a bending modulus when hydrated of 100 MPa or greater and 2200 MPa or less. Preferably, an orthodontic article (or a sheet of the material the orthodontic article is composed of) exhibits a bending or relaxation modulus when hydrated of 150 MPa or greater, 200 MPa or greater, 300 MPa or greater, 400 MPa or greater, 500 MPa or greater, 600 MPa or greater, 700 MPa or greater, 800 MPa or greater, 900 MPa or greater, 1000 MPa or greater, 1100 MPa or greater, or even 1,200 MPa or greater. In some embodiments, the bending or initial relaxation modulus when hydrated is no greater than about 3000, 2500, 2200, 2000, or 1500 MPa. A sheet of photopolymerized polymer(s) optionally has a rectangular structure, for instance with dimensions of 9.4 mm width and 25.4 mm length.

It has been discovered that for at least certain embodiments of photopolymerized polymers according to the present disclosure, hydration from water uptake provides a decreased bending modulus, as compared to the same materials when dry. In some preferred embodiments, the decrease in bending modulus advantageously tends to plateau after a few hours (e.g., 2 hours, 3, 4, 5, 6, or 8 hours) of exposure to water. In contrast, a thermoformable glycol modified polyethylene terephthalate (PETg) can exhibit a continued decrease in bending modulus for over 20 hours, 30 hours, or over 40 hours prior to reaching a plateau, as compared to the same material when dry.

In contrast to deliberately hydrating an orthodontic article, some photopolymerized orthodontic articles have been taught to be coated in a water-resistant coating (e.g., parylene), to minimize water uptake, as disclosed in co-owned PCT Publication No. WO2019/023166 (Parkar et al.). Typically, orthodontic articles according to the present disclosure are free of a water-resistant coating disposed thereon.

An orthodontic article optionally exhibits a (e.g., 30 minute) relaxation modulus of 100 MPa or greater as determined by DMA following 30 minutes of soaking in water at 37° C. under a 2% strain. The DMA procedure for relaxation modulus is described in detail in the Examples below, and is performed on a sample of the material of the orthodontic article following Water Conditioning and initial relaxation modulus testing. Preferably, an orthodontic article exhibits a (e.g., 30 minute) relaxation modulus of 200 MPa or greater, 300 MPa or greater, 400 MPa or greater, 500 MPa or greater, 600 MPa or greater, 700 MPa or greater, 800 MPa or greater, 900 MPa or greater, or even 1,000 MPa or greater. In some embodiments, the (e.g., 30 minute) relaxation modulus is no greater than about 2200, 2000, 1500, 1200, 1000, or 800 MPa.

An orthodontic article optionally exhibits a percent loss of relaxation modulus of 70% or less as determined by DMA. The loss is determined by comparing the initial relaxation modulus to the (e.g., 30 minute) relaxation modulus at 37° C. and 2% strain. It was discovered that orthodontic articles according to at least certain embodiments of the present disclosure exhibit a smaller loss in relaxation modulus following exposure to water than articles made of different materials. Preferably, an orthodontic article exhibits loss of relaxation modulus after hydration of 95% or less, 90% or less, 85% or less, 80% or less, 65% or less, 60% or less, 55% or less, 50% or less, 45% or less 40% or less, or even 35% or less. In some embodiments, the loss of relaxation modulus is 2%, 5%, 10%, 15%, or 20% or greater, preferably 20% or greater. In certain embodiments, a sheet of the at least one photopolymerized polymer (e.g., having a thickness of 1 mm) exhibits a decrease in initial relaxation modulus of 15% or greater, 17%, 19%, or 20% or greater, from before exposure to water to 2 hours of exposure to water, measured at 2% strain at 37° C.

An orthodontic article optionally exhibits an elongation at break of a printed article of 20% or greater, as determined according to the Examples section below, after conditioning (i.e., soaking) of a sample of the material of the orthodontic article in phosphate-buffered saline having a pH of 7.4, for 24 hours at a temperature of 37° C. (“PBS Conditioning”). High elongation at break helps prevent the orthodontic article from being too brittle and potentially breaking during use by a patient. Preferably, an orthodontic article exhibits an elongation at break of 25% or greater, 30%, 35%, 40%, 45%, 50%, 55%, 60%, 65%, 70%, 75%, 80%, 85%, 90%, 95%, 100%, 110%, or even 120% or greater. In some embodiments, the elongation at break is no greater than 250%, 240%, 230%, 220%, 210%, 200%, 190%, 180%, 170%, 160%, 150%, or 140%.

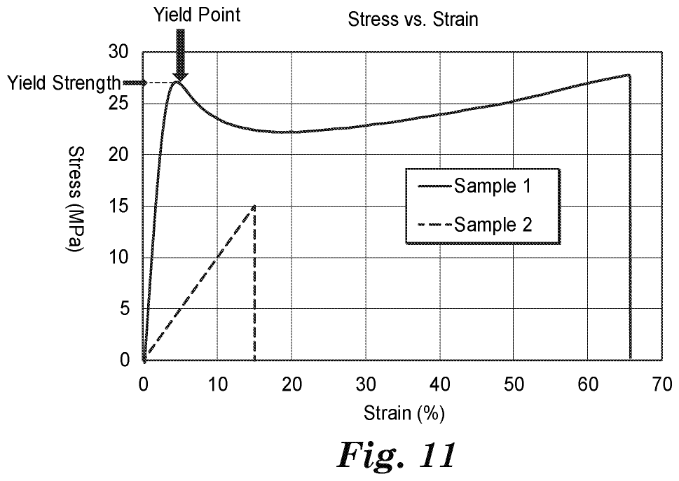

An orthodontic article optionally exhibits a tensile strength at yield (or maximum) of 14 MPa or greater as determined, as determined according to ASTM-D638-14, using test specimen V, after PBS Conditioning. Strength at yield (i.e., yield strength) is defined as the maximum tensile stress a material can handle before it is permanently deformed. Tensile strength at break refers to the point on the stress-strain curve where the material breaks. Samples that yield can undergo strain hardening by deformation, prior to breaking. The stress strain curves for brittle materials, however, do not have a yield point and are typically linear over the full range of strain, eventually terminating in fracture at a maximum tensile strength without appreciable plastic flow. Referring to FIG. 11, plots of stress-strain are shown of materials having different yield behavior. For instance, Sample 1 has a yield strength of 27 MPa, which is at the yield point on the curve, as well as a tensile strength at break of about 27 MPa. In contrast, Sample 2 does not yield, but has a tensile strength at break of 15 MPa. High tensile strength contributes to the orthodontic article having sufficient strength to be resilient during use in a patient's mouth. Preferably, an orthodontic article exhibits a tensile strength of 15 MPa or greater, 17 MPa or greater, 20 MPa or greater, 25 MPa or greater, 30 MPa or greater, 35 MPa or greater, 40 MPa or greater, 45 MPa or greater, 50 MPa or greater, or even 55 MPa or greater. In some embodiments, the elongation at break is no greater than 100 MPa, 95 MPa, 90 MPa, 85 MPa, 80 MPa, 75 MPa, or 70 MPa.

In select embodiments, an orthodontic article exhibits a bending or initial relaxation modulus of 100 MPa, an elongation at break of 20% or greater, and a tensile strength of 14 MPa or greater. Similarly, an article may exhibit any combination of the preferred values described above, of each of the bending or initial relaxation modulus, elongation at break, and tensile strength at yield.

The above mechanical properties are particularly well suited for orthodontic articles that require resiliency and flexibility, along with adequate wear strength and low hygroscopicity.

### Photopolymerizable Compositions

Various photopolymerizable compositions are suitable for use in the methods according to the present disclosure. The compositions include at least one polymerizable component. The term “component” encompasses compounds, monomers, oligomers, and polymers. A “polymerizable component,” for reference purposes herein, comprises a hardenable component that can be cured to provide a printed article. In some embodiments, for instance, hardening comprises irradiating with actinic radiation having sufficient energy to initiate a polymerization or cross-linking reaction. For instance, in some embodiments, ultraviolet (UV) radiation, e-beam radiation, or both, can be used.

In any embodiment, the photopolymerizable composition includes at least one of a (meth)acryl component, a polyalkylene component, a polyalkylene oxide component, a polyester component, a polycarbonate component, a urethane component, a polyamide component, or combinations thereof. In some embodiments, a photopolymerizable composition includes a (meth)acryl component in combination with one or more of a polyalkylene component, a polyalkylene oxide component, a polyester component, a polycarbonate component, a urethane component, and/or a polyamide component.

More particularly, in some embodiments, the photopolymerizable composition is selected from the compositions described in co-owned application Ser. Nos. ______ (Docket No. 82036), ______ (Docket No. 82028), ______ (Docket No. 81316), International Application Nos. PCT/IB2019/051815 (Abuelyaman et al.), and PCT/US2018/060014 (Parkar et al.)), and PCT Publication Nos. WO 2019/023009 (Parkar et al.)) and/or WO 2018/119026 (Parkar et al.). These applications are incorporated herein by reference in their entireties. Compositions according to application Ser. No. ______ (Docket No. 82036) are described in detail below, and the compositions according to the other listed applications are summarized below.

Photopolymerizable Compositions Comprising a (Meth)Acryl Component and a Polyalkylene Oxide Component (e.g., Described in application Ser. No. ______ (Docket No. 82036)):
A suitable photopolymerizable composition comprises:
30-65 parts by weight of monofunctional (meth)acrylate monomer(s), wherein a cured homopolymer of at least one monofunctional (meth)acrylate monomer has a T_{g} of 30 degrees Celsius (° C.) or greater; and
at least one urethane (meth)acrylate comprising polymerized units of an aliphatic polycarbonate diol.
   The monofunctional (meth)acrylate monomer(s) and urethane (meth)acrylates are discussed in detail below.

### Monofunctional (Meth)Acrylate Monomer

In any embodiment, the polymerizable composition comprises a monofunctional (meth)acrylate monomer having a glass transition temperature (T_{g}), i.e., whose cured homopolymer has a T_{g} of 30° C. or greater. In some embodiments, a monofunctional (meth)acrylate monomer is present whose cured homopolymer has a T_{g} of 40° C. or greater, 50° C. or greater, 60° C. or greater, 70° C. or greater, 80° C. or greater, 90° C. or greater, 100° C. or greater, 110° C. or greater, 120° C. or greater, 125° C. or greater, 130° C. or greater, 135° C. or greater, 140° C. or greater, 145° C. or greater, 150° C. or greater, 155° C. or greater, 160° C. or greater, 165° C. or greater, 170° C. or greater, 175° C. or greater, 180° C. or greater, 185° C. or greater, 190° C. or greater, or even 195° C. or greater. In select embodiments, a monofunctional (meth)acrylate monomer is present whose cured homopolymer has a T_{g} of 150° C. or greater, 170° C. or greater, or 180° C. or greater. The T_{g} of the homopolymer of the monofunctional (meth)acrylate monomer is typically no greater than about 260° C. For example, 1-adamantyl methacrylate decomposes at about 260° C. In some embodiments, the T_{g} of the homopolymer of the monofunctional (meth)acrylate monomer is no greater than 255° C., 250° C., 245° C., 240° C., 235° C., 230° C., 225° C., 220° C., 215° C., 210° C., 205° C. or 200° C. The inclusion of one or more monofunctional (meth)acrylate monomers whose cured homopolymer has a T_{g} of 90° C. or greater in a polymerizable composition contributes to increasing the relaxation modulus of a polymerization reaction product of the composition as measured after soaking in deionized water. Often, the T_{g} of a homopolymer of a monomer can be found in the literature.

In some embodiments, the monofunctional (meth)acrylate monomer comprises a cycloaliphatic monofunctional (meth)acrylate. Suitable monofunctional (meth)acrylate monomers include for instance and without limitation, dicyclopentadienyl acrylate, dicyclopentanyl acrylate, dimethyl-1-adamantyl acrylate, cyclohexyl methacrylate, tetrahydrofurfuryl methacrylate, 2-phenoxyethyl methacrylate, butyl methacrylate (e.g., tert-butyl methacrylate or isobutyl methacrylate), benzyl methacrylate, n-propylmethacrylate, 3,3,5-trimethylcyclohexyl methacrylate, butyl-cyclohexylmethacrylate (e.g., cis-4-tert-butyl-cyclohexylmethacrylate, 73/27 trans cis-4-tert-butylcyclohexylmethacrylate, or trans-4-tert-butylcyclohexyl methacrylate), 2-decahydronapthyl methacrylate, 1-adamantyl acrylate, dicyclopentadienyl methacrylate, dicyclopentanyl methacrylate, isobornyl methacrylate (e.g., d,l-isobornyl methacrylate), dimethyl-1-adamantyl methacrylate, bornyl methacrylate (e.g., d,l-bornyl methacrylate), 3-tetracyclo[4.4.0.1.1]dodecyl methacrylate, 1-adamantyl methacrylate, isobornyl acrylate, tertiary butyl acrylate, or combinations thereof. In an embodiment, the monofunctional (meth)acrylate monomer comprises isobornyl methacrylate.

In certain embodiments, the weight ratio of the monofunctional (meth)acrylate monomer to the polyurethane (meth)acrylate is 60:40 to 40:60, 55:45 to 45:55, or 50:50. In some embodiments, the urethane (meth)acrylate and the monofunctional (meth)acrylate monomer(s) are present at a weight ratio ranging from 2:1 to 1:2. Often, the monofunctional (meth)acrylate monomer is present in an amount of 40 parts or more by weight per 100 parts of the total polymerizable composition, 45 parts or more, 46 parts or more, 47 parts or more, 48 parts or more, 49 parts or more, or 50 parts or more; and 65 parts or less, 64 parts or less, 63 parts or less, 62 parts or less, 61 parts or less, 60 parts or less, 59 parts or less, 58 parts or less, 57 parts or less, 56 parts or less, or 55 parts or less, by weight per 100 parts of the total polymerizable composition. In some embodiments, the monofunctional (meth)acrylate monomer(s) having a T_{g} of at least 30° C. are present in an amount of at least 15, 20, 25, 30, 35, 40, 45, or 50 wt. %, based on the total weight of the organic components of the composition (e.g., excluding inorganic components, such as filler).

In some embodiments of the invention, the cured material will be in contact with an aqueous environment. In those cases, it is advantageous to utilize materials which have low affinity for water. The affinity for water of certain (meth)acrylate monomers can be estimated by the calculation of a partition coefficient (P) between water and an immiscible solvent, such as octanol. This can serve as a quantitative descriptor of hydrophilicity or lipophilicity. The octanol/water partition coefficient can be calculated by software programs such as ACD ChemSketch, (Advanced Chemistry Development, Inc., Toronto, Canada) using the log of octanol/water partition coefficient (log P) module. In embodiments of the present invention, the calculated log P value is greater than 1, 1.5, 2, 2.5, 3, 3.5, or 4. The calculated log P value is typically no greater than 12.5. In some embodiments, the calculated log P value is no greater than 12, 11.5, 11, 10.5, 10, 9.5, 9, 8.5, 8, 7.5, 7, 6.5, 6, or 5.5. Moreover, in some embodiments, polymerizable compositions exclude the presence of a significant amount of hydrophilic (meth)acrylate monomers by being essentially free of any monofunctional (meth)acrylate monomer having a log P value of less than 3, less than 2, or less than 1.

In some embodiments, polymerizable compositions contain hydrophilic (meth)acrylate monomers, oligomers, or polymers (e.g., hydrophilic urethane (meth)acrylate) having a log P value of less than 3, less than 2, or less than 1, in an amount of less than 30% by weight, based on the total weight of the polymerizable composition, such as 29% or less, 28%, 27%, 26%, 25%, 24%, 23%, 22%, 21%, 20%, 19%, 18%, 17%, 16%, 15%, 14%, 13%, 12%, or 11% or less of hydrophilic components; and 1% by weight or more, 2%, 3%, 4%, 5%, 7%, 9%, or 10% or more hydrophilic components, for example 1% to 29% by weight, based on the total weight of the polymerizable composition. In some embodiments, the combination of a hydrophilic component and a monofunctional (meth)acrylate monomer whose cured homopolymer has a T_{g} of 150° C. or greater can impart advantageous properties to an article, for instance, 20% by weight or more of the high T_{g} monomer, 22%, 25%, 27%, 30%, 32%, 35%, 37%, 40%, 42%, 45%, 47%, or 50% by weight or more of a monofunctional (meth)acrylate monomer whose cured homopolymer has a T_{g} of 150° C. may be included when 1% to 29% by weight of a hydrophilic component is present, each based on the total weight of the polymerizable composition.

In embodiments of polymerizable compositions containing little to no low molecular weight difunctional component (e.g., a dimethacrylate), inclusion of an insufficient amount of a relatively high T_{g} monomer (e.g., over 125° C., 140° C., 150° C., or over 160° C.), may negatively impact the ability of a polymerization reaction product of the polymerization composition to yield (e.g., having increased brittleness).

### Urethane (Meth)Acrylate

Orthodontic articles according to the present disclosure comprise at least one urethane (meth)acrylate. Urethanes are prepared by the reaction of an isocyanate with an alcohol to form carbamate linkages. The urethane (meth)acrylate typically provides toughness (e.g., at least a minimum tensile strength and/or modulus and flexibility, (e.g., at least a minimum elongation at break)) to the final orthodontic article. In addition to the urethane functionality, the urethane (meth)acrylate further comprises a polycarbonate linking group. The linking group is a functional group that connects two or more urethane groups, and may be divalent, trivalent, or tetravalent, and preferably divalent. In addition, the urethane (meth)acrylate optionally further comprises one or more functional groups selected from hydroxyl groups, carboxyl groups, amino groups, and siloxane groups. These functional groups can be reactive with other components of the polymerizable composition during polymerization. The urethane (meth)acrylate preferably has a weight average molecular weight (Mw) of 3,000 g/mol or greater, 4,000 g/mol or greater, 5,000 g/mol or greater, 6,000 g/mol or greater, 6,000 g/mol or greater, 7,000 g/mol or greater, 8,000 g/mol or greater, 9,000 g/mol or greater, 10,000 g/mol or greater, 11,000 g/mol or greater, or 12,000 g/mol or greater; and 50,000 g/mol or less, 45,000 g/mol or less, 40,000 g/mol or less, 35,000 g/mol or less, 32,000 g/mol or less, 30,000 g/mol or less, 28,000 g/mol or less, 25,000 g/mol or less, 23,000 g/mol or less, 20,000 g/mol or less, or 18,000 g/mol or less. Stated another way, the urethane (meth)acrylate may have a Mw of 3,000 g/mol to 50,000 g/mol, 6,000 g/mol to 40,000 g/mol, 6,000 g/mol to 18,000 g/mol, 6,000 g/mol to 35,000 g/mol, or 8,000 g/mol to 32,000 g/mol. Weight average molecular weight may be measured using gel permeation chromatography (GPC), for instance using the method described in the Examples below. Higher molecular weight of the urethane (meth)acrylates will result in higher viscosity resin formulations with comparable compositions and loadings, which makes them less flowable; lower molecular weight of the urethane (meth)acrylates will reduce their toughening effect on the cured orthodontic articles.

The urethane (meth)acrylate may be provided by one or more different urethane (meth)acrylates containing polymerized units of an aliphatic polycarbonate diol. Additionally, one or more urethane (meth)acrylates may also be present in the polymerizable composition that lack polymerized units of an aliphatic polycarbonate diol. Various suitable urethane (meth)acrylates, which can be present in the polymerizable composition alone or in combination, are described below. The polycarbonate urethane (meth)acrylate is the major urethane (meth)acrylate. When other urethane (meth)acrylates and/or or difunctional (e.g. di(meth)acrylate) components are present, the weight ratio of polycarbonate urethane (meth)acrylate to the total of other urethane (meth)acrylates and/or difunctional (e.g. di(meth)acrylate) components typically ranges from 1:1 to 25:1. In some embodiments, the weight ratio of polycarbonate urethane (meth)acrylate to the total of other urethane (meth)acrylates and/or or difunctional (e.g. di(meth)acrylate) components is at least 2:1, at least 3:1, or at least 4:1. The use of more than one urethane(meth)acrylate may provide somewhat different mechanical properties to the orthodontic article than using a single urethane(meth)acrylate in the polymerizable composition.

In one embodied synthetic route, the urethane (meth)acrylate comprises a reaction product of an aliphatic polycarbonate diol, a diisocyanate, and a hydroxy functional (meth)acrylate. One such suitable urethane (meth)acrylate is of Formula (VI):

(A)ₚ-Q-OC(O)NH—R_{di}—NH—C(O)—[O—R_{dOH}—OC(O)NH—R_{di}—NH—C(O)]ᵣ—O-Q-(A)ₚ (VI),

wherein A has the formula —XC(═O)C(R₁)═CH₂, wherein X is O, S, or NR₄, R₄ is H or alkyl of 1 to 4 carbon atoms, and R₁ is a lower alkyl of 1 to 4 carbon atoms or H, p is 1 or 2, Q is a polyvalent organic linking group, R_{di} is the residue of a diisocyanate, R_{dOH} is the residue of a polycarbonate polyol, and r averages from 1 to 15. In some embodiments, r is no greater than 15, 14, 13, 12, 11, or 10. In some embodiments, r averages at least 2, 3, 4, or 5. In some embodiments, A is a methacryl functional group, such as methacrylate.

Suitable amounts of each of the diisocyanate, hydroxy functional (meth)acrylate, and polycarbonate diol present in the polymerizable composition are based on molar ratios of each of these components to the others. For instance, a ratio of the diisocyanate (which has 2 isocyanate equivalents per mole of isocyanate compound) to the polycarbonate diol typically ranges from 4 molar equivalents of the diisocyanate to 1 molar equivalent of the alcohol of the polycarbonate diol, to 4 molar equivalents of the diisocyanate to 3 molar equivalents of the alcohol of the polycarbonate diol. In select embodiments, a ratio of the isocyanate to the polycarbonate diol is 4 molar equivalents of diisocyanate to 2 molar equivalents of the alcohol of the polycarbonate diol. The closer the ratio of the diisocyanate to the polycarbonate diol is to 1 molar equivalent of diisocyanate to 1 molar equivalent of the alcohol of the polycarbonate diol, the higher the weight average molecular weight of the resulting polyurethane (meth)acrylate produced in the polymerization reaction product.

A ratio of the diisocyanate to the hydroxy functional (meth)acrylate typically ranges from 4 molar equivalents of the diisocyanate to 3 molar equivalents of the hydroxy functional (meth)acrylate, to 4 molar equivalents of the diisocyanate to 1 molar equivalent of the hydroxy functional (meth)acrylate. In select embodiments, a ratio of the diisocyanate to the hydroxy functional (meth)acrylate is 4 molar equivalents of the diisocyanate to 2 molar equivalents of the hydroxy functional (meth)acrylate.

A ratio of the polycarbonate diol to the hydroxy functional (meth)acrylate typically ranges from 1 molar equivalent of the alcohol of the polycarbonate diol to 3 molar equivalents of the hydroxy functional (meth)acrylate, to 3 molar equivalents of the polycarbonate diol to 1 molar equivalents of the hydroxy functional (meth)acrylate. In select embodiments, a ratio of the polycarbonate diol to the hydroxy functional (meth)acrylate is 1 molar equivalent of the alcohol of the polycarbonate diol to 1 molar equivalent of the hydroxy functional (meth)acrylate.

In another embodied synthetic route, the urethane (meth)acrylate comprises a reaction product of an aliphatic polycarbonate diol, a diisocyanate, a diol (meth)acrylate, and a hydroxy functional (meth)acrylate. One such suitable the urethane (meth)acrylate is of Formula (V):

(A)ₚ-Q-OC(O)NH—R_{di}—NH—C(O)—[O—R_{dOH}—OC(O)NH—R_{di}—NH—C(O)]ₛ—[O—R_{D}—OC(O)NH—R_{di}—NH—C(O)]ᵣ—O-Q-(A)ₚ (V),

wherein A has the formula —XC(═O)C(R₁)═CH₂, wherein X is O, S, or NR₄, R₄ is H or alkyl of 1 to 4 carbon atoms, and R₁ is a lower alkyl of 1 to 4 carbon atoms or H, p is 1 or 2, Q is a polyvalent organic linking group, R_{di} is the residue of a diisocyanate, R_{dOH} is the residue of a polycarbonate polyol, s and t are independently 1 or greater, s+t averages from 2 to 15, wherein the s and t units may be connected to each other in any order, and R_{AD} is the residue of a (meth)acrylated diol. In some embodiments, s+t is no greater than 15, 14, 13, 12, 11, or 10. In some embodiments, s averages at least 2, 3, 4, or 5. In some embodiments, t averages 1 or 2. In some embodiments, A is a (meth)acryl functional group, such as methacrylate. R_{AD} always has a single (meth)acryl group. In some embodiments R_{AD} is represented as

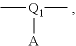

and may also be represented as -Q₁(A)-, wherein A is defined as above. In some embodiments, Q₁ is a straight or branched chain or cycle-containing aliphatic polyvalent connecting group.

In another embodied synthetic route, the urethane (meth)acrylate comprises a reaction product of an aliphatic polycarbonate diol and an isocyanate functional (meth)acrylate. One such suitable urethane (meth)acrylate is of Formula (VIII):

(H₂C═C(R₃)C(═O)—O)ₚ-Q-NH—C(═O)—(O—R₁—O—C(═O))ₘ—O—R₂—O—C(═O)NH-Q-(O—C(═O)C(R₃)═CH₂)ₚ (VIII),

wherein Q is a polyvalent organic linking group, R₃ is a lower alkyl of 1 to 4 carbon atoms or H, p is 1 or 2, each R₁ and R₂ are independently an aliphatic, cycloaliphatic, or aliphatic/cycloaliphatic alkylene group and an average number of carbon atoms in a combination of all the R₁ and R₂ groups is 4 to 10, and m is 2 to 23. As an example, the compound of Formula (VIII) may, in select embodiments, be a compound of Formula (IX):

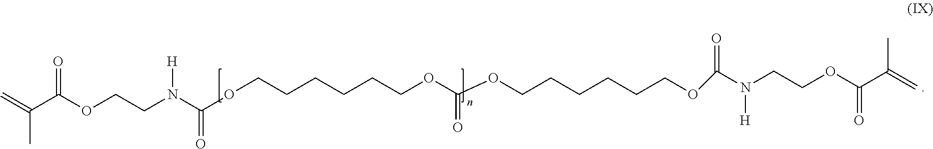

In Formula (IX), n is about 6.7 for a 1000 molecular weight polycarbonate diol based on hexane diol.

In another embodied synthetic route, the urethane (meth)acrylate comprises a reaction product of an aliphatic polycarbonate diol, a diisocyanate, and an isocyanate functional (meth)acrylate. One such suitable urethane (meth)acrylate is of Formula (XI):

(A)ₚ-Q-NHC(O)—[O—R_{dOH}—OC(O)NH—R_{di}—NH—C(O)]ᵤ—O—R_{dOH}—O—C(O)NH-Q-(A)ₚ (XI),

wherein u is 0 to 15, A has the formula —XC(═O)C(R₁)═CH₂, wherein X is O, S, or NR₄, R₄ is H or alkyl of 1 to 4 carbon atoms, and R₁ is a lower alkyl of 1 to 4 carbon atoms or H, p is 1 or 2, Q is a polyvalent organic linking group, R_{di} is the residue of a diisocyanate, and R_{dOH} is the residue of a polycarbonate polyol.

In another embodied synthetic route, the urethane (meth)acrylate comprises a reaction product of an aliphatic polycarbonate diol, a diisocyanate, a diol (meth)acrylate, and an isocyanate functional (meth)acrylate. One such suitable urethane (meth)acrylate is of Formula (XII):

(A)ₚ-Q-NHC(O)—[O—R_{dOH}—OC(O)NH—R_{di}—NH—C(O)]ᵥ—[O—R_{A}—OC(O)NH—R_{di}—NH—C(O)]_{w}—O—R_{dOH1}—O—C(O)NH-Q-(A)ₚ (XII),

wherein, R_{di}, R_{AD}, Q, A, and p, are defined as above, v+w is 1 to 15, and R_{dOH1} is selected from R_{dOH} or R_{AD}, with the provisos that if v is 0 then R_{dOH1} is R_{dOH}, and if w is 0 then R_{dOH1} is R_{AD}.

In another embodied synthetic route, the urethane (meth)acrylate containing polycarbonate moieties further comprises polymerized units of a polyester diol. However, the urethane (meth)acrylate contains the same or more polymerized units of the aliphatic polycarbonate diol than of the polyester diol. One such suitable urethane (meth)acrylate is of Formula (XIII):

(A)_{P}-Q-OC(O)NH—R_{di}—NH—C(O)—[O—R_{dOH2}—OC(O)NH—R_{di}—NH—C(O)]ₓ—O-Q-(A)ₚ (XIII),

wherein each R_{dOH2} is independently selected from the residue of a polyester polyol or the residue of a polycarbonate polyol, and x is greater than 2.

In some embodiments, the polymerizable composition further comprises at least one second urethane (meth)acrylate lacking aliphatic polycarbonate moieties. For instance, such a urethane (meth)acrylate may comprise polymerized units of a polyester diol. One suitable urethane (meth)acrylate comprising polymerized units of a polyester diol is of Formula (XXI) or Formula (XXII):

(A)ₚ-Q-OC(O)NH—R_{di}—NH—C(O)—[O—R_{dOH3}—OC(O)NH—R_{di}—NH—C(O)]ᵣ—O-Q-(A)ₚ (XXI), or

(A)ₚ-Q-NHC(O)O—R_{dOH3}—OC(O)NH-Q-(A)ₚ (XXII),

wherein A has the formula —XC(═O)C(R₁)═CH₂, wherein X is O, S, or NR₄, R₄ is H or alkyl of 1 to 4 carbon atoms, and R₁ is a lower alkyl of 1 to 4 carbon atoms or H, p is 1 or 2, Q is a polyvalent organic linking group, R_{di} is a residue of a diisocyanate, R_{dOH3} is a residue of a polyester polyol, and r averages from 1 to 15.

Any combination of the urethane (meth)acrylates is contemplated to be used in polymerizable compositions and orthodontic articles. The various reactants mentioned above that may be used to form urethane (meth)acrylates (e.g., polycarbonate diols, diisocyanates, hydroxy functional (meth)acrylates, diol (meth)acrylates, isocyanate functional (meth)acrylates, and polyester polyols) are further described below, as well as additional components useful in polymerizable compositions and orthodontic articles according to the present disclosure.

### Polycarbonate Diol

In some embodiments, the polycarbonate diol is of Formula (I):

H(O—R₁—O—C(═O))ₘ—O—R₂—OH (I),

wherein each of R₁ in each (O—R₁—O—C(═O)) repeat unit, and R₂ are independently an aliphatic, cycloaliphatic, or aliphatic/cycloaliphatic alkylene group and an average number of carbon atoms in a combination of all the R₁ and R₂ groups is 4 to 10, and m is (an integer of) 2 to 23. Stated another way, while some repeat units of R₁ and/or R₂ may have a carbon number of less than 4 (e.g., 2 or 3), enough of the repeat units have a sufficiently high carbon number that when the carbon numbers of all the repeat units of R₁ and R₂ in the polycarbonate diol of Formula (I) are averaged, that average falls within the range of 4 to 10, or any of 4 to 6, 4 to 7, 4 to 8, 4 to 9, 5 to 7, 5 to 8, 5 to 9, 5 to 10, 6 to 8, 6 to 9, 6 to 10, 7 to 9, 7 to 10, or 8 to 10. In contrast, a polycarbonate diol having a molecular weight of about 1,500 g/mol made with CO₂ and propylene oxide available as “CONVERGE POLYOL 212-20” from Aramco, (Dhahran, Saudi Arabia), has an average number of carbon atoms in a combination of all the R₁ and R₂ groups is just 3. In select embodiments, at least one of R₁ or R₂ is —CH₂CH₂CH(CH₃)CH₂CH₂—, —(CH₂)₆—, or —(CH₂)₄—, and preferably a combination of —CH₂CH₂CH(CH₃)CH₂CH₂—, and —(CH₂)₆—.

In some embodiments, either the polycarbonate diol has a number average molecular weight (Mn) of greater than 1,000 grams per mole (g/mol) or a weighted average of all polycarbonate diols present in the components has a Mn of greater than 1,000 g/mol, wherein Mn is determined by OH value. Stated a different way, when the components contain a single polycarbonate diol of Formula (I), the polycarbonate diol has a Mn higher than 1,000 g/mol. When the components contain two or more polycarbonate diols (e.g., one or more being of Formula (I)), the Mn of at least one of the polycarbonate diols may be 1,000 g/mol or less with the proviso that a weighted average of all the Mn values of the two or more polycarbonate diols is higher than 1,000 g/mol. For instance, components containing two polycarbonate diols could include a molar ratio of a first polycarbonate diol having a Mn of about 500 g/mol of 1 to a second polycarbonate diol having a Mn of about 1,500 g/mol of 2, resulting in a weighted average Mn of 1,167 g/mol. In certain embodiments, a polycarbonate diol (or a weighted average of all the polycarbonate diols present in the components) has a number average molecular weight of 1,500 g/mol or higher.

In some embodiments, one or more polycarbonate diols are present having a Mn of 450 grams per mole (g/mol) or greater, 500 g/mol or greater, 550 g/mol or greater, 600 g/mol or greater, 650 g/mol or greater, 700 g/mol or greater, 750 g/mol or greater, 800 g/mol or greater, 850 g/mol or greater, 900 g/mol or greater, 950 g/mol or greater, or 1,000 g/mol or greater; and 3,200 g/mol or less, 3,100 g/mol or less, 3,000 g/mol or less, 2,900 g/mol or less, 2,800 g/mol or less, 2,700 g/mol or less, 2,600 g/mol or less, 2,500 g/mol or less, 2,400 g/mol or less, 2,300 g/mol or less, 2,200 g/mol or less, 2,100 g/mol or less, 2,000 g/mol or less, 1,900 g/mol or less, 1,800 g/mol or less, or 1,700 g/mol or less. Stated another way, the polycarbonate diol may have a Mn of 450 g/mol to 3,200 g/mol, 800 g/mol to 3,200 g/mol, 1,000 g/mol to 3,200 g/mol, 1,500 g/mol to 3,200 g/mol, 1,800 g/mol to 3,200 g/mol, 450 g/mol to 2,200 g/mol, 800 g/mol to 2,200 g/mol, 1,000 g/mol to 2,200 g/mol, 1,500 g/mol to 2,200 g/mol, or 1,800 g/mol to 2,200 g/mol. Inclusion of a polycarbonate diol having a Mn of greater than 3,200 g/mol, on the other hand, may negatively impact the stiffness of a polymerization reaction product of the polymerization composition, by increasing the elastomeric character of the polymerization reaction product. In select embodiments, the polymerizable composition is essentially free of any diols that have a Mn lower than the one or more polycarbonate diols present in the components. In embodiments of polymerizable compositions containing a relatively low T_{g} monomer (e.g., under 90° C., 80° C., or under 60° C.), inclusion of a polycarbonate diol having a Mn of greater than 1,500 g/mol may negatively impact the ability of a polymerization reaction product of the polymerization composition to yield (e.g., having increased brittleness). Similarly, in embodiments of polymerizable compositions containing a polycarbonate diol having a Mn of greater than 1,500 g/mol, inclusion of an insufficient amount of a relatively high T_{g} monomer (e.g., over 90° C., 100° C., 125° C., or over 150° C.), may negatively impact the ability of a polymerization reaction product of the polymerization composition to yield (e.g., having increased brittleness).

Suitable polycarbonate diols for use in the components include for instance and without limitation, those commercially available from Kuraray Co. Ltd. (Tokyo, JP) under the trade designation “KURARAY POLYOL”, e.g., specifically, each of the KURARAY POLYOL C series: C-590, C-1090, C-2050, C-2090, and C-3090; from Covestro LLC (Pittsburgh, Pa.) under the trade designation “DESMOPHEN”, e.g., specifically, each of the DESMOPHEN C series: C-2100, C-2200, and C XP-2613.

### Polyester Diol

In some embodiments, polyester diols are utilized in the preparation of the urethane (meth)acrylate.

In some embodiments, the polyester diol has Formula (XVI), as follows:

H[O—R₅—O—C(═O)—R₆—C(═O)]ᵢ—O—R₅—OH (XVI),

wherein R₅ and R₆ are independently straight or branched chain or cycle-containing alkylene, groups, that optionally include heteroatoms, such as oxygen. R₅ and R₆ independently comprise 2 to 40 carbon atoms. The subscript “i” is typically at least 2, 3, 4, 5, 6, or 7. The subscript “i” is typically no greater than 50, 45, 40, 35, 30, 25, 20, or 15. In some embodiments, the R₅ and R₆ are alkylene.

Representative polyester diols include for example neopentyl glycol adipate diol, butane diol adipate diol; 3-methyl-1,5-pentanediol adipate diol; and 3-methyl-1,5-pentanediol sebecate diol, and dimer acid based polyols in which the dimer acid is derived for example from dimerization of two 18 carbon diacids such as linoleic acid.

In some embodiments, such as the diols just described, the polyester diol comprises a single R₅ group (e.g. neopentyl or 3-methyl-1,5-pentyl) and a single R₆ group (e.g. adipate).

In other embodiments, the polyester diol can be prepared from more than one diol and more than one acid. In this embodiment, the diol can contain two or more different R₅ groups and two or more different R₆ groups such as in the case of ethylene glycol-hexane diol/adipate-azelate copolyester diol.

In other embodiments, the polyester diol has Formula (XVII), as follows:

H[—O—R₂₃—C(═O)]ⱼ—O—R₂₂—O—[C(═O)—R₂₃—O]ₖ—H (XVII),

wherein R₂₂ and R₂₃ are independently straight or branched chain or cycle-containing alkylene groups that optionally include heteroatoms such as oxygen, the alkylene groups independently comprise 2 to 40 carbon atoms. The subscripts “j” and “k” are typically independently at least 4, 5 or 6. The subscripts “j” and “k” are typically independently no greater than 25, 20, or 15.

One representative polyester diol of this type is polycaprolactone diol, such as available from Perstorp. In this embodiment, R₂₃ is a C₅ alkylene group and R₂₂ is the residue of an alcohol, such as ethylene glycol, butylene glycol, diethylene glycol, and the like.

In some embodiments, at least one of R₅ or R₆ of Formula (XVI) and at least one of R₂₂ and R₂₃ of Formula (XVII) is a straight or branched chain or cycle-containing alkylene group independently comprising at least 4, 5, or 6 carbon atoms.

In some embodiments, each of the R₅ and R₆ groups of Formula (XVI) are alkylene groups independently comprising at least 4, 5, or 6 carbon atoms. In some embodiments, each of the R₂₂ and R₂₃ groups of Formula (XVII) are alkylene groups independently comprising at least 4, 5, or 6 carbon atoms.

The values of i, j, and k are chosen such that the molecular weight (Mn) of the diol is at least 500, 600, 700, 800, 900, or 1000 g/mole. In some embodiments, the molecular weight (Mn) of the diol is at least 1100, 1200, 1300, 1400, 1500 g/mole. In some embodiments, the molecular weight (Mn) of the diol is at least 1600, 1700, 1800, 1900, or 2000 g/mole. In some embodiments, the molecular weight (Mn) of the diol is no greater than 10,000; 9,000; 8,000; 7,000; 6,000; 5000; 4000; or 3000 g/mole. The values of i, j, and k can vary widely due to the range of carbons for the R₅, R₆, R₇ and R₈ groups.

### Polyether Diol

In some embodiments, polyether diols are utilized in the preparation of the urethane (meth)acrylate. The polyether diol is typically of Formula (XVIII) as follows:

H[O—R₂₄]ₕ—OH (XVIII),

Wherein each R₂₄ is independently selected from straight or branched chain or cycle-containing alkylene groups of 2 to 6 carbon atoms, more preferably 3-4 carbon atoms, and h is typically is at least 7, but no higher than 80. The value of h is chosen such that the molecular weight (Mn) of the diol is at least 500, 600, 700, 800, 900, or 1000 g/mole. In some embodiments, the molecular weight (Mn) of the diol is at least 1100, 1200, 1300, 1400, 1500 g/mole. In some embodiments, the molecular weight (Mn) of the diol is at least 1600, 1700, 1800, 1900, or 2000 g/mole. In some embodiments, the molecular weight (Mn) of the diol is no greater than 10,000; 9,000; 8,000; 7,000; 6,000; 5000; 4000; or 3000 g/mole. When the molecular weight is too low the elongation can be insufficient (i.e. less than 15-20%).

### Diisocyanate

Diisocyanates that can be employed can be any organic isocyanate having two free isocyanate groups. Included are aliphatic, cycloaliphatic, aromatic and araliphatic isocyanates. Any of the known polyisocyanates such as alkyl and alkylene polyisocyanates, cycloalkyl and cycloalkylene polyisocyanates, and combinations such as alkylene and cycloalkylene polyisocyanates can be employed. In some embodiments, diisocyanates having the formula R_{di}(NCO)₂ can be used, with R_{di} as defined above (e.g., an aliphatic and/or aromatic moiety between the isocyanate groups).

Specific examples of suitable diisocyanates include for instance and without limitation, 2,6-toluene diisocyanate (TDI), 2,4-toluene diisocyanate, methylenedicyclohexylene-4,4′-diisocyanate (H12MDI), 3-isocyanatomethyl-3,5,5-trimethylcyclohexyl isocyanate (IPDI), 1,6-diisocyanatohexane (HDI), tetramethyl-m-xylylene diisocyanate, a mixture of 2,2,4- and 2,4,4-trimethyl-1,6-diisocyanatohexane (TMXDI), trans-1,4-hydrogenated xylylene diisocyanates (H6XDI), cyclohexyl-1,4-diisocyanate, 4,4′-methylene diphenyl diisocyanate, 2,4′-methylene diphenyl diisocyanate, a mixture of 4,4′-methylene diphenyl diisocyanate and 2,4′-methylene diphenyl diisocyanate, 1,5-naphthalene diisocyanate, 1,4-tetramethylene diisocyanate, 1,4-phenylene diisocyanate, 2,6- and 2,4-toluene diisocyanate, 1,5-naphthylene diisocyanate, 2,4′ and 4,4′-diphenylmethane diisocyanate, pentamethylene diisocyanate, dodecamethylene diisocyanate, 1,3-cyclopentane diisocyanate, 1,3-cyclohexane diisocyanate, methyl 2,4-cyclohexane diisocyanate, methyl-2,6-cyclohexane diisocyanate, 1,4-bis (isocyanatomethyl) cyclohexane, 1,3-bis (isocyanatomethyl) cyclohexane, 4,4′-toluidine diisocyanate, 4,4′-diphenyl ether diisocyanate, 1,3- or 1,4-xylylene diisocyanate, lysine diisocyanate methyl ester, 3,3′-dimethyl-4,4′-diphenylmethane diisocyanate, 3,3′-dimethyl-phenylene diisocyanate, 2,5-bis (isocyanate methyl)-bicyclo[2.2.1]heptane, 2,6-bis (isocyanate methyl)-bicyclo[2.2.1]heptane, bis (2-isocyanate ethyl) fumarate, 4-diphenylpropane diisocyanate, trans-cyclohexane-1,4-diisocyanatehydrogenated dimer acid diisocyanate, a norbomene diisocyanate, methylenebis 6-isopropyl-1,3-phenyl diisocyanate, and any combination thereof. In select embodiments, the diisocyanate comprises IPDI.

It is also possible to include higher-functional polyisocyanates known from polyurethane chemistry or else modified polyisocyanates, for example containing carbodiimide groups, allophanate groups, isocyanurate groups and/or biuret groups.

### Hydroxy Functional (Meth)Acrylate

In some embodiments, hydroxy functional (meth)acrylates are utilized in the preparation of the urethane (meth)acrylate. Typically, the hydroxy functional (meth)acrylate is of Formula (II):

HO-Q-(A)ₚ (II),

wherein Q is a polyvalent organic linking group, A is a (meth)acryl functional group of the formula —XC(═O)C(R₁)═CH₂, wherein X is O, S, or NR₄, R₄ is H or alkyl of 1 to 4 carbon atoms, R₁ is a lower alkyl of 1 to 4 carbon atoms (e.g., methyl) or H, and wherein p is 1 or 2.

Q can be a straight or branched chain or cycle-containing connecting group. Q comprises typically no greater than 20 carbon atoms. Q can include a covalent bond, an alkylene, an arylene, an aralkylene, an alkarylene. Q can optionally include heteroatoms such as O, N, and S, and combinations thereof. Q can also optionally include a heteroatom-containing functional group such as carbonyl or sulfonyl, and combinations thereof. In some embodiments, Q is a straight chain, branched chain, or cycle-containing connecting group selected from arylene, aralkylene, and alkarylene. In yet other embodiments, Q is a straight chain, branched chain, or cycle-containing connecting group containing heteroatoms such as O, N, and S and/or a heteroatom containing functional group such as carbonyl and sulfonyl. In other embodiments, Q is a branched or cycle-containing alkylene group that optionally contains heteroatoms selected from O, N, S, and/or a heteroatom-containing functional group such as carbonyl and sulfonyl.

In some embodiments, in the hydroxy functional (meth)acrylate of Formula (II), Q is an alkylene group, p is 1, and in the (meth)acryl functional group A, X is O and R₂ is methyl or H. In certain preferred embodiments, in the hydroxy functional (meth)acrylate of Formula (II), Q is an alkylene group, p is 1, and in the (meth)acryl functional group A, X is O and R₂ is methyl. In some embodiments, Q is an alkylene comprising no greater than 12, 10, 8, or 6 carbon atoms, and may be a C₂, C₃, or C₄ alkylene group.

Suitable example hydroxy functional (meth)acrylates include for instance and without limitation, 2-hydroxyethyl (meth)acrylate, hydroxypropyl acrylate (all isomers), hydroxybutyl acrylate (all isomers), poly(e-caprolactone) mono[2-(meth) acryloxy ethyl] esters such as caprolactone monoacrylate available under the trade designation “SR-495” from Sartomer USA (Arkema Group) (Exton, Pa.), glycerol dimethacrylate, 1-(acryloxy)-3-(methacryloxy)-2-propanol, 2-hydroxy-3-phenyloxypropyl (meth)acrylate, 2-hydroxyalkyl (meth)acryloyl phosphate, 4-hydroxycyclohexyl (meth)acrylate, trimethylolpropane di(meth)acrylate, trimethylolethane di(meth)acrylate, 1,4-butanediol mono(meth)acrylate, neopentyl glycol mono(meth)acrylate, 1,6-hexanediol mono(meth)acrylate, 3-chloro-2-hydroxypropyl (meth)acrylate, 2-hydroxy-3-alkyloxy(meth)acrylate, polyethylene glycol mono(meth)acrylate, polypropylene glycol mono(meth)acrylate, ethylene oxide-modified phthalic acid (meth)acrylate, and 4-hydroxycyclohexyl (meth)acrylate.

### Diol (Meth)Acrylate

In some embodiments, diol (meth)acrylates are utilized in the preparation of the urethane (meth)acrylate. Typically, the diol (meth)acrylate is of Formula (XV):

HO-Q₁(A)-OH (XV);

wherein A has the formula —XC(═O)C(R₁)═CH₂, wherein X is O, S, or NR₄, R₄ is H or alkyl of 1 to 4 carbon atoms, and R₁ is a lower alkyl of 1 to 4 carbon atoms or H, and Q₁ is a polyvalent organic linking group. Q₁ comprises typically no greater than 20 carbon atoms. Q₁ can include a covalent bond, an alkylene, an arylene, an aralkylene, an alkarylene. Q₁ can optionally include heteroatoms such as O, N, and S, and combinations thereof. Q₁ can also optionally include a heteroatom-containing functional group such as carbonyl or sulfonyl, and combinations thereof. In some embodiments, Q₁ is a straight chain, branched chain, or cycle-containing connecting group (e.g., polyvalent group) selected from arylene, aralkylene, and alkarylene. In yet other embodiments, Q₁ is a straight chain, branched chain, or cycle-containing connecting group containing heteroatoms such as O, N, and S and/or a heteroatom containing functional group such as carbonyl and sulfonyl. In other embodiments, Q₁ is a branched or cycle-containing alkylene group that optionally contains heteroatoms selected from O, N, S, and/or a heteroatom-containing functional group such as carbonyl and sulfonyl.

Examples of the diol (meth)acrylate include, glycerol-2-methacrylate (1,3-bis hydroxy-propyl-2-methacrylate), 2,3-Dihydroxypropyl methacrylate, glycerin mono(meth)acrylate, trimethylolpropane monoacrylate (shown in the structure below), and

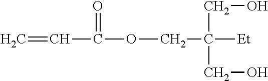

trimethylolpropane monomethacrylate (shown in the structure below),

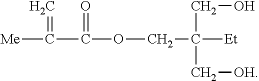

Additional suitable diol (meth)acrylates may be synthesized, for instance an acrylated diol adduct of diethanolamine and isocyanatoethyl methacrylate, an acrylated diol adduct of diethanolamine and isocyanatoethyl acrylate, an acrylated diol adduct of diethanolamine and isocyanatoethoxyethyl methacrylate, and an acrylated diol adduct of ethylene glycol mono-acetoacetate mono-methacrylate and 2-hydroxyethyl acrylate.

### Isocyanate Functional (Meth)Acrylate

In some embodiments, isocyanate functional (meth)acrylates are utilized in the preparation of the urethane (meth)acrylate. In typical embodiments, the isocyanate functional (meth)acrylate is of Formula (VII):

(A)ₚ-Q-NCO (VII);

wherein A and Q are the same as described above with respect to the hydroxy functional (meth)acrylate, and p is 1 or 2.

Examples of the isocyanate functional (meth)acrylates include isocyanatoethyl methacrylate, isocyanatoethoxyethyl methacrylate, isocyanatoethyl acrylate, and 1,1-(bisacryloyloxymethyl) ethyl isocyanate, which are for instance commercially available from Showa Denko (Tokyo, Japan).

### Catalyst

The polymerizable composition optionally comprises a catalyst. Typically, catalyst is included in an amount of 0.01 wt. % to 5 wt. %, based on the total weight of the polymerizable components.

Examples of suitable catalysts include for instance and without limitation, dioctyl dilaurate (DOTDL), stannous octoate, dibutyltin diacetate, dibutyltin dilaurate, dibutyltin mercaptide, dibutyltin thiocarboxylate, dibutyltin dimaleate, dioctyltin mercaptide, dioctyltin thiocarboxylate, lead 2-ethylhexanoate, tetra-alkyl titanates such as tetrabutyl titanate (TBT), triethylamine, N, N-dimethylcyclohexylamine, N-methylmorpholine, N-ethylmorpholine, N, N-dimethyl-p-toluidine, beta-(dimethylamino) propionitrile, N-methylpyrrolidone, N, N-dicyclohexylmethylamine, dimethylaminoethanol, dimethylamino-ethoxyethanol, triethylenediamine, N, N, N′-trimethyl aminoethyl ethanol amine, N, N, N′, N′-tetramethylethylenediamine, N, N, N′, N′-tetramethyl-1,3-diamine, N, N, N′, N′-tetramethyl-1,6-hexanediol-diamine, bis(N, N-dimethylaminoethyl) ether, N′-cyclohexyl-N, N-dimethyl-formamidine, N, N′-dimethylpiperazine, trimethyl piperazine, bis(aminopropyl) piperazine, N—(N, N′-dimethylaminoethyl) morpholine, bis(morpholinoethyl) ether, 1,2-dimethyl imidazole, N-methylimidazole, 1,4-diamidines, diazabicyclo-[2.2.2]-octane (DABCO), 1,4-diazabicyclo [3.3.0]-oct-4-ene (DBN), 1,8-diazabicyclo-[4.3.0]-non-5-ene (DBN), 1,8-diazabicyclo-[5.4.0]-undec-7-ene (DBU), and phenol salts, salts such as octyl acid salts, N, N, N′, N″-pentamethyldiethylenetriamine, N, N, N′, N″-pentamethyl dipropylenetriamine, tetramethylguanidine, N-cyclohexyl-N′, N′, N″, N″-tetramethyl guanidine, N-methyl-N′-(2-dimethyl amino ethyl) piperazine, 1,3,5-tris (N, N-dimethyl-propyl)-hexahydro-1,3,5-triazine.

In any embodiment, the catalyst comprises zinc, an amine, tin, zirconium, or bismuth. The catalyst can comprise tin, such as dibutyltin diacrylate. Preferably, however, the catalyst is free of tin, as tin catalysts may not be desirable to include in orthodontic articles that will be in contact with a patient's mouth.

The catalyst may comprise an organometallic zinc complex that is free of 2-ethylhexyl carboxylate and 2-ethylhexanoic acid, such as the zinc catalyst commercially available from King Industries, Inc. (Norwalk, Conn.) under the trade designation K-KAT XK-672, and/or other zinc catalysts available from King Industries, such as K-KAT XK-661, and K-KAT XK-635. Another suitable catalyst is bismuth neodecanoate, for instance commercially available from Sigma-Aldrich (St. Louis, Mo.), as well as bismuth catalysts available from King Industries under the trade designations K-KAT XK-651 and K-KAT 348. Available aluminum based catalysts include K-KAT 5218 from King Industries. Further, zirconium based catalysts include K-KAT 4205 and K-KAT 6212 available from King Industries.

### Photoinitiator

Photopolymerizable compositions of the present disclosure typically include at least one photoinitiator. Suitable exemplary photoinitiators are those available under the trade designations OMNIRAD from IGM Resins (Waalwijk, The Netherlands) and include 1-hydroxycyclohexyl phenyl ketone (OMNIRAD 184), 2,2-dimethoxy-1,2-diphenylethan-1-one (OMNIRAD 651), bis(2,4,6 trimethylbenzoyl)phenylphosphineoxide (OMNIRAD 819), 1-[4-(2-hydroxyethoxy)phenyl]-2-hydroxy-2-methyl-1-propane-1-one (OMNIRAD 2959), 2-benzyl-2-dimethylamino-1-(4-morpholinophenyl)butanone (OMNIRAD 369), 2-Dimethylamino-2-(4-methyl-benzyl)-1-(4-morpholin-4-yl-phenyl)-butan-1-one (OMNIRAD 379), 2-methyl-1-[4-(methylthio)phenyl]-2-morpholinopropan-1-one (OMNIRAD 907), Oligo[2-hydroxy-2-methyl-1-[4-(1-methylvinyl)phenyl]propanone] ESACURE ONE (Lamberti S.p.A., Gallarate, Italy), 2-hydroxy-2-methyl-1-phenyl propan-1-one (DAROCUR 1173), 2, 4, 6-trimethylbenzoyldiphenylphosphine oxide (OMNIRAD TPO), and 2, 4, 6-trimethylbenzoylphenyl phosphinate (OMNIRAD TPO-L). Additional suitable photoinitiators include for example and without limitation, benzyl dimethyl ketal, 2-methyl-2-hydroxypropiophenone, benzoin methyl ether, benzoin isopropyl ether, anisoin methyl ether, aromatic sulfonyl chlorides, photoactive oximes, and combinations thereof.

In some embodiments, a photoinitiator is present in a photopolymerizable composition in an amount of up to about 5% by weight, based on the total weight of polymerizable components in the photopolymerizable composition. In some cases, a photoinitiator is present in an amount of 0.1 wt. % or more, 0.2 wt. % or more, 0.3 wt. % or more, 0.4 wt. % or more, 0.5 wt. % or more, 0.6 wt. % or more, 0.7 wt. % or more, 0.8 wt. % or more, 0.9 wt. % or more, 1.0 wt. % or more, 1.25 wt. % or more, or 1.5 wt. % or more; and 5 wt. % or less, 4.8 wt. % or less, 4.6 wt. % or less, 4.4 wt. % or less, 4.2 wt. % or less, 4.0 wt. % or less, 3.8 wt. % or less, 3.6 wt. % or less, 3.4 wt. % or less, 3.2 wt. % or less, 3.0 wt. % or less, 2.8 wt. % or less, 2.6 wt. % or less, 2.4 wt. % or less, 2.2 wt. % or less, 2.0 wt. % or less, 1.8 wt. % or less, or 1.6 wt. % or less. Stated another way, the photoinitiator may be present in an amount of about 0.1-5% by weight, 0.2-5% by weight, or 0.5-5% by weight, based on the total weight of the photopolymerizable composition.

Further, a thermal initiator can optionally be present in a polymerizable composition described herein. In some embodiments, a thermal initiator is present in a polymerizable composition or in an amount of up to about 5% by weight, based on the total weight of polymerizable components in the polymerizable composition. In some cases, a thermal initiator is present in an amount of about 0.1-5% by weight, based on the total weight of polymerizable components in the polymerizable composition. Suitable thermal initiators include for instance and without limitation, peroxides such as benzoyl peroxide, dibenzoyl peroxide, dilauryl peroxide, cyclohexane peroxide, methyl ethyl ketone peroxide, hydroperoxides, e.g., tert-butyl hydroperoxide and cumene hydroperoxide, dicyclohexyl peroxydicarbonate, 2,2,-azo-bis(isobutyronitrile), and t-butyl perbenzoate. Examples of commercially available thermal initiators include initiators available from DuPont Specialty Chemical (Wilmington, Del.) under the VAZO trade designation including VAZO 67 (2,2′-azo-bis(2-methybutyronitrile)) VAZO 64 (2,2′-azo-bis(isobutyronitrile)) and VAZO 52 (2,2′-azo-bis(2,2-dimethyvaleronitrile)), and LUCIDOL 70 from Elf Atochem North America, Philadelphia, Pa.

In some embodiments, an initiator comprises a polymer comprising a free-radical photoinitiator group, e.g., a polymer backbone and pendent photoinitiator groups or terminal photoinitiator groups linked by a polymer chain. In some embodiments, an initiator comprises a macromolecule comprising a photoinitiator group, in which the macromolecule typically has a molecular weight of at least 500 g/mole. Such initiators are described in detail in co-owned International Application No. US2018/062074 (Chakraborty et al.).

In certain aspects, the use of more than one initiator assists in increasing the percentage of monomer that gets incorporated into the reaction product of polymerizable components and thus decreasing the percentage of the monomer that remains uncured. In some embodiments, at least one initiator comprises a first free-radical photoinitiator having sufficient absorbance at a first wavelength range; and a second free-radical initiator selected from a second photoinitiator having sufficient absorbance at a second wavelength range, wherein the second wavelength range is different than the first wavelength range, or a thermal free-radical initiator. Such initiator systems are described in detail in co-owned International Application No. US2018/062085 (Chakraborty et al.).

### Additional Components

In some embodiments, the polymerizable composition further comprises one or more side reaction products in addition to the urethane (meth)acrylate. Depending on the selectivity of the catalyst and/or the weight ratios of the components, oligomers of the reactants may be produced. The order of addition of components in preparing the polymerizable composition affects the relative amounts of polymers and oligomers produced in the polymerized reaction product. For instance, adding a diisocyanate to a polycarbonate diol first, followed by adding the monofunctional (meth)acrylate results in a higher ratio of urethane (meth)acrylate to side products such as oligomers, than instead adding the monofunctional (meth)acrylate to the diisocyanate first, followed by adding the polycarbonate diol.

Oligomers having a structure of monofunctional (meth)acrylate monomer-isocyanate-monofunctional (meth)acrylate monomer have been found to be a byproduct of the polymerization reaction of components in certain embodiments. It is possible to purify the urethane (meth)acrylate to remove such side products. Alternatively, additional side products such as oligomers may be added to the polymerized reaction product, particularly when a specific reaction generates a small amount of one or more side products. It has been discovered that some side product components can improve at least one of modulus or extent of crosslinking after the polymerizable composition has been cured.

For example, polymerizable compositions optionally comprise a compound of Formula (III):

(H₂C═C(R₃)C(═O)—X)ₚ-Q-OC(═O)NH—R_{di}—NHC(═O)O-Q-(X—C(═O)C(R₃)═CH₂)ₚ (III)

wherein Q is a polyvalent organic linking group, X is O, S, or NR₄, R₄ is H or alkyl of 1 to 4 carbon atoms, R₃ is a lower alkyl of 1 to 4 carbon atoms or H, p is 1 or 2, and R_{di} is the residue of a diisocyanate as defined above. Typically, the compound of Formula (III) is produced during the polymerization of the a diisocyanate, polycarbonate diol, and a monofunctional (meth)acrylate monomer, as described above. The specific formulation of the components will affect how much of a compound of Formula (III) is made during the polymerization. For instance, the specificity of the catalyst towards catalyzing the formation of the urethane (meth)acrylate can affect the amount of the compound of Formula (III) generated during the polymerization of the components. In certain embodiments, the compound of Formula (III) is added to the polymerizable composition, particularly when a smaller amount of the compound of Formula (III) is produced by the polymerization of components than desired. In any embodiment, the compound may advantageously improve crosslinking during the polymerization reaction, increase the modulus or the polymerization reaction product, or both. Regardless of if the compound of Formula (III) is formed during the polymerization of the components, added separately to the polymerizable composition, or both, in some embodiments the compound of Formula (III) is present in an amount of 0.05 weight percent (wt. %) or greater, based on the weight of the polymerizable composition, 0.1 wt. % or greater, 0.5 wt. % or greater, 1 wt. % or greater, 1.5 wt. % or greater, 2.5 wt. % or greater, 2 wt. % or greater, 3 wt. % or greater, 4 wt. % or greater, 5 wt. % or greater, 6 wt. % or greater, 7 wt. % or greater, 8 wt. % or greater, or 9 wt. % or greater; and 20 wt. % or less, 18 wt. % or less, 16 wt. % or less, 15 wt. % or less, 14 wt. % or less, 12 wt. % or less, or 10 wt. % or less, based on the weight of the polymerizable composition. Stated another way, the compound of Formula (III) may be present in the polymerizable composition in an amount of 0.05 to 20 weight percent (wt. %), 1.5 to 12 wt. %, 2.5 to 12 wt. %, 5 to 15 wt. %, 5 to 12 wt. %, 7 to 15 wt. %, 7 to 12 wt. %, or 5 to 20 wt. %, based on the weight of the polymerizable composition. Optionally, X is O in the compound of Formula (III). In select embodiments, the compound of Formula (III) is of Formula (IV):

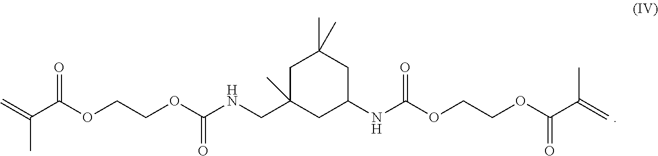 [SMILES: C=C(C)C(=O)OCCOC(=O)NCC1(C)CC(NC(=O)OCCOC(=O)C(=C)C)CC(C)(C)C1]

### Difunctional Component

Polymerizable compositions of the present disclosure optionally include at least one difunctional component, such as a difunctional (meth)acrylate monomer or oligomer. A difunctional component present in a polymerizable composition can co-react with the polyurethane (meth)acrylate (e.g., is capable of undergoing addition polymerization).

A difunctional component (e.g., monomer) is optionally present in an amount of up to 15 wt. %, based on the total weight of the polymerizable composition, up to 12 wt. %, up to 10 wt. %, or up to 8 wt. %, based on the total weight of the polymerizable composition. Including more than 15 wt. % difunctional components may lead to more crosslinking than desired and decrease the elongation of the orthodontic article.

Suitable difunctional monomers include for instance and without limitation, compounds having the Formula (X):

H₂C═C(R₃)C(═O)X-Q-O—C(═O)NH—R_{di}—NHC(═O)—O-Q-XC(═O)C(R₃)═CH₂ (X),

wherein R₃ is as defined for Formula (II) and R_{di} is the residue of a diisocyanate, or compounds having the Formula (XIX):

H₂C═C(R₃)C(═O)—O-Q-NH—C(═O)—(O—R₁—O—C(═O))ₘ—O—R₂—O—C(═O)NH-Q-C(═O)(R₃)C═CH₂ (XIX),

wherein Q, X, and R₃ are as defined for Formula (II) and R₁ and R₂ are as defined for Formula (I). Additional suitable difunctional monomers include hydroxyethyl methacrylate diester of terephthalic acid, 1,12-dodecanediol dimethacrylate, alkoxylated hexanediol diacrylate, alkoxylated neopentyl glycol diacrylate, caprolactone modified neopentylglycol hydroxypivalate diacrylate, caprolactone modified neopentylglycol hydroxypivalate diacrylate, cyclohexanedimethanol diacrylate, diethylene glycol diacrylate, dipropylene glycol diacrylate, ethoxylated (10) bisphenol A diacrylate, ethoxylated (3) bisphenol A diacrylate, ethoxylated (30) bisphenol A diacrylate, ethoxylated (4) bisphenol A diacrylate, hydroxypivalaldehyde modified trimethylolpropane diacrylate, neopentyl glycol diacrylate, polyethylene glycol (200) diacrylate, polyethylene glycol (400) diacrylate, polyethylene glycol (600) diacrylate, propoxylated neopentyl glycol diacrylate, tetraethylene glycol diacrylate, tricyclodecanedimethanol diacrylate, triethylene glycol diacrylate, tripropylene glycol diacrylate, or any combination thereof. Further suitable difunctional monomers include the dimethacrylates of each of the above listed diacrylates.

Typically, the polymerizable compositions are essentially free of trihydric alcohols, which are alcohols having three hydroxyl groups. This is due to such alcohols increasing the hydrophilicity of the polymerizable composition, which may result in an undesirably high water absorption during use of an orthodontic article prepared from the polymerizable composition.

### Additives

Polymerizable compositions described herein, in some instances, further comprise one or more additives, such as one or more additives selected from the group consisting of inhibitors, stabilizing agents, sensitizers, absorption modifiers, fillers and combinations thereof.

In addition, a polymerizable material composition described herein can further comprise one or more sensitizers to increase the effectiveness of one or more photoinitiators that may also be present. In some embodiments, a sensitizer comprises isopropylthioxanthone (ITX) or 2-chlorothioxanthone (CTX). Other sensitizers may also be used. If used in the polymerizable composition, a sensitizer can be present in an amount ranging of about 0.01% by weight or about 1% by weight, based on the total weight of the polymerizable composition.

A polymerizable composition described herein optionally also comprises one or more polymerization inhibitors or stabilizing agents. A polymerization inhibitor is often included in a polymerizable composition to provide additional thermal stability to the composition. A stabilizing agent, in some instances, comprises one or more anti-oxidants. Any anti-oxidant not inconsistent with the objectives of the present disclosure may be used. In some embodiments, for example, suitable anti-oxidants include various aryl compounds, including butylated hydroxytoluene (BHT), which can also be used as a polymerization inhibitor in embodiments described herein. In addition to or as an alternative, a polymerization inhibitor comprises methoxyhydroquinone (MEHQ).

In some embodiments, a polymerization inhibitor, if used, is present in an amount of about 0.001-2% by weight, 0.001 to 1% by weight, or 0.01-1% by weight, based on the total weight of the polymerizable composition. Further, if used, a stabilizing agent is present in a polymerizable composition described herein in an amount of about 0.1-5% by weight, about 0.5-4% by weight, or about 1-3% by weight, based on the total weight of the polymerizable composition.

A polymerizable composition as described herein can also comprise one or more UV absorbers including dyes, optical brighteners, pigments, particulate fillers, etc., to control the penetration depth of actinic radiation. One particularly suitable UV absorber is Tinuvin 326 (2-(5-chloro-2H-benzotriazol-2-yl)-6-(1,1-dimethylethyl)-4-methylphenol, obtained from BASF Corporation, Florham Park, N.J. Another particularly suitable UV absorber that is an optical brightener that is Tinopal OB, a benzoxazole, 2,2′-(2,5-thiophenediyl)bis[5-(1,1-dimethylethyl)], also available from BASF Corporation. Another suitable UV absorber is an optical brightener comprising a compound of the following structure:

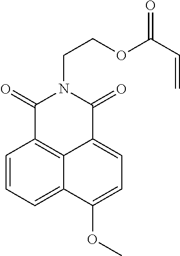 [SMILES: C=CC(=O)OCCN1C(=O)c2cccc3c(OC)ccc(c23)C1=O]

The UV absorber, if used, can be present in an amount of about 0.001-5% by weight, about 0.01-1% by weight, about 0.1-3% by weight, or about 0.1-1% by weight, based on the total weight of the photopolymerizable composition.

Polymerizable compositions may include fillers, including nano-scale fillers. Examples of suitable fillers are naturally occurring or synthetic materials including, but not limited to: silica (SiO₂ (e.g., quartz)); alumina (Al₂O₃), zirconia, nitrides (e.g., silicon nitride); glasses and fillers derived from, for example, Zr, Sr, Ce, Sb, Sn, Ba, Zn, and Al; feldspar; borosilicate glass; kaolin (china clay); talc; zirconia; titania; and submicron silica particles (e.g., pyrogenic silicas such as those available under the trade designations AEROSIL, including “OX 50,” “130,” “150” and “200” silicas from Degussa Corp., Akron, Ohio and CAB-O-SIL M5 and TS-720 silica from Cabot Corp., Tuscola, Ill.). Organic fillers made from polymeric materials are also possible, such as those disclosed in International Publication No. WO09/045752 (Kalgutkar et al.).

The compositions may further contain fibrous reinforcement and colorants such as dyes, pigments, and pigment dyes. Examples of suitable fibrous reinforcement include PGA microfibrils, collagen microfibrils, and others as described in U.S. Pat. No. 6,183,593 (Narang et al.). Examples of suitable colorants as described in U.S. Pat. No. 5,981,621 (Clark et al.) include 1-hydroxy-4-[4-methylphenylamino]-9,10-anthracenedione (FD&C violet No. 2); disodium salt of 6-hydroxy-5-[(4-sulfophenyl)oxo]-2-naphthalenesulfonic acid (FD&C Yellow No. 6); 9-(o-carboxyphenyl)-6-hydroxy-2,4,5,7-tetraiodo-3H-xanthen-3-one, disodium salt, monohydrate (FD&C Red No. 3); and the like.

Discontinuous fibers are also suitable fillers, such as fibers comprising carbon, ceramic, glass, or combinations thereof. Suitable discontinuous fibers can have a variety of compositions, such as ceramic fibers. The ceramic fibers can be produced in continuous lengths, which are chopped or sheared to provide the discontinuous ceramic fibers. The ceramic fibers can be produced from a variety of commercially available ceramic filaments. Examples of filaments useful in forming the ceramic fibers include the ceramic oxide fibers sold under the trademark NEXTEL (3M Company, St. Paul, Minn.). NEXTEL is a continuous filament ceramic oxide fiber having low elongation and shrinkage at operating temperatures, and offers good chemical resistance, low thermal conductivity, thermal shock resistance, and low porosity. Specific examples of NEXTEL fibers include NEXTEL 312, NEXTEL 440, NEXTEL 550, NEXTEL 610 and NEXTEL 720. NEXTEL 312 and NEXTEL 440 are refractory aluminoborosilicate that includes Al₂O₃, SiO₂ and B₂O₃. NEXTEL 550 and NEXTEL 720 are aluminosilica and NEXTEL 610 is alumina. During manufacture, the NEXTEL filaments are coated with organic sizings or finishes which serves as aids in textile processing. Sizing can include the use of starch, oil, wax or other organic ingredients applied to the filament strand to protect and aid handling. The sizing can be removed from the ceramic filaments by heat cleaning the filaments or ceramic fibers as a temperature of 700° C. for one to four hours.

The ceramic fibers can be cut, milled, or chopped so as to provide relatively uniform lengths, which can be accomplished by cutting continuous filaments of the ceramic material in a mechanical shearing operation or laser cutting operation, among other cutting operations. Given the highly controlled nature of certain cutting operations, the size distribution of the ceramic fibers is very narrow and allow to control the composite property. The length of the ceramic fiber can be determined, for instance, using an optical microscope (Olympus MX61, Tokyo, Japan) fit with a CCD Camera (Olympus DP72, Tokyo, Japan) and analytic software (Olympus Stream Essentials, Tokyo, Japan). Samples may be prepared by spreading representative samplings of the ceramic fiber on a glass slide and measuring the lengths of at least 200 ceramic fibers at 10× magnification.

Suitable fibers include for instance ceramic fibers available under the trade name NEXTEL (available from 3M Company, St. Paul, Minn.), such as NEXTEL 312, 440, 610 and 720. One presently preferred ceramic fiber comprises polycrystalline α-Al₂O₃. Suitable alumina fibers are described, for example, in U.S. Pat. No. 4,954,462 (Wood et al.) and U.S. Pat. No. 5,185,299 (Wood et al.). Exemplary alpha alumina fibers are marketed under the trade designation NEXTEL 610 (3M Company, St. Paul, Minn.). In some embodiments, the alumina fibers are polycrystalline alpha alumina fibers and comprise, on a theoretical oxide basis, greater than 99 percent by weight Al₂O₃ and 0.2-0.5 percent by weight SiO₂, based on the total weight of the alumina fibers. In other embodiments, some desirable polycrystalline, alpha alumina fibers comprise alpha alumina having an average grain size of less than one micrometer (or even, in some embodiments, less than 0.5 micrometer). In some embodiments, polycrystalline, alpha alumina fibers have an average tensile strength of at least 1.6 GPa (in some embodiments, at least 2.1 GPa, or even, at least 2.8 GPa). Suitable aluminosilicate fibers are described, for example, in U.S. Pat. No. 4,047,965 (Karst et al). Exemplary aluminosilicate fibers are marketed under the trade designations NEXTEL 440, and NEXTEL 720, by 3M Company (St. Paul, Minn.). Aluminoborosilicate fibers are described, for example, in U.S. Pat. No. 3,795,524 (Sowman). Exemplary aluminoborosilicate fibers are marketed under the trade designation NEXTEL 312 by 3M Company. Boron nitride fibers can be made, for example, as described in U.S. Pat. No. 3,429,722 (Economy) and U.S. Pat. No. 5,780,154 (Okano et al.).

Ceramic fibers can also be formed from other suitable ceramic oxide filaments. Examples of such ceramic oxide filaments include those available from Central Glass Fiber Co., Ltd. (e.g., EFH75-01, EFH150-31). Also preferred are aluminoborosilicate glass fibers, which contain less than about 2% alkali or are substantially free of alkali (i.e., “E-glass” fibers). E-glass fibers are available from numerous commercial suppliers.

Examples of useful pigments include, without limitation: white pigments, such as titanium oxide, zinc phosphate, zinc sulfide, zinc oxide and lithopone; red and red-orange pigments, such as iron oxide (maroon, red, light red), iron/chrome oxide, cadmium sulfoselenide and cadmium mercury (maroon, red, orange); ultramarine (blue, pink and violet), chrome-tin (pink) manganese (violet), cobalt (violet); orange, yellow and buff pigments such as barium titanate, cadmium sulfide (yellow), chrome (orange, yellow), molybdate (orange), zinc chromate (yellow), nickel titanate (yellow), iron oxide (yellow), nickel tungsten titanium, zinc ferrite and chrome titanate; brown pigments such as iron oxide (buff, brown), manganese/antimony/titanium oxide, manganese titanate, natural siennas (umbers), titanium tungsten manganese; blue-green pigments, such as chrome aluminate (blue), chrome cobalt-alumina (turquoise), iron blue (blue), manganese (blue), chrome and chrome oxide (green) and titanium green; as well as black pigments, such as iron oxide black and carbon black. Combinations of pigments are generally used to achieve the desired color tone in the cured composition.

The use of florescent dyes and pigments can also be beneficial in enabling the printed composition to be viewed under black-light. A particularly useful hydrocarbon soluble fluorescing dye is 2,5-bis(5-tert-butyl-2-benzoxazolyl) 1 thiophene. Fluorescing dyes, such as rhodamine, may also be bound to cationic polymers and incorporated as part of the resin.

If desired, the compositions of the disclosure may contain other additives such as indicators, accelerators, surfactants, wetting agents, antioxidants, tartaric acid, chelating agents, buffering agents, and other similar ingredients that will be apparent to those skilled in the art. Additionally, medicaments or other therapeutic substances can be optionally added to the polymerizable compositions. Examples include, but are not limited to, fluoride sources, whitening agents, anticaries agents (e.g., xylitol), remineralizing agents (e.g., calcium phosphate compounds and other calcium sources and phosphate sources), enzymes, breath fresheners, anesthetics, clotting agents, acid neutralizers, chemotherapeutic agents, immune response modifiers, thixotropes, polyols, anti-inflammatory agents, antimicrobial agents, antifungal agents, agents for treating xerostomia, desensitizers, and the like, of the type often used in dental compositions.

Combinations of any of the above additives may also be employed. The selection and amount of any one such additive can be selected by one of skill in the art to accomplish the desired result without undue experimentation.

Photopolymerizable Compositions Comprising a (Meth)Acryl Component and a Polyester Component (e.g., Described in application Ser. No. ______ (Docket No. 81316)):
A suitable photopolymerizable composition comprises:
a) 30-70 parts by weight of monofunctional (meth)acrylate monomer, wherein a cured homopolymer of at least one monofunctional (meth)acrylate monomer has a T_{g} of at least 60° C.; and
b) urethane (meth)acrylate polymer comprising polymerized units of an aliphatic polyester diol.

### Monofunctional (Meth)Acrylate Monomer

In some embodiments, the monofunctional (meth)acrylate monomer comprises a cyclic moiety. Although the cyclic moiety may be aromatic, in typical embodiments, the cyclic moiety is a cycloaliphatic. Suitable monofunctional (meth)acrylate monomers include for instance and without limitation, tetrahydrofurfuiryl methacrylate, 3,3,5-trimethylcyclohexyl (meth)acrylate, butyl-cyclohexyl(meth)acrylate, 2-decahydronapthyl (meth)acrylate, 1-adamantyl (meth)acrylate, dicyclopentadienyl (meth)acrylate, bornyl (meth)acrylate including isobornyl (meth)acrylate, dimethyl-1-adamantyl (meth)acrylate, and 3-tetracyclo[4.4.0.1.1]dodecyl methacrylate.

### Urethane (Meth)Acrylate Polymer

Various polyester urethane (meth)acrylate polymers are commercially available. Other polyester urethane (meth)acrylate polymers can be synthesized. In typical embodiments, aliphatic polyester diols are utilized in the preparation of the polyester urethane (meth)acrylate polymer.

In some embodiments, the polyester diol has Formula (XXIII), as follows:

H[O—R₂₅—O—C(═O)—R₂₆—C(═O)]_{g}—O—R₂₅—OH

wherein R₂₅ and R₂₆ are independently straight or branched chain or cycle-containing alkylene, groups, that optionally include heteroatoms, such as oxygen. R₂₅ and R₂₆ independently comprise 2 to 40 carbon atoms. The subscript “g” is typically at least 2, 3, 4, 5, 6, or 7. The subscript “g” is typically no greater than 50, 45, 40, 35, 30, 25, 20, or 15. In some embodiments, the R₂₅ and R₂₆ are alkylene.

Representative polyester diols include for example neopentyl glycol adipate diol, butane diol adipate diol; 3-methyl-1,5-pentanediol adipate diol; and 3-methyl-1,5-pentanediol sebecate diol, and dimer acid based polyols in which the dimer acid is derived for example from dimerization of two 18 carbon diacids such as linoleic acid.

In some embodiments, such as the diols just described, the polyester diol comprises a single R₂₅ group (e.g. neopentyl or 3-methyl-1,5-pentyl) and a single R₂₆ group (e.g. adipate).

In other embodiments, the aliphatic polyester diol can be prepared from more than one diol and more than one acid. In this embodiment, the diol can contain two or more different R₂₅ groups and two or more different R₂₆ groups such as in the case of ethylene glycol-hexane diol/adipate-azelate copolyester diol.

In some embodiments, each of the R₂₅ and R₂₆ groups of Formula (XXIII) are alkylene groups independently comprising at least 4, 5, or 6 carbon atoms.

The value of g is chosen such that the molecular weight (Mn) of the diol is at least 500, 600, 700, 800, 900, or 1000 g/mole. In some embodiments, the molecular weight (Mn) of the diol is at least 1100, 1200, 1300, 1400, 1500 g/mole. In some embodiments, the molecular weight (Mn) of the diol is at least 1600, 1700, 1800, 1900, or 2000 g/mole. In some embodiments, the molecular weight (Mn) of the diol is no greater than 10,000; 9,000; 8,000; 7,000; 6,000; 5000; 4000; or 3000 g/mole. When the molecular weight is too low the elongation can be insufficient (i.e. less than 15-20%). The value of g can vary widely due to the range of carbons for the R₂₅ and R₂₆ groups.

In one embodied synthetic route, the polyester urethane (meth)acrylate polymer is a reaction product of an aliphatic polyester diol; an (e.g. aliphatic and/or aromatic) diisocyanate, and an (e.g. aliphatic and/or aromatic) hydroxy functional (meth)acrylate.

Such polyester urethane (meth)acrylate polymer can be represented by the following Formula (XX):

(A)ₚ-Q-OC(O)NH—R_{di}—NH—C(O)—[O—R_{dOH}—OC(O)NH—R_{di}—NH—C(O)]ᵣ—O-Q-(A)ₚ (XX)

wherein, A has the formula —OC(═O)C(R₇)═CH₂ wherein R₇ is H or alkyl of 1 (e.g. methyl) to 4 carbon atoms, p is 1 or 2, Q is a polyvalent organic linking group as described above, R_{di} is the residue of a diisocyanate, R_{dOH} is the residue of a polyester polyol, and r averages from 1 to 15. In some embodiments, r is no greater than 15, 14, 13, 12, 11, or 10. In some embodiments, r averages at least 2, 3, 4, or 5. In some embodiments, A is methacrylate.

As evident by such formula, the polyester urethane (meth)acrylate polymer may comprise a central polymerized unit of an aliphatic polyester diol. The aliphatic polyester polymerized unit (derived from the diol) is bonded via urethane linkages formed from one of the isocyanate groups of polymerized units of diisocyanate. The polyester urethane (meth)acrylate polymer comprises terminal groups derived from reaction with a hydroxy functional (meth)acrylate and the opposing isocyanate group of the diisocyanate. When r is 1, the molar ratio of polymerized units of aliphatic polyester diol to polymerized units of diisocyanate is 1:2. When r is a value greater than 1, the molar ratio of polymerized units of aliphatic polyester diol to polymerized units of diisocyanate is 1:greater than 1. For example, when r is 10, the molar ratio of polymerized units of aliphatic polyester diol to polymerized units of diisocyanate is 10:11, or in other words 1:1.1.

One representative reaction product prepared from 2 equivalents of neopentyl glycol adipate based polyester diol, 4 equivalents of isophorone diisocyanate (IPDI), and 2 equivalents of hydroxyl ethyl methacrylate is as follows:

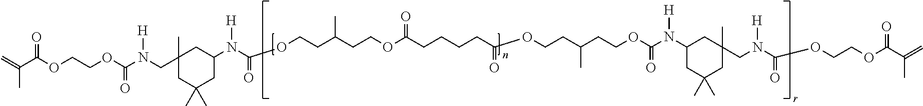

Although the reaction product can have a mixture of polyester urethane (meth)acrylate polymers, wherein r ranges from 1-10 as described above, in some embodiments, the major polyester urethane (meth)acrylate polymer of the above formulas is wherein r=1.

Photopolymerizable compositions comprising a (meth)acryl component (e.g., described in WO 2018/119026 (Parkar et al.)):
A suitable photopolymerizable composition comprises:
(a) 1 to 50 wt. %, inclusive, of a polymer;
(b) 5 to 50 wt. %, inclusive, of a polymerizable component;
(c) 10 to 80 wt. %, inclusive, of atemporary solvent;
(d) 0.1 to 5 wt. %, inclusive, of a photoinitiator; and
(e) an optional inhibitor in an amount of 0.001 to 1 wt. %, inclusive, if present; based on the total weight of the printable composition.

### Polymers

Suitable polymers for component (a) comprise for instance and without limitation, polyethylene (PE), poly(meth)acrylate, polypropylene, polyurethane, sulfopolyester, polycarbonate, polyethylene terephthalate (PET), a thermoplastic fluoropolymer, and combinations thereof. In select embodiments, the polymer comprises poly(meth)acrylate (e.g., poly(methylmethacrylate) (PMMA)).

### Polymerizable Components

Suitable polymerizable components for component (b) contain at least one ethylenically unsaturated bond, and are capable of undergoing addition polymerization. Such free-radically polymerizable materials include mono-, di-, tri-, or other poly-acrylates and methacrylates such as methyl acrylate, methyl methacrylate, ethyl acrylate, isopropyl methacrylate, n-hexyl acrylate, stearyl acrylate, allyl acrylate, glycerol diacrylate, the diurethane dimethacrylate called UDMA (mixture of isomers, e.g., Rohm Plex 6661-0) being the reaction product of 2-hydroxyethyl methacrylate (HEMA) and 2,2,4-trimethylhexamethylene diisocyanate (TMDI), glycerol triacrylate, ethyleneglycol diacrylate, diethyleneglycol diacrylate, triethyleneglycol dimethacrylate, 1,3-propanediol diacrylate, 1,3-propanediol dimethacrylate, trimethylolpropane triacrylate, 1,2,4-butanetriol trimethacrylate, 1,4-cyclohexanediol diacrylate, pentaerythritol triacrylate, pentaerythritol tetraacrylate, pentaerythritol tetramethacrylate, sorbitol hexacrylate, bis[1-(2-acryloxy)]-p-ethoxyphenyldimethylmethane, bis[1-(3-acryloxy-2-hydroxy)]-p-propoxyphenyl-dimethylmethane, and trishydroxyethyl-isocyanurate trimethacrylate; the bis-acrylates and bis-methacrylates of polyethylene glycols of molecular weight 200-500, copolymerizable mixtures of acrylated monomers such as those in U.S. Pat. No. 4,652,274 (Boettcher et al.), and acrylated oligomers such as those of U.S. Pat. No. 4,642,126 (Zador et al.); polyfunctional (meth)acrylates comprising urethane, urea or amide groups, as those of EP2008636 (Hecht et al.). The polymerizable component optionally includes urethane groups, epoxy groups, or both. The polymerizable component also may comprise silicone acrylate oligomers, epoxy (meth)acrylate oligomers, polyester (meth)acrylate oligomers or chlorinated polyester (meth)acrylates, allylic oligomers and (meth)acrylic oligomers. Mixtures of two or more of these free radically polymerizable materials can be used if desired.

Suitable temporary solvents of component (c) include one or more of water, propylene carbonate, methanol, isopropyl alcohol, and tripropylene glycol methyl ether (TPM), ethanol, acetone, ethyl acetate, methyl ethyl ketone, and mixtures thereof.

Photopolymerizable Compositions Comprising a Urethane Component (e.g., Described in PCT Publication No. WO 2019/023009 (Parkar et al.)):
A suitable photopolymerizable composition comprises:
(a) 50 to 90 wt. %, inclusive, of at least one urethane component;
(b) 5 to 50 wt. %, inclusive, of at least one reactive diluent;
(c) 0.1 to 5 wt. %, inclusive, of a photoinitiator; and
(d) an optional inhibitor in an amount of 0.001 to 1 wt. %, inclusive, if present; based on the total weight of the photopolymerizable composition.

### Urethane Component

The “urethane component” of component (a) refers to a compound including one or more carbamate functionalities in the backbone of the compound. In certain embodiments, the carbamate functionality is of Formula (XXIV):

—N(H)—C(O)O— (XXIV).

Urethanes are prepared by the reaction of an isocyanate with an alcohol to form carbamate linkages. Moreover, the term “polyurethane” has been used more generically to refer to the reaction products of polyisocyanates with any polyactive hydrogen compound including polyfunctional alcohols, amines, and mercaptans.

The at least one urethane component often comprises a urethane (meth)acrylate, a urethane acrylamide, or combinations thereof, and wherein the at least one urethane component comprises a linking group selected from alkyl, polyalkylene, polyalkylene oxide, aryl, polycarbonate, polyester, polyamide, and combinations thereof. As used herein, “linking group” refers to a functional group that connects two or more urethane groups. The linking group may be divalent, trivalent, or tetravalent. In select embodiments, the at least one urethane component comprises a urethane (meth)acrylate comprising a polyalkylene oxide linking group, a polyamide linking group, or combinations thereof.

Examples of commercially available urethane components include those available under the trade designations of EXOTHANE 108, EXOTHANE 8, and EXOTHANE 10 from Esstech Inc, and DESMA from 3M Company. DESMA is described in, e.g., paragraph [0135] and Table 3 of EP2167013B1 (Hecht et al.).

### Reactive Diluent

The “reactive diluent,” of component (b) is a component that contains at least one free radically reactive group (e.g., an ethylenically-unsaturated group) that can co-react with the at least one urethane component (e.g., is capable of undergoing addition polymerization). The reactive diluent has a smaller molecular weight than at least one (e.g., high Mn) urethane component, often less than 400 grams per mole, and does not contain any urethane functional groups (e.g., is free of any urethane functional groups).

In select embodiments, the at least one reactive diluent comprises a (meth)acrylate, a polyalkylene oxide di(meth)acrylate, an alkane diol di(meth)acrylate, or combinations thereof, such as a (meth)acrylate. The reactive diluent can comprise one or more poly(meth)acrylates, for example, di-, tri-, tetra- or pentafunctional monomeric or oligomeric aliphatic, cycloaliphatic or aromatic acrylates or methacrylates.

Another suitable class of free radical polymerizable compounds includes aromatic di(meth)acrylate compounds and trifunctional or higher functionality (meth)acrylate compound. Trifunctional or higher functionality meth(acrylates) can be tri-, tetra- or pentafunctional monomeric or oligomeric aliphatic, cycloaliphatic or aromatic acrylates or methacrylates.

In some cases, a reactive diluent comprises diacrylate and/or dimethacrylate esters of aliphatic, cycloaliphatic or aromatic diols, including 1,3- or 1,4-butanediol, neopentyl glycol, 1,6-hexanediol, diethylene glycol, triethylene glycol, tetraethylene glycol, polyethylene glycol, tripropylene glycol, ethoxylated or propoxylated neopentyl glycol, 1,4-dihydroxymethylcyclohexane, 2,2-bis(4-hydroxycyclohexyl)propane or bis(4-hydroxycyclohexyl)methane, hydroquinone, 4,4′-dihydroxybiphenyl, bisphenol A, bisphenol F, bisphenol S, ethoxylated or propoxylated bisphenol A, ethoxylated or propoxylated bisphenol F or ethoxylated or propoxylated bisphenol S. In some cases, a reactive diluent described herein comprises one or more higher functional acrylates or methacrylates such as dipentaerythritol monohydroxy pentaacrylate or bis(trimethylolpropane)tetraacrylate.

Photopolymerizable Compositions Comprising a Urethane Component (e.g., Described in International Application No. PCT/US2018/060014 (Parkar et al.)):
A suitable photopolymerizable composition comprises a blend of:
a) 30 to 70 wt. %, inclusive, of at least one urethane component;
b) 25 to 70 wt. %, inclusive, of at least one monofunctional reactive diluent, wherein the at least one monofunctional reactive diluent comprises at least one monofunctional reactive diluent having a T_{g} of up to but not including 25 degrees Celsius;
c) optionally at least one multifunctional reactive diluent in an amount of 1 to 30 wt. %, inclusive, if present, based on the total weight of the photopolymerizable composition;
d) 0.1 to 5 wt. %, inclusive, of at least one initiator; and
e) an optional inhibitor in an amount of 0.001 to 1 wt. %, inclusive, if present, based on the total weight of the photopolymerizable composition.

### Urethane Component

The urethane component of component (a) may be as summarized above with respect to PCT Publication No. WO 2019/023009 (Parkar et al.)).

### Monofunctional Reactive Diluent

The monofunctional reactive diluent of component (b) has a T_{g} of up to but not including 25° C., 20° C., 15° C., or 10° C. The inclusion of a low T_{g} monofunctional reactive diluent tends to lower the T_{g} of a reaction product of the photopolymerizable composition.

In some embodiments, the at least one monofunctional reactive diluent further comprises a second monofunctional reactive diluent, wherein the second monofunctional reactive diluent has a T_{g} of 25° C. or greater, 30° C. or greater, 35° C. or greater, or 40° C. or greater. The T_{g} may be 80° C. or less. In some embodiments, a balance of physical properties (e.g., strength and elongation at break) can be obtained in a polymerized article when including both a monofunctional reactive diluent having a T_{g} of less than 25° C. and a monofunctional reactive diluent having a T_{g} of 25° C. or greater.

In select embodiments, the (at least one) monofunctional reactive diluent comprises a (meth)acrylate, an alkyl (meth)acrylate, a phenoxy (meth)acrylate, a hydroxy alkyl (meth)acrylate, or a combination thereof. In some preferred embodiments, the monofunctional reactive diluent comprises phenoxy ethyl methacrylate.

Suitable free-radically polymerizable monofunctional diluents include phenoxy ethyl(meth)acrylate, phenoxy-2-methylethyl(meth)acrylate, phenoxyethoxyethyl(meth)acrylate, 3-hydroxy-2-hydroxypropyl(meth)acrylate, benzyl(meth)acrylate, phenylthio ethyl acrylate, 2-naphthylthio ethyl acrylate, 1-naphthylthio ethyl acrylate, 2,4,6-tribromophenoxy ethyl acrylate, 2,4-dibromophenoxy ethyl acrylate, 2-bromophenoxy ethyl acrylate, 1-naphthyloxy ethyl acrylate, 2-naphthyloxy ethyl acrylate, phenoxy 2-methylethyl acrylate, phenoxyethoxyethyl acrylate, 3-phenoxy-2-hydroxy propyl acrylate, 2,4-dibromo-6-sec-butylphenyl acrylate, 2,4-dibromo-6-isopropylphenyl (meth)acrylate, benzyl (meth)acrylate, phenyl (meth)acrylate, tetrahydrofurfuryl (meth)acrylate, alkoxylated tetrahydrofurfuryl acrylate, ethoxylated nonyl phenol (meth)acrylate, alkoxylated lauryl (meth)acrylate, alkoxylated phenol (meth)acrylate, stearyl (meth)acrylate, tetrahydrofurfuryl (meth)acrylate, lauryl (meth)acrylate, isodecyl (meth)acrylate, isooctyl (meth)acrylate, octadecyl (meth)acrylate, tridecyl (meth)acrylate, ethoxylated (4) nonyl phenol (meth)acrylate, caprolactone (meth)acrylate, cyclic trimethylolpropane formal (meth)acrylate, 3,3,5-trimethylcyclohexyl (meth)acrylate, dicyclopentadienyl (meth)acrylate, isobutyl (meth)acrylate, n-butyl (meth)acrylate, ethyl hexyl (meth)acrylate, isobornyl (meth)acrylate, and 2,4,6-tribromophenyl (meth)acrylate.

### Multifunctional Reactive Diluent

The optional multifunctional reactive diluent of component (c) may include di-, tri-, or other poly-acrylates and methacrylates such as glycerol diacrylate, ethoxylated bisphenol A dimethacrylate (D-zethacrylate), tetraethylene glycol dimethacrylate (TEGDMA), polyethyleneglycol dimethacrylate (PEGDMA), glycerol triacrylate, ethyleneglycol diacrylate, diethyleneglycol diacrylate, triethyleneglycol dimethacrylate, 1,3-propanediol diacrylate, 1,3-propanediol dimethacrylate, trimethylolpropane triacrylate, 1,2,4-butanetriol trimethacrylate, 1,4-cyclohexanediol diacrylate, pentaerythritol triacrylate, pentaerythritol tetraacrylate, pentaerythritol tetramethacrylate, sorbitol hexacrylate, bis[1-(2-acryloxy)]-p-ethoxyphenyldimethylmethane, bis[1-(3-acryloxy-2-hydroxy)]-p-propoxyphenyldimethylmethane, and trishydroxyethyl-isocyanurate trimethacrylate; bis-acrylates of polyesters (e.g., methacrylate-terminated polyesters); the bis-acrylates and bis-methacrylates of polyethylene glycols of molecular weight 200-500, copolymerizable mixtures of acrylated monomers such as those in U.S. Pat. No. 4,652,274 (Boettcher et al.), and acrylated oligomers such as those of U.S. Pat. No. 4,642,126 (Zador et al.); polyfunctional (meth)acrylates comprising urea or amide groups, such as those of EP2008636 (Hecht et al.).

The reactive diluent can comprise one or more poly(meth)acrylates, for example, di-, tri-, tetra- or pentafunctional monomeric or oligomeric aliphatic, cycloaliphatic or aromatic acrylates or methacrylates. Another suitable class of free radical polymerizable compounds includes aromatic di(meth)acrylate compounds and trifunctional or higher functionality (meth)acrylate compound. Trifunctional or higher functionality meth(acrylates) can be tri-, tetra- or pentafunctional monomeric or oligomeric aliphatic, cycloaliphatic or aromatic acrylates or methacrylates.

Photopolymerizable Compositions Comprising a Polyalkylene Oxide Component (e.g., Described in International Application No. PCT/IB2019/051815 (Abuelyaman et al.)):
A suitable photopolymerizable composition comprises a blend of:
a) 1 to 80 wt. %, inclusive, of at least one polypropylene oxide component based on the total weight of the photopolymerizable composition, the polypropylene oxide component comprising i) two (meth)acryl groups; ii) one polypropylene oxide segment; and iii) at least two functional groups selected from oxycarbonylamino, oxycarbonyl, amino carbonyloxy, carbonyloxy, amino carbonylamino, aminocarbonyl, carbonylamino, and combinations thereof,
b) optionally 30 wt. % or greater of at least one urethane component, if present, based on the total weight of the photopolymerizable composition; with the proviso that when the at least one urethane component is not present the at least one polypropylene oxide component comprises at least two functional groups selected from oxycarbonylamino, amino carbonyloxy, and combinations thereof,
c) optionally at least one multifunctional reactive diluent in an amount of 1 to 30 wt. %, inclusive, if present, based on the total weight of the photopolymerizable composition;
d) 0.1 to 5 wt. %, inclusive, of at least one initiator; and
e) an optional inhibitor in an amount of 0.001 to 1 wt. %, inclusive, if present, based on the total weight of the photopolymerizable composition.

### Polypropylene Oxide Component

The “polypropylene oxide component” of component (a) refers to a compound including one or more polypropylene glycol functionalities in the backbone of the compound or polymer.

The polypropylene glycol functionality is of the following Formula (XIV):

—CH₂CH(CH₃)O— (XIV).

Various commercially available polypropylene oxide polyol materials are referred to by vendors as polypropylene glycol polyol materials. Polypropylene oxides can be prepared by the ring opening polymerization of propylene oxide, initiated by an alcohol and catalyzed by a base (e.g., potassium hydroxide).

The presence of two (or more) (meth)acryl groups helps ensure that the polypropylene oxide component reacts with at least one other (and preferably two) components of the photopolymerizable composition such that it would not be unreacted and able to leach out of the polymerized product. Optionally, the polypropylene oxide component comprises at least two functional groups selected from oxycarbonylamino, amino carbonyloxy, and combinations thereof. These functional groups act as linkers attaching the (meth)acryl groups to the polypropylene oxide segment. Often, the at least one polypropylene oxide component comprises at least two functional groups selected from oxycarbonylamino, oxycarbonyl, amino carbonyloxy, carbonyloxy, and combinations thereof.

Typically, the polypropylene oxide segment can have a molecular weight of 400 g/mol to 2,000 g/mol, 400 g/mol to 1,300 g/mol, or 1,000 g/mol to 2,000 g/mol.

In many embodiments, the polymerizable component can include at least one polypropylene oxide component of Formula (XXV):

R⁸—R⁹_{f}—[—O—CH₂CH(CH₃)—]ₑO—R⁹_{f}—R⁸ (XXV);

wherein e is an integer in a range of 5 to 70, inclusive (e.g., 5 to 60, 5 to 50, 5 to 40, 5 to 30, 5 to 20, 15 to 40, 15 to 30, or 15 to 20); R⁸ is a monovalent group of Formula (XXVI):

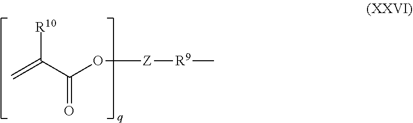

wherein R¹⁰ is selected from H and CH₃; Z is a linking group with a valency of q+1, the linking group containing from 1 to 10 carbon atoms and optionally substituted by at least one of sulfur, nitrogen, and/or oxygen (e.g., examples of Z include linear, cyclic, and/or branched alkylene, with or without substitution of at least one carbon atom by an N, S, or O atom, sulfonyl group, nitro group, carbonyl group, or a combination thereof); q is 1 or 2; and R⁹ is a divalent group of Formula (XXVII), Formula (XXVIII), Formula (XXIX), or Formula (XXX):

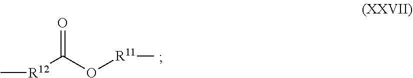

wherein R¹¹ and R¹² are independently selected from an alkylene, a heteroalkylene, an alkenediyl, and a heteroalkenediyl;

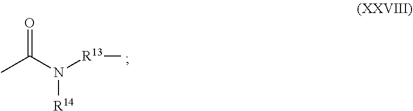

wherein R¹³ is an alkylene or an alkenediyl; and R¹⁴ is H, an alkyl, a heteroalkyl, an alkenyl, or a heteroalkenyl;

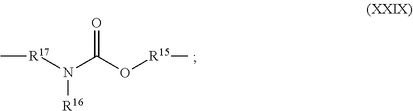

wherein R¹⁵ and R¹⁷ are independently selected from an alkylene, a heteroalkylene, an alkenediyl, and a heteroalkenediyl; and R¹⁶ is H, an alkyl, a heteroalkyl, an alkenyl, or a heteroalkenyl; and

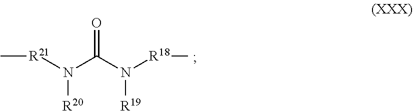

wherein R¹⁸ and R²¹ are independently selected from an alkylene, a heteroalkylene, an alkenediyl, and a heteroalkenediyl; and R¹⁹ and R²⁰ are independently selected from H, an alkyl, a heteroalkyl, an alkenyl, and a heteroalkenyl; f is 0 or 1; and R⁹ is of Formula (XXVII), Formula (XXVIII), Formula (XXIX), or Formula (XXX), wherein the R groups are as defined above for each of Formula (XXVII), Formula (XXVIII), Formula (XXIX), or Formula (XXX). In some select embodiments, f is 0, whereas in other select embodiments, f is 1.

### Urethane Component

The urethane component of component (b) may be as summarized above with respect to PCT Publication No. WO 2019/023009 (Parkar et al.)).

### Multifunctional Component

The optional multifunctional component of component (c) may be as summarized above with respect to International Application No. PCT/US2018/060014 (Parkar et al.)).

### Amide Component

Suitable amide components to include in the photopolymerizable composition include for instance and without limitation, methacrylamide, N-alkyl substituted and N,N-dialkyl substituted acrylamides or methacrylamides where the alkyl group has up to 3 carbons (e.g., N—(C₁-C₃)alkyl-substituted methacrylamide, N,N-di(C₁-C₃)alkyl-substituted acrylamide, N,N-di(C₁-C₃)alkyl-substituted methacrylamide), 2-hydroxyethyl acrylate (HEA), and 2-hydroxy-propyl acrylate (HPA), 4-hydroxybutylacrylate, 2-ethoxyethoxyethyl acrylate, 2-methoxyethoxyethylacrylate, acrylamide (Acm), N-morpholino acrylate (MoA), diacetoneacrylamide, and N-t-octylacrylamide.

### Alkylene Component

Suitable alkylene components to include in the photopolymerizable composition include for instance and without limitation, linear saturated divalent hydrocarbon materials having from one to twelve carbon atoms and branched saturated divalent hydrocarbon radicals having from three to twelve carbon atoms, e.g., methylene, ethylene, propylene, 2-methylpropylene, pentylene, hexylene, and the like.

Polymerizable Compositions Comprising a (Meth)Acryl Component, a Urethane Component, and Optionally at Least One Ethylenically Unsaturated Compound with Acid Functionality (e.g., Described in application Ser. No. ______ (Docket No. 82028)):
A suitable polymerizable composition comprises:

30 to 70 wt. %, inclusive, of at least one urethane component, and

25 to 70 wt. %, inclusive, of reactive diluent(s) comprising at least one monofunctional (meth)acrylate monomer, and

optionally at least one ethylenically unsaturated compound with acid functionality;

wherein the polymerizable resin comprises no greater than 50 wt. % of the reactive diluent(s) having a high affinity for water.

Another suitable polymerizable composition is a free-radically polymerizable resin comprising:

30 to 70 wt. %, inclusive, of at least one urethane component, and

25 to 70 wt. %, inclusive, of reactive diluent(s) comprising at least one monofunctional (meth)acrylate monomer,

wherein the polymerizable resin comprises no greater than 35 wt. % of reactive diluent(s) having a high affinity for water.

The specific components of the polymerizable composition are as described in detail in the application.

### Additional Photoinitiators

In some embodiments, a thermal initiator can optionally be present in a photopolymerizable composition described herein. For instance, a free-radical photoinitiator, a thermal photoinitiator, or a combination thereof may be present in a photopolymerizable composition.

In some embodiments, a photoinitiator is present in a photopolymerizable composition in an amount of up to about 5% by weight, based on the total weight of polymerizable components in the photopolymerizable composition. In some cases, a photoinitiator is present in an amount of about 0.1-5% by weight, 0.2-5% by weight, or 0.5-5% by weight, based on the total weight of the photopolymerizable composition.

In some embodiments, a thermal initiator is present in a photopolymerizable composition or in an amount of up to about 5% by weight, based on the total weight of polymerizable components in the photopolymerizable composition. In some cases, a thermal initiator is present in an amount of about 0.1-5% by weight, based on the total weight of polymerizable components in the photopolymerizable composition. Suitable thermal initiators include for instance and without limitation, peroxides such as benzoyl peroxide, dibenzoyl peroxide, dilauryl peroxide, cyclohexane peroxide, methyl ethyl ketone peroxide, hydroperoxides, e.g., tert-butyl hydroperoxide and cumene hydroperoxide, dicyclohexyl peroxydicarbonate, 2,2,-azo-bis(isobutyronitrile), and t-butyl perbenzoate. Examples of commercially available thermal initiators include initiators available from DuPont Specialty Chemical (Wilmington, Del.) under the VAZO trade designation including VAZO 67 (2,2′-azo-bis(2-methybutyronitrile)) VAZO 64 (2,2′-azo-bis(isobutyronitrile)) and VAZO 52 (2,2′-azo-bis(2,2-dimethyvaleronitrile)), and LUCIDOL 70 from Elf Atochem North America, Philadelphia, Pa.

In some embodiments of compositions including free-radically polymerizable components, the composition contains a first free-radical photoinitiator having sufficient absorbance at a first wavelength range; and a second free-radical initiator selected from a second photoinitiator having sufficient absorbance at a second wavelength range, wherein the second wavelength range is different than the first wavelength range, or a thermal free-radical initiator. Some suitable first free-radical photoinitiators include for instance and without limitation, acyl phosphine oxide and alkyl amine acetophenone. Some suitable second free-radical photoinitiators include for instance and without limitation, photoinitiators comprising photoinitiator groups selected from benzil ketal or hydroxy-acetophenone. Suitable thermal free-radical initiators may include a peroxide or azo group. Additional details regarding such combinations of a first free-radical photoinitiator with either a thermal free-radical initiator or a second free-radical photoinitiator are described in co-owned International Application No. PCT/US2018/062085 (Chakraborty et al.).

In some embodiments of compositions including free-radically polymerizable components, the composition contains a polymer or macromolecule comprising a free-radical photoinitiator group, for instance including a polymer or macromolecule backbone and pendent photoinitiator groups. Suitable photoinitiator groups include for instance and without limitation, a hydroxy or alkyl amino acetophenone photoinitiator. Additional details regarding such polymers and macromolecules comprising a free-radical photoinitiator group are described in co-owned International Application No. PCT/US2018/062074 (Chakraborty et al.).

In certain aspects, the use of more than one initiator assists in increasing the percentage of monomer that gets incorporated into the reaction product of polymerizable components and thus decreasing the percentage of the monomer that remains uncured.

### Orthodontic Articles and Kits

A polymerized reaction product of a photopolymerizable composition according to the above disclosure comprises a shape of an orthodontic article.

In a third aspect, a hydrated orthodontic article is provided. The hydrated orthodontic article is prepared by the methods according to the first aspect or the second aspect, as described in detail above.

In a fourth aspect, another hydrated orthodontic article is provided. The hydrated orthodontic article includes a plurality of layers of at least one photopolymerized polymer in the shape of an orthodontic article; and b) water contained in the hydrated orthodontic article in an amount of 0.2 wt. % or greater, based on the total mass of the hydrated orthodontic article. A sheet of the at least one photopolymerized polymer has a bending modulus when hydrated of 100 MPa or greater and 2200 MPa or less.

In a fifth aspect, a kit is provided. The kit includes a) a container; b) an orthodontic article disposed in the container; and c) instructions for exposing the orthodontic article to water to hydrate the orthodontic article. The instructions typically recommend exposing the orthodontic article to water for 0.5 hours or more, 1, 2, 3, 4, 5, 6, 7, 8, 9, 10, 12, 14, 16, 18, 20, 22, or 24 hours or more; and up to 72 hours, prior to use of the orthodontic article. Hence, a patient can hydrate the orthodontic article prior to inserting the orthodontic article in his or her mouth, for instance immediately prior to using the orthodontic article. The orthodontic article includes a plurality of layers of at least one photopolymerized polymer in the shape of an orthodontic article. The orthodontic article may be as described in detail above with respect to the method of the first and second aspects. A sheet of the at least one photopolymerized polymer has a bending modulus when hydrated of 100 MPa or greater and 2200 MPa or less. In some embodiments, the container comprises a sealed package, for instance to protect the article from exposure to contaminants prior to use. In some embodiments, the container comprises a vent (e.g., at least one air hole). The container is optionally suitable for holding the orthodontic article during the exposure to water to hydrate the orthodontic article.

In a sixth aspect, another kit is provided. The kit includes a) a container; and b) a hydrated orthodontic article disposed in the container, wherein the container is hermetically sealed. The hydrated orthodontic article includes a plurality of layers of at least one photopolymerized polymer in the shape of an orthodontic article. A sheet of the at least one photopolymerized polymer has a bending modulus when hydrated of 100 MPa or greater and 2200 MPa or less. The hermetic seal of the container assists to maintain the level of hydration of the hydrated orthodontic article by minimizing water loss out of the container. In some embodiments, the container is formed of at least one material having a water vapor transmission rate of less than 0.005 cc/m²/day at 50° C. and 100% relative humidity, e.g., a metallized polymeric layer, a metal layer, an inorganic barrier layer, or the like. Water vapor transmission rate can be measured in accordance with ASTM F-1249 at 50° C. and 100% Relative Humidity (RH) using a Water Vapor Transmission Rate (WVTR) tester commercially available from MOCON, Inc., Minneapolis, Minn., under the trade designation “MOCON PERMATRAN-W” Model 700.

The photopolymerized (e.g, crosslinked) polymer for each of the third through sixth aspects is a reaction product of components of a photopolymerizable composition. The components of the photopolymerizable composition are as discussed in detail above. In many embodiments, the photopolymerizable composition is cured (and e.g., crosslinked) using actinic radiation comprising UV radiation, e-beam radiation, visible radiation, or a combination thereof. Moreover, the method optionally further comprises post curing the orthodontic article using actinic radiation.

In certain embodiments, the method comprises vat polymerization of the photopolymerizable composition. When vat polymerization is employed, the radiation may be directed through a wall of a container (e.g., a vat) holding the photopolymerizable composition, such as a side wall or a bottom wall.

A photopolymerizable composition described herein in a cured state, in some embodiments, can exhibit one or more desired properties. A photopolymerizable composition in a “cured” state can comprise a photopolymerizable composition that includes a polymerizable component that has been at least partially polymerized and/or crosslinked. For instance, in some instances, a cured article is at least about 10% polymerized or crosslinked or at least about 30% polymerized or crosslinked. In some cases, a cured photopolymerizable composition is at least about 50%, at least about 70%, at least about 80%, or at least about 90% polymerized or crosslinked. A cured photopolymerizable composition can also be between about 10% and about 99% polymerized or crosslinked.

Fabricating an Orthodontic Appliance with the Photopolymerizable Compositions

The following describes general methods for creating an orthodontic aligner as printed appliance 300. However, other dental and orthodontic articles can be created using similar techniques and the photopolymerizable compositions of the present disclosure. Representative examples include, but are not limited to, the removable appliances having occlusal windows described in International Application Publication No. WO2016/109660 (Raby et al.), the removable appliances with a palatal plate described in US Publication No. 2014/0356799 (Cinader et al); and the resilient polymeric arch members described in International Application Publication Nos. WO2016/148960 and WO2016/149007 (Oda et al.) and US Publication No. 2008/0248442 (Cinader et al.), ceramic articles described in International Application Publication Nos. WO2016/191162 (Mayr et al), and molding techniques and tools for forming a dental restoration in a mouth as described in WO2016/094272 (Hansen et al.) and US Publication No. 2019/0083208 (Hansen et al.). Moreover, the photopolymerizable compositions can be used in the creation of indirect bonding trays, such as those described in International Publication No. WO2015/094842 (Paehl et al.) and US Publication No. 2011/0091832 (Kim, et al.) and other dental articles, including but not limited to crowns, bridges, veneers, inlays, onlays, fillings, and prostheses (e.g., partial or full dentures). Other orthodontic appliances and devices include, but not limited to, orthodontic brackets, buccal tubes, lingual retainers, orthodontic bands, class II and class III correctors, sleep apnea devices, bite openers, buttons, cleats, and other attachment devices.

One particularly interesting implementation of an article is generally depicted in FIG. 3. The additive manufactured article 300 is an orthodontic aligner and is removably positionable over some or all of a patient's teeth. In some embodiments, the appliance 300 is one of a plurality of incremental adjustment appliances. The appliance 300 may comprise a shell having an inner cavity. The inner cavity is shaped to receive and resiliently reposition teeth from one tooth arrangement to a successive tooth arrangement. The inner cavity may include a plurality of receptacles, each of which is adapted to connect to and receive a respective tooth of the patient's dental arch. The receptacles are spaced apart from each other along the length of the cavity, although adjoining regions of adjacent receptacles can be in communication with each other. In some embodiments, the shell fits over all teeth present in the upper jaw or lower jaw. Typically, only certain one(s) of the teeth will be repositioned while others of the teeth will provide a base or anchor region for holding the dental appliance in place as it applies the resilient repositioning force against the tooth or teeth to be treated.

In order to facilitate positioning of the teeth of the patient, at least one of the receptacles may be aligned to apply rotational and/or translational forces to the corresponding tooth of the patient when the appliance 300 is worn by the patient in order to eventually align said tooth to a new desired position. In some particular examples, the appliance 300 may be configured to provide only compressive or linear forces. In the same or different examples, the appliance 300 may be configured to apply translational forces to one or more of the teeth within receptacles.

In some embodiments, the shell of the appliance 300 fits over some or all anterior teeth present in an upper jaw or lower jaw. Typically, only certain one(s) of the teeth will be repositioned while others of the teeth will provide a base or anchor region for holding the appliance in place as it applies the resilient repositioning force against the tooth or teeth to be repositioned. An appliance 300 can accordingly be designed such that any receptacle is shaped to facilitate retention of the tooth in a particular position in order to maintain the current position of the tooth.

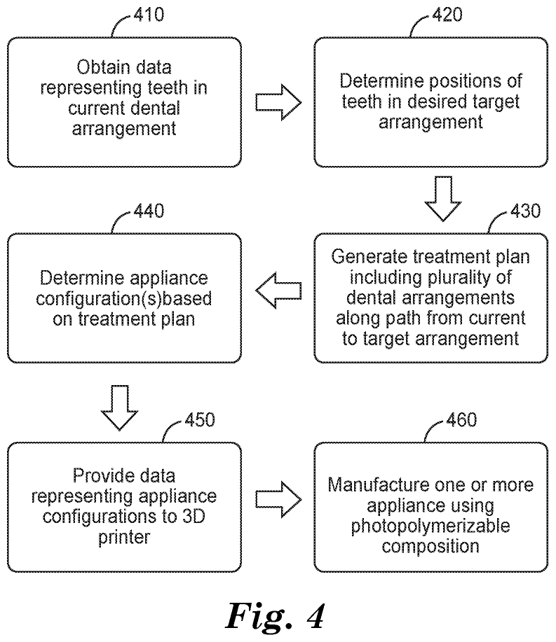

A method 400 of creating an orthodontic appliance using the photopolymerizable compositions of the present disclosure can include general steps as outlined in FIG. 4. Individual aspects of the process are discussed in further detail below. The process includes generating a treatment plan for repositioning a patient's teeth. Briefly, a treatment plan can include obtaining data representing an initial arrangement of the patient's teeth (Step 410), which typically includes obtaining an impression or scan of the patient's teeth prior to the onset of treatment. The treatment plan will also include identifying a final or target arrangement of the patient's anterior and posterior teeth as desired (Step 420), as well as a plurality of planned successive or intermediary tooth arrangements for moving at least the anterior teeth along a treatment path from the initial arrangement toward the selected final or target arrangement (Step 430). One or more appliances can be virtually designed based on the treatment plan (Step 440), and image data representing the appliance designs can exported in STL format, or in any other suitable computer processable format, to an additive manufacturing device (e.g., a 3D printer system) (Step 450). An appliance can be manufactured using a photopolymerizable composition of the present disclosure retained in the additive manufacturing device (Step 460).

In some embodiments, a (e.g., non-transitory) machine-readable medium is employed in additive manufacturing of articles according to at least certain aspects of the present disclosure. Data is typically stored on the machine-readable medium. The data represents a three-dimensional model of an article, which can be accessed by at least one computer processor interfacing with additive manufacturing equipment (e.g., a 3D printer, a manufacturing device, etc.). The data is used to cause the additive manufacturing equipment to create an article comprising a reaction product of a photopolymerizable composition, and the polymerized reaction product of the photopolymerizable composition has a shape of the orthodontic article. Suitable photopolymerizable compositions are as described above.

Data representing an article may be generated using computer modeling such as computer aided design (CAD) data. Image data representing the (e.g., polymeric) article design can be exported in STL format, or in any other suitable computer processable format, to the additive manufacturing equipment. Scanning methods to scan a three-dimensional object may also be employed to create the data representing the article. One exemplary technique for acquiring the data is digital scanning. Any other suitable scanning technique may be used for scanning an article, including X-ray radiography, laser scanning, computed tomography (CT), magnetic resonance imaging (MRI), and ultrasound imaging. Other possible scanning methods are described, e.g., in U.S. Patent Application Publication No. 2007/0031791 (Cinader, Jr., et al.). The initial digital data set, which may include both raw data from scanning operations and data representing articles derived from the raw data, can be processed to segment an article design from any surrounding structures (e.g., a support for the article). In select embodiments, scanning techniques may include, for example, scanning a patient's mouth to customize an orthodontic article for the patient.

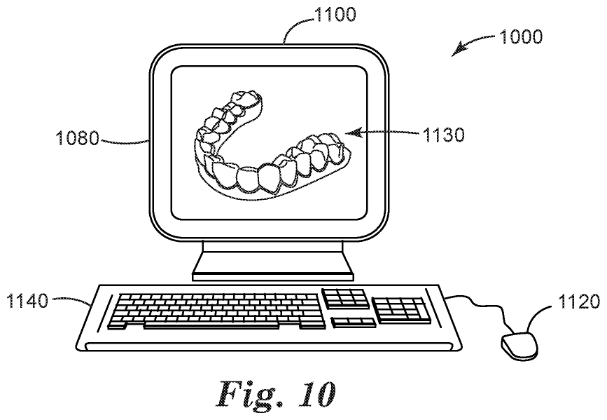

Often, machine-readable media are provided as part of a computing device. The computing device may have one or more processors, volatile memory (RAM), a device for reading machine-readable media, and input/output devices, such as a display, a keyboard, and a pointing device. Further, a computing device may also include other software, firmware, or combinations thereof, such as an operating system and other application software. A computing device may be, for example, a workstation, a laptop, a personal digital assistant (PDA), a server, a mainframe or any other general-purpose or application-specific computing device. A computing device may read executable software instructions from a computer-readable medium (such as a hard drive, a CD-ROM, or a computer memory), or may receive instructions from another source logically connected to computer, such as another networked computer. Referring to FIG. 10, a computing device 1000 often includes an internal processor 1080, a display 1100 (e.g., a monitor), and one or more input devices such as a keyboard 1140 and a mouse 1120. In FIG. 10, an aligner article 1130 is shown on the display 1100.

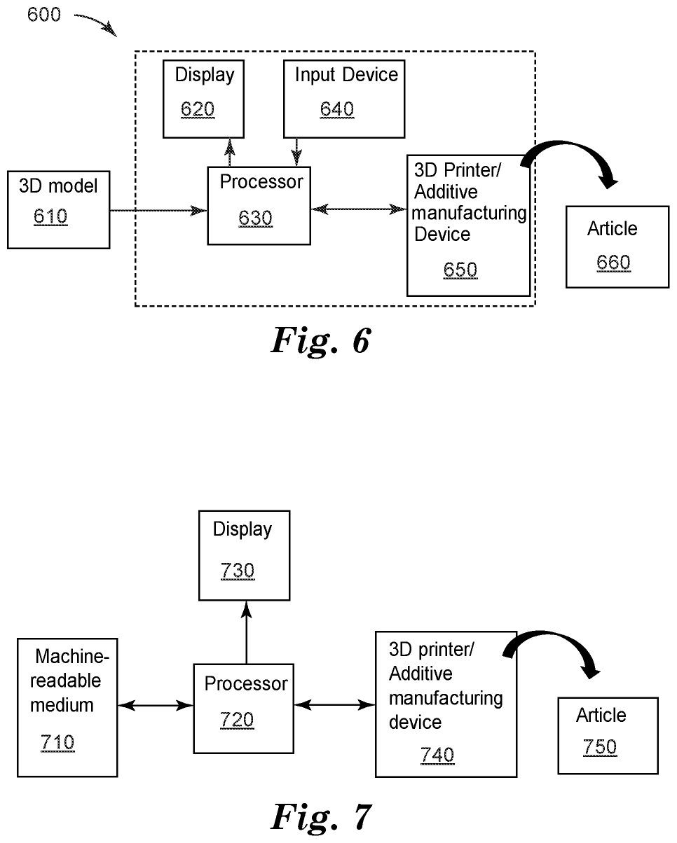

Referring to FIG. 6, in certain embodiments, the present disclosure provides a system 600. The system 600 comprises a display 620 that displays a 3D model 610 of an article (e.g., an aligner 1130 as shown on the display 1100 of FIG. 10); and one or more processors 630 that, in response to the 3D model 610 selected by a user, cause a 3D printer/additive manufacturing device 650 to create a physical object of the article 660. Often, an input device 640 (e.g., keyboard and/or mouse) is employed with the display 620 and the at least one processor 630, particularly for the user to select the 3D model 610. The article 660 comprises a reaction product of a photopolymerizable composition, and the polymerized reaction product of the photopolymerizable composition has a shape of the orthodontic article. Suitable photopolymerizable compositions are as described above.

Referring to FIG. 7, a processor 720 (or more than one processor) is in communication with each of a machine-readable medium 710 (e.g., a non-transitory medium), a 3D printer/additive manufacturing device 740, and optionally a display 730 for viewing by a user. The 3D printer/additive manufacturing device 740 is configured to make one or more articles 750 based on instructions from the processor 720 providing data representing a 3D model of the article 750 (e.g., an aligner article 1130 as shown on the display 1100 of FIG. 10) from the machine-readable medium 710.

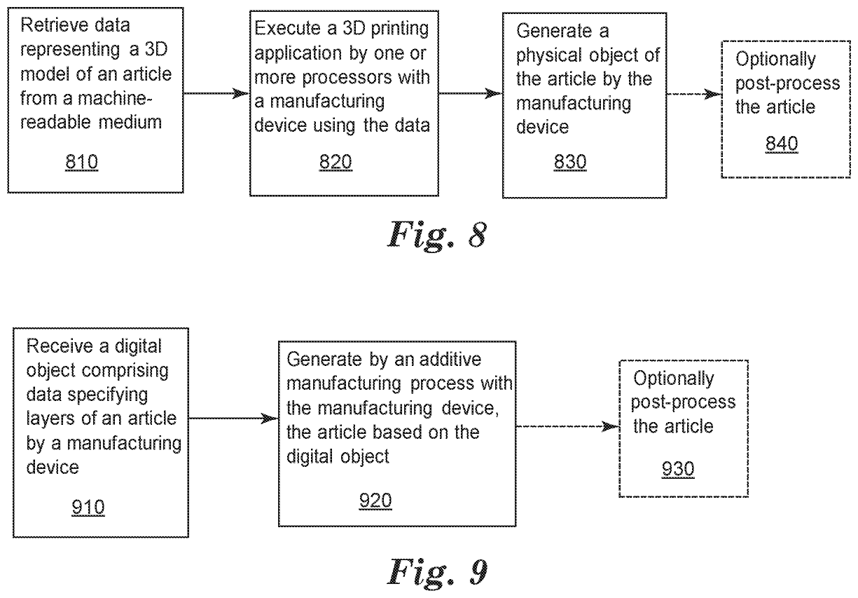

Referring to FIG. 8, for example and without limitation, an additive manufacturing method comprises retrieving 810, from a (e.g., non-transitory) machine-readable medium, data representing a 3D model of an article according to at least one embodiment of the present disclosure. The method further includes executing 820, by one or more processors, an additive manufacturing application interfacing with a manufacturing device using the data; and generating 830, by the manufacturing device, a physical object of the article. The additive manufacturing equipment can selectively cure a photopolymerizable composition to form an article. The article comprises a reaction product of a photopolymerizable composition, and the polymerized reaction product of the photopolymerizable composition has a shape of the orthodontic article. The details of the photopolymerizable composition are as described above. One or more post-processing steps 840 is also undertaken (e.g., exposing the article to water). Typically, remaining unpolymerized photopolymerizable component will be cured.

Additionally, referring to FIG. 9, a method of making an article comprises receiving 910, by a manufacturing device having one or more processors, a digital object comprising data specifying a plurality of layers of an article; and generating 920, with the manufacturing device by an additive manufacturing process, the article based on the digital object. Again, the article undergoes one or more steps of post-processing 930 (e.g., exposing the article to water).

### SELECT EMBODIMENTS OF THE DISCLOSURE

Embodiment 1 is a method of making an orthodontic article. The method includes a) providing a photopolymerizable composition; b) selectively curing the photopolymerizable composition using actinic radiation to form an article in the shape of an orthodontic article having a plurality of layers of at least one photopolymerized polymer; and c) exposing the article to water by submersion in water, thereby hydrating the article. A sheet of the at least one photopolymerized polymer has a bending modulus when hydrated of 100 MPa or greater and 2200 MPa or less.

Embodiment 2 is the method of embodiment 1, wherein the exposing includes contacting the article with an aqueous solution.

Embodiment 3 is the method of embodiment 2, wherein the aqueous solution includes a buffer.

Embodiment 4 is a method of making an orthodontic article. The method includes a) providing a photopolymerizable composition; b) selectively curing the photopolymerizable composition using actinic radiation to form an article in the shape of an orthodontic article having a plurality of layers of at least one photopolymerized polymer; c) exposing the article to water vapor, thereby hydrating the article; and d) hermetically sealing the hydrated orthodontic article in a container. A sheet of the at least one photopolymerized polymer has a bending modulus when hydrated of 100 MPa or greater and 2200 MPa or less

Embodiment 5 is the method of any of embodiments 1 to 4, wherein the hydrated orthodontic article contains 0.2 weight percent (wt. %) or more water, based on the total mass of the hydrated orthodontic article, 0.3 wt. % or more, 0.4 wt. % or more, 0.5 wt. % or more, 0.6 wt. % or more, 0.8 wt. % or more, 1.0 wt. % or more, 2 wt. % or more, 3 wt. % or more, 4 wt. % or more, or 5 wt. % or more, based on the total mass of the hydrated orthodontic article.

Embodiment 6 is the method of embodiment 5, wherein the hydrated orthodontic article contains 8 wt. % or less water, based on the total mass of the hydrated orthodontic article, 7.8 wt. %, 7.6 wt. %, 7.4 wt. %, 7.2 wt. %, 7.0 wt. %, 6.8 wt. %, 6.6 wt. %, 6.4 wt. %, 6.2 wt. %, 6.0 wt. %, 5.8 wt. %, 5.6 wt. %, or 5.4 wt. % or less water, based on the total mass of the hydrated orthodontic article.

Embodiment 7 is the method of any of embodiments 1 to 6, wherein the article is exposed to water for 0.5 hours or more, 1 hour or more, 2 hours or more, 3 hours or more, 4 hours or more 5 hours or more, 6 hours or more, 8 hours or more, 10 hours or more, 12 hours or more, 14 hours or more, 16 hours or more, 18 hours or more, 20 hours or more, 22 hours or more, 24 hours or more, 30 hours or more, or 36 hours or more.

Embodiment 8 is the method of any of embodiments 1 to 7, wherein the article is exposed to water for 72 hours or less, 66 hours or less, 60 hours or less, 54 hours or less, 48 hours or less, or 40 hours or less.

Embodiment 9 is the method of any of embodiments 1 to 8, wherein the article is exposed to water at a temperature of 20° C. or greater, 22° C. or greater, 25° C. or greater, 27° C. or greater, 30° C. or greater, 32° C. or greater, or 35° C. or greater; and 40° C. or less.

Embodiment 10 is the method of any of embodiments 1 to 9, wherein the article is exposed to water at a temperature of 37° C. or 22° C.

Embodiment 11 is the method of any of embodiments 1 to 10, wherein the at least one photopolymerized polymer includes a (meth)acryl polymer.

Embodiment 12 is the method of any of embodiments 1 to 11, wherein the at least one photopolymerized polymer includes a urethane (meth)acryl polymer, a polyalkylene oxide (meth)acryl polymer, a polyalkylene oxide urethane (meth)acryl polymer, a polyester urethane (meth)acryl polymer, a polycarbonate urethane (meth)acryl polymer, a polyamide polymer, or combinations thereof.

Embodiment 13 is the method of any of embodiments 1 to 12, wherein the at least one photopolymerized polymer includes a polycarbonate urethane (meth)acryl polymer.

Embodiment 14 is the method of any of embodiments 1 to 13, prior to step c), further including e) moving the article and thereby generating a mass inertial force in uncured photopolymerizable composition disposed on the article, thereby forming a coating layer of uncured photopolymerizable composition on the article, wherein the mass inertial force is generated using a centrifuge, a shaker, or a mixer that spins along one or more axes.

Embodiment 15 is the method of any of embodiments 1 to 14, prior to step c), further including f) removing excess first composition from the article by washing with at least one solvent.

Embodiment 16 is the method of embodiment 15, wherein the at least one solvent includes propylene carbonate, isopropanol, methanol, di(ethylene glycol) ethyl ether, tripropylene glycol monomethyl ether, diethylene glycol monobutyl ether, a blend of dipropylene glycol monomethyl ether with [2-(2-methoxymethylethoxy)methylethoxy]propanol, or combinations thereof.

Embodiment 17 is the method of any of embodiments 1 to 16, prior to step c), further including g) subjecting the article to actinic radiation to photopolymerize uncured photopolymerizable composition.

Embodiment 18 is the method of any of embodiments 1 to 17, prior to step c), further including h) subjecting the article to heat.

Embodiment 19 is the method of any of embodiments 1 to 18, wherein the photopolymerizable composition includes at least one of a (meth)acryl component, a polyalkylene component, a polyalkylene oxide component, a polyester component, a polycarbonate component, a urethane component, a polyamide component, at least one ethylenically unsaturated compound with acid functionality, or combinations thereof.

Embodiment 20 is the method of any of embodiments 1 to 19, wherein the photopolymerizable composition includes 30-65 parts by weight of monofunctional (meth)acrylate monomer(s), wherein a cured homopolymer of at least one monofunctional (meth)acrylate monomer has a Tg of 30 degrees Celsius (° C.) or greater.

Embodiment 21 is the method of any of embodiments 1 to 20, wherein the hydrated orthodontic article exhibits a bending modulus of 100 megapascals (MPa) or greater and 2200 MPa or less measured at 2% strain at 37° C.

Embodiment 22 is the method of any of embodiments 1 to 21, wherein the hydrated orthodontic article exhibits a percent loss of relaxation modulus of 2% to 70% within 30 minutes when held at 2% strain at 37° C.

Embodiment 23 is the method of any of embodiments 1 to 22, wherein the hydrated orthodontic article exhibits a relaxation modulus of 100 MPa or greater and 2200 MPa or less.

Embodiment 24 is the method of any of embodiments 1 to 23, wherein the hydrated orthodontic article exhibits an elongation at break of 20% or greater or 70% or greater.

Embodiment 25 is the method of any of embodiments 1 to 24, wherein the hydrated orthodontic article exhibits a tensile strength at yield of 14 MPa or greater or 25 MPa or greater.

Embodiment 26 is the method of any of embodiments 1 to 25, wherein a sheet of the at least one photopolymerized polymer has a bending modulus when hydrated of 150 MPa or greater and 2200 MPa or less.

Embodiment 27 is the method of any of embodiments 1 to 26, wherein a water content of the hydrated article reaches a plateau after exposure to water for 20 hours or less, 18 hours, 16 hours, 14 hours, 12 hours 10 hours, 8 hours, 6 hours, or 4 hours or less.

Embodiment 28 is the method of any of embodiments 1 to 27, wherein a sheet of the at least one photopolymerized polymer exhibits a decrease in initial relaxation modulus of 15% or greater from before exposure to water to 2 hours of exposure to water, measured at 2% strain at 37° C.

Embodiment 29 is the method of any of embodiments 1 to 28, wherein the article is free of a water-resistant coating disposed thereon.

Embodiment 30 is the method of any of embodiments 1 to 29, wherein the article having the shape of an orthodontic article is an aligner, a splint, or a retainer.

Embodiment 31 is a hydrated orthodontic article. The hydrated article is prepared by the method of any of embodiments 1 to 30.

Embodiment 32 is a hydrated orthodontic article. The hydrated orthodontic article includes a) a plurality of layers of at least one photopolymerized polymer in the shape of an orthodontic article; and b) water contained in the hydrated orthodontic article in an amount of 0.2 wt. % or greater, based on the total mass of the hydrated orthodontic article. A sheet of the at least one photopolymerized polymer having has a bending modulus when hydrated of 100 MPa or greater and 2200 MPa or less.

Embodiment 33 is the hydrated orthodontic article of embodiment 32, containing 0.3 wt. % or more water, based on the total mass of the hydrated orthodontic article, 0.4 wt. % or more, 0.5 wt. % or more, 0.6 wt. % or more, 0.8 wt. % or more, 1.0 wt. % or more, 2 wt. % or more, 3 wt. % or more, 4 wt. % or more, or 5 wt. % or more, based on the total mass of the hydrated orthodontic article.

Embodiment 34 is the hydrated orthodontic article of embodiment 32 or embodiment 33, containing 8 wt. % or less water, based on the total mass of the hydrated orthodontic article, 7.8 wt. %, 7.6 wt. %, 7.4 wt. %, 7.2 wt. %, 7.0 wt. %, 6.8 wt. %, 6.6 wt. %, 6.4 wt. %, 6.2 wt. %, 6.0 wt. %, 5.8 wt. %, 5.6 wt. %, or 5.4 wt. % or less water, based on the total mass of the hydrated orthodontic article.

Embodiment 35 is the hydrated orthodontic article of any of embodiments 32 to 34, wherein the at least one photopolymerized polymer includes at least one of a (meth)acryl polymer, or a combination thereof.

Embodiment 36 is the hydrated orthodontic article of any of embodiments 31 to 35, wherein the at least one photopolymerized polymer includes a urethane (meth)acryl polymer, a polyalkylene oxide (meth)acryl polymer, a polyalkylene oxide urethane (meth)acryl polymer, a polyester urethane (meth)acryl polymer, a polycarbonate urethane (meth)acryl polymer, a polyamide polymer, or combinations thereof.

Embodiment 37 is the hydrated orthodontic article of any of embodiments 32 to 36, wherein the at least one photopolymerized polymer includes a polycarbonate urethane (meth)acryl polymer.

Embodiment 38 is the hydrated orthodontic article of any of embodiments 32 to 37, wherein the hydrated orthodontic article exhibits a bending modulus of 100 megapascals (MPa) or greater and 2200 MPa or less measured at 2% strain at 37° C.

Embodiment 39 is the hydrated orthodontic article of any of embodiments 32 to 38, wherein the hydrated orthodontic article exhibits a percent loss of relaxation modulus of 2% to 70% within 30 minutes when held at 2% strain at 37° C.

Embodiment 40 is the hydrated orthodontic article of any of embodiments 32 to 39, wherein the hydrated orthodontic article exhibits a relaxation modulus of 100 MPa or greater and 2200 MPa or less.

Embodiment 41 is the hydrated orthodontic article of any of embodiments 32 to 40, wherein the hydrated orthodontic article exhibits an elongation at break of 20% or greater or 70% or greater.

Embodiment 42 is the hydrated orthodontic article of any of embodiments 32 to 41, wherein the hydrated orthodontic article exhibits a tensile strength at yield of 14 MPa or greater or 25 MPa or greater.

Embodiment 43 is the hydrated orthodontic article of any of embodiments 32 to 42, wherein a sheet of the at least one photopolymerized polymer has a bending modulus when hydrated of 150 MPa or greater and 2200 MPa or less.

Embodiment 44 is the hydrated orthodontic article of any of embodiments 32 to 43, wherein a water content of the hydrated article reaches a plateau after exposure to water for 20 hours or less, 18 hours, 16 hours, 14 hours, 12 hours 10 hours, 8 hours, 6 hours, or 4 hours or less.

Embodiment 45 is the hydrated orthodontic article of any of embodiments 32 to 44, wherein a sheet of the at least one photopolymerized polymer exhibits a decrease in bending modulus of 15% or greater from before exposure to water to 0.5 hours of exposure to water, measured at 2% strain at 37° C.

Embodiment 46 is the hydrated orthodontic article of any of embodiments 32 to 45, wherein the article is free of a water-resistant coating disposed thereon.

Embodiment 47 is the hydrated orthodontic article of any of embodiments 32 to 46, wherein the orthodontic article is an aligner, a splint, or a retainer.

Embodiment 48 is a kit. The kit includes a) a container; b) an orthodontic article disposed in the container; and c) instructions for exposing the orthodontic article to water to hydrate the orthodontic article. The orthodontic article includes a plurality of layers of at least one photopolymerized polymer in the shape of an orthodontic article. A sheet of the at least one photopolymerized polymer having a thickness of 1 mm has a bending modulus when hydrated of 100 MPa or greater and 2200 MPa or less.

Embodiment 49 is the kit of embodiment 48, wherein the container includes a sealed package.

Embodiment 50 is the kit of embodiment 48, wherein the container includes a vent.

Embodiment 51 is the kit of any of embodiments 48 to 50, wherein the instructions state to expose the orthodontic article to water for 0.5 hours or more, 1 hour or more, 2 hours or more, 3 hours or more, 4 hours or more 5 hours or more, 6 hours or more, 8 hours or more, 10 hours or more, 12 hours or more, 14 hours or more, 16 hours or more, 18 hours or more, 20 hours or more.

Embodiment 52 is a kit. The kit includes a) a container; and b) a hydrated orthodontic article disposed in the container, wherein the container is hermetically sealed. The hydrated orthodontic article includes a plurality of layers of at least one photopolymerized polymer in the shape of an orthodontic article. A sheet of the at least one photopolymerized polymer has a bending modulus when hydrated of 100 MPa or greater and 2200 MPa or less.

Embodiment 53 is the kit of any of embodiments 48 to 52, wherein the at least one photopolymerized polymer includes a (meth)acryl polymer.

Embodiment 54 is the kit of any of embodiments 48 to 53, wherein the at least one photopolymerized polymer includes a urethane (meth)acryl polymer, a polyalkylene oxide (meth)acryl polymer, a polyalkylene oxide urethane (meth)acryl polymer, a polyester urethane (meth)acryl polymer, a polycarbonate urethane (meth)acryl polymer, a polyamide polymer, or combinations thereof.

Embodiment 55 is the kit of any of embodiments 48 to 54, wherein the at least one photopolymerized polymer includes a polycarbonate urethane (meth)acryl polymer.

Embodiment 56 is the kit of any of embodiments 48 to 55, wherein a water content of the hydrated article reaches a plateau after exposure to water for 20 hours or less, 18 hours, 16 hours, 14 hours, 12 hours 10 hours, 8 hours, 6 hours, or 4 hours or less.

Embodiment 57 is the kit of any of embodiments 48 to 56, wherein the orthodontic article is an aligner, a splint, or a retainer.

### EXAMPLES

Objects and advantages of this disclosure are further illustrated by the following examples, but the particular materials and amounts thereof recited in these examples, as well as other conditions and details, should not be construed to unduly limit this disclosure.

Unless otherwise noted, all parts, percentages, ratios, etc. in the Examples and the rest of the specification are by weight. Table 1 (below) lists materials used in the examples and their sources.

TABLE 1
Materials List

| DESIGNATION | DESCRIPTION | SOURCE |
|---|---|---|
| IBOMA | Isobomyl methacrylate | San Esters Corp., New |
| | | York, NY |
| EXOTH-10 | A urethane (meth)acrylate oligomer | Esstech Inc., Essington, |
| | comprising a polyethylene oxide | PA |
| | diol of about 400 MW, obtained | |
| | under the trade designation | |
| | EXOTHANE-10 | |
| EXOTH-108 | A urethane (meth)acrylate oligomer | Esstech Inc., Essington, |
| | comprising a polytetramethylene | PA |
| | oxide diol of about 650 MW, | |
| | obtained as “EXOTHANE-108” | |
| | from Esstech Inc. | |
| H1188 | A methacrylate terminated | Designer Molecules, Inc., |
| | polyester oligomer, the backbone of | San Diego, CA |
| | which consists of a statistical | |
| | distribution of low molecular | |
| | weight polyester segments; | |
| | additionally containing | |
| | cycloaliphatic dibasic ester residues | |
| | as well as the methacrylate end- | |
| | groups; product ID PEM-665. | |
| IBuMA | Isobutyl methacrylate | TCI America, Portland, OR |
| EHMA | 2-Ethyl hexyl methacrylate | Alfa Aesar, Haverhill, MA |
| PEMA | 2-Phenoxy ethyl methacrylate (“SR | Sartomer, Exton, PA |
| | 340”) | |
| DESMA | Urethane (meth)acrylate | Described in U.S. Pat. No. 8,329,776 |
| | | (Hecht) |
| TEGDMA | Triethylene glycol dimethacrylate | TCI America, Portland, OR |
| TIN OB | 2,5-thiophenediylbis(5-tert-butyl- | BASF, Ludwigshafen, |
| | 1,3-benzoxazole) obtained under | Germany |
| | trade designation TINOPAL OB | |
| TIN-326 | 2-(5-chloro-2H-benzotriazol-2-yl)- | BASF, Ludwigshafen, |
| | 6-(1,1-dimethylethyl)-4- | Germany |
| | methylphenol obtained under the | |
| | trade designation TINUVIN 326 | |
| BHT | 2,6-di-t-butyl-4-methylphenol | Alfa Aesar, Haverhill, MA |
| TPO | 2,4,6- | Chitec Technology, Taipei |
| | trimethylbenzoyldiphenylphosphine | City, Taiwan |
| | oxide photoinitiator obtained under | |
| | the trade designation CHIVACURE | |
| | TPO | |
| C-2050 | A polycarbonate diol of about 2000 | Kuraray Co. Ltd., Tokyo, |
| | MW made with about a 50% (i.e., | Japan. |
| | 5:5) mole ratio of (MPD):(HD), | |
| | obtained as “KURARAY POLYOL | |
| | C-2050” from Kuraray Co. Ltd. | |
| XK-672 | Zn-based catalyst obtained under | King Industries, Norwalk, |
| | the trade designation K-KAT XK- | CT |
| | 672 | |
| HEMA | Hydroxyethyl methacrylate | TCI America, Portland, OR |
| IPDI | Isophorone diisocyanate, equivalent | Covestro LLC, |
| | weight 111.11, molecular weight | Leverkusen, Germany |
| | 222.22 g/mole, obtained under | |
| | trade designation DESMODUR I | |
| EtOH | Ethanol | Spectrum Chemicals, New |
| | | Brunswick, NJ |
| IPA | Isopropyl alcohol | VWR, Radnor, PA |
| Propylene carbonate | Propylene carbonate | Alfa Aesar, Haverhill, MA |

### Test Methods

Additive Manufacturing of Articles from the Formulated Resin

Polymerizable compositions PE-3, PE-4, PE-5, and PE-6 were photopolymerized on the Asiga Max printer with a LED light source of 385 nm. A stereolithography file format (STL file) of the aligner was loaded into the Asiga Composer software, and support structures were generated. Additionally, in separate prints, 3-point bend rectangular dynamic mechanical analysis (DMA) bars according to ASTM E328-13 (2013), having dimensions of 25.4 mm×9.5 mm×1 mm were prepared. The resin bath of the printer was heated to 40° C. for some resins before photopolymerization to reduce the viscosity to be able to manufacture the article. The following settings were used for the printing: slice thickness=50 μm; burn in layers=1. Additional printing parameters are in Table 2 below. The printed parts were washed using propylene carbonate followed by isopropanol to remove unreacted resin. The printed specimens were then post-cured using a CLEARSTONE 3200 post-curing UV-chamber (including 365 nm, 385 nm, 405 nm LEDs—all of them switched on) for 15 minutes on each side, or 5 min each side for DMA bars. The printed specimens were then heated in an oven at 100° C. for 30 minutes.

TABLE 2
Printer settings

| | | | Separation | |
|---|---|---|---|---|
| | Exposure | Burn-in | Velocity | Temperature |
| Example | Time (sec) | Time (sec) | (mm/min) | (° C.) |
| PE-3 | 3 | 8 | 1.5 | 40 |
| PE-4 | 3.5 | 10 | 2 | 40 |
| PE-5 | 6 | 15 | 2 | rt |
| PE-6 | 4.5 | 12 | 1.5 | 40 |

### General Procedure for Water Uptake Measurement

Aligner articles were first placed in a sealed desiccator with fresh desiccant (DRIERITE, obtained from W.A. Hammond Drierite Co., Ltd., Xenia, Ohio) for 40 hours. The articles were then weighed on a balance before being placed in a glass jar containing approximately 10 mL of deionized water. Within the jar, the articles were placed on a metal mesh keeping them about 5 mm above the water surface. The jars were then sealed and kept at room temperature. At 0.5, 1, 2, 4, 17, and 40 hour timepoints, the aligners were removed from the jar, weighed on a balance to record a hydrated mass, and returned to their jar. After hydration, the articles were returned to the sealed desiccator for 68 hours before a final dry mass measurement was taken. Water uptake was calculated as:

$$\% Water Uptake = \frac{( final hydrated mass - final dry mass )}{final dry mass} * 100$$

The results are shown in Table 4.

### General Procedure for the Determination of Relaxation Modulus Using Dynamic Mechanical Analysis

DMA 3-point bend rectangular specimens were tested in a TA Instruments Q800 DMA (New Castle, Del.) equipped with a submersion 3-point bending clamp. Samples designated “dry” were tested with no preconditioning within an empty 3-point bend submersion clamp. Samples designated “wet” were conditioned in de-ionized (DI) water for 48 hours at room temperature prior to testing and were tested within a water-filled 3-point bend submersion clamp. After placing the specimens in the submersion clamp, the samples were allowed to equilibrate for 10 minutes at 37° C. After equilibration, a 2% strain was applied and data collection began.

For the data in Table 5, a bending modulus was measured using TA Advantage software, which was the initial modulus measured during a 30 minute long stress relaxation test.

For the data in Table 6, relaxation modulus was measured for 14.2 hours using TA Advantage software. The first data point collected is the bending modulus and the final data point collected at 14.2 hours is the relaxation modulus at 14.2 hours. The percent difference between wet relaxation modulus and the initial dry bending modulus (termed Percent difference from dry bending modulus) was calculated in the following way:

$$\% difference from dry bending modulus = \frac{dry bending modulus - wet relaxation modulus}{dry bending modulus} * 100$$

### General Procedure for Sorption Analysis

A TA Instruments Q5000SA Dynamic Vapor Sorption Analyzer was utilized to measure moisture uptake of the materials by weight percent over time under controlled conditions of temperature and humidity. The specimens were taken from rectangular printed samples and were approximately 4-5 mm square x 0.5 mm thick and ranging in weight from 13-18 milligrams each. The samples were equilibrated at 5% relative humidity (RH) for 40 hours followed by a hydration step of 95% RH for 40 hours at 37° C. The weight percent increase based on hydration, calculated from the end of the 5% equilibration step, is reported in Table 4.

### EXAMPLES

### Preparative Example 1 (PE-1)

Synthesis of PE-1 was prepared as follows. A 12 L three-necked round-bottom flask was charged with 55° C. oven-heated 2198.4 g C-2050 (2.233 eq, 984.2 hydroxide equivalent weight (OH EW)), 496.37 g IPDI (4.467 eq), 1.20 g BHT (400 ppm), and 0.75 XK-672 (250 ppm). The reaction was heated under dry air to an internal setpoint of 105° C. (temperature reached 116° C. at about 37 minutes). At 40 minutes 305.23 g HEMA (2.3545 eq, 130.14 MW, a 5% excess) was added via an addition funnel at a steady rate over 1 hour and 3 minutes. The reaction was heated for an additional 5 hours at 105° C., then an aliquot was checked by Fourier transform infrared spectroscopy (FTIR) and found to have no —NCO peak at 2265 cm-1 and the product was isolated as a clear, viscous material.

### Preparative Example 2 (PE-2)

Synthesis of PE-2 was prepared as follows. A 5 liter (L) three-necked round-bottom flask was charged with 1475.3 g P-2010 (1.462 eq, 1009 EW), heated to about 45° C., then were added 324.9 g IPDI (2.924 eq), 0.8 g BHT, and 0.5 g XK-672. The reaction was heated under dry air to an internal setpoint of 100° C. (temperature reached at about 50 min). At 1 hour, 199.8 g HEMA (1.535 eq) was added via an addition funnel at a steady rate over 30 minutes. The reaction was heated for about an additional 5 hours at 100° C., then an aliquot was checked by Fourier transform infrared spectroscopy (FTIR) and found to have no —NCO peak at 2265 cm-1 and the product was isolated as a clear, viscous material.

### Preparative Examples 3 to 6 (PE-3 to PE-6)

Each formulation was prepared by weighing the components (indicated in Table 3) into an amber jar, followed by rolling each amber jar on a roller (having the trade designation “OLDE MIDWAY PRO18” and manufactured by Olde Midway) at 60° C. until mixed.

TABLE 3
Formulations (parts by weight)

| Example | PE-3 | PE-4 | PE-5 | PE-6 |
|---|---|---|---|---|
| PE-1 | 50 | | | |
| PE-2 | | 50 | | |
| EXOTH-10 | | | 40 | |
| EXOTH-108 | | | | 70 |
| H1188 | | | 10 | |
| DESMA | | | | 5 |
| TEGDMA | | | | 25 |
| IBOMA | 50 | 50 | | |
| IBuMA | | | 16.7 | |
| EHMA | | | 16.7 | |
| PEMA | | | 16.7 | |
| TPO | 2 | 2 | 2 | 0.5 |
| BHT | 0.025 | 0.025 | 0.025 | 0.05 |
| TIN OB | | | | 0.05 |
| TIN 326 | 0.025 | 0.025 | | |

### EXAMPLES (EX) AND COMPARATIVE EXAMPLES (CE)

DMA bars and orthodontic articles were additively manufactured and tested as described in detail above. Results are provided in Tables 4-6 below.

### Examples 1-3 (EX-1 to EX-3) and Comparative Examples 1-2 (CE-1 and CE-2)

These aligner article examples consisted of formulations PE-3, PE-4, PE-5, PE-6, and PETg, and were hydrated according to the GENERAL PROCEDURE FOR WATER UPTAKE MEASUREMENT.

### Example 4 (EX-4)

This aligner article example consisted of formulation PE-3 that was hydrated according to the GENERAL PROCEDURE FOR WATER UPTAKE MEASUREMENT, except submerging in phosphate-buffered saline solution (PBS, diluted to 1× from 10× stock, pH=7.4) rather than hydrating with water vapor. When removed from the water for mass measurements, the aligner articles were first centrifuged at 2000 RPM for 1 minute in a Beckman Coulter AVANTI J-20 XP instrument to remove excess solution, then weighed.

### Example 5-7 (EX-5 to EX-7)

These aligner article examples consisted of formulations PE-3, PE-4, and PE-5, respectively, and were all hydrated according to the GENERAL PROCEDURE FOR WATER UPTAKE MEASUREMENT, except submerging in liquid deionized (DI) water rather than hydrating with water vapor. When removed from the water for mass measurements, the aligner articles were first centrifuged at 2000 RPM for 1 minute in a Beckman Coulter AVANTI J-20 XP instrument to remove excess water, then weighed.

### Example 8 (EX-8)

This aligner article example consisted of formulation PE-3 and was hydrated according to the GENERAL PROCEDURE FOR SORPTION ANALYSIS.

### Comparative Example 2 (CE-2)

This aligner article example consisted of commercially available DURAN PET-G manufactured by Scheu-Dental GmbH (Iserlohn, Germany) and obtained from Great Lakes Orthodontics (Tonawanda, N.Y.). The 0.75 mm thick film was formed into an aligner article on a BIOSTAR VI pressure moulding machine (Scheu-Dental GmbH, Iserlohn, Germany). To thermoform, a 125 mm diameter piece of film was heated for 25 seconds and then then pulled down over a rigid-polymer arch model. The BIOSTAR chamber behind the film was pressurized to 90 psi (0.62 MPa) for 60 seconds of cooling time, after which the chamber was vented to ambient pressure and the formed aligner and arch model were removed from the instrument. Excess film was trimmed from the aligner using a Nakanishi Sonic Cutter (model NE80, Nakanishi Inc., Kanuma City, Japan). Finally, the finished aligner was removed from the arch model.

TABLE 4
Percent water uptake of aligner articles (EX-1 to EX-7 and CE-1 to
CE-2) and from specimens from rectangular printed samples (EX-8)

| Example | Formulation | 0.5 hours | 1 hour | 2 hours | 4 hours | 17 hours | 40 hours |
|---|---|---|---|---|---|---|---|
| EX-1 | PE-3 | 0.61 | 0.71 | 0.82 | 0.95 | 0.96 | 0.96 |
| EX-2 | PE-4 | 1.04 | 1.09 | 1.21 | 1.33 | 1.29 | 1.26 |
| EX-3 | PE-5 | 0.48 | 0.63 | 1.04 | 1.28 | 2.41 | 2.71 |
| EX-4 | PE-3 | 0.59 | 0.81 | 0.99 | 1.24 | 0.94 | 0.82 |
| EX-5 | PE-3 | NM | 0.71 | 0.80 | 0.91 | 0.80 | 0.74 |
| EX-6 | PE-4 | NM | 1.19 | 1.31 | 1.30 | 1.10 | 0.93 |
| EX-7 | PE-5 | NM | 1.32 | 1.74 | 2.27 | 3.58 | 3.5 |
| EX-8 | PE-3 | 0.37 | 0.52 | 0.59 | 0.66 | 0.59 | 0.44 |
| CE-1 | PE-6 | 0.81 | 1.02 | 1.36 | 1.78 | 3.08 | 3.44 |
| CE-2 | PETg | 0.17 | 0.199 | 0.54 | 0.57 | 0.79 | 0.87 |

*NM = not measured

TABLE 5
DMA properties of 1 mm thick films

| | | | Wet |
|---|---|---|---|
| | | | Bending |
| | | | Modulus/ |
| | Dry | Wet | Dry |
| | Bending | Bending | Bending |
| | Modulus | Modulus | Modulus |
| Formulation | (MPa) | (MPa) | (%) |
| PE-3 | 992 | 943 | 95 |
| PE-4 | 736 | 651 | 88 |
| PE-5 | 628 | 171 | 27 |
| PE-6 | 442 | 92 | 21 |
| PE-7 | 758 | 769 | 101 |
| PETg | 2178 | 2140 | 98 |

In Table 6 below, DMA measurements of PE-3 and CE-2 were collected for a duration of 14.2 hours.

TABLE 6
DMA stress relaxation of 1 mm thick films

| | Wet PE-3 | | CE-2 (PETg) | |
|---|---|---|---|---|
| | | % difference | | % difference |
| | Wet relaxation | from Initial | Wet relaxation | from Initial dry |
| Time | modulus | dry modulus | modulus | modulus |
| Hrs | MPa | % | MPa | % |
| 0 | 943 | 4.9 | 2140 | 1.7 |
| 0.5 | 473 | 52.3 | 1574 | 27.7 |
| 1.1 | 408 | 58.9 | 1404 | 35.5 |
| 1.9 | 357 | 64.0 | 1257 | 42.3 |
| 4.7 | 278 | 72.0 | 981 | 55.0 |
| 9.8 | 218 | 78.0 | 754 | 65.4 |
| 14.2 | 193 | 80.5 | 649 | 70.2 |

*Initial dry bending moduli of PE-3 and CE-2 were 992 and 2178 MPa, respectively

All of the patents and patent applications mentioned above are hereby expressly incorporated by reference. The embodiments described above are illustrative of the present invention and other constructions are also possible. Accordingly, the present invention should not be deemed limited to the embodiments described in detail above and shown in the accompanying drawings, but instead only by a fair scope of the claims that follow along with their equivalents.

1. A method of making a hydrated orthodontic article, the method comprising:
a) providing a photopolymerizable composition;
b) selectively curing the photopolymerizable composition using actinic radiation to form an article in the shape of an orthodontic article comprising a plurality of layers of one photopolymerized polymer; and
c) exposing the article to water by submersion in water, thereby hydrating the article, wherein a sheet of the photopolymerized polymer has a bending modulus when hydrated of 100 MPa or greater and 2200 MPa or less.

2. The method of claim 1, wherein the exposing comprises contacting the article with an aqueous solution.

3. A method of making a hydrated orthodontic article, comprising:
a) providing a photopolymerizable composition;
b) selectively curing the photopolymerizable composition using actinic radiation to form an article in the shape of an orthodontic article having a plurality of layers of at least one photopolymerized polymer;
c) exposing the article to water vapor, thereby hydrating the article; and
d) hermetically sealing the hydrated orthodontic article in a container,
wherein a sheet of the at least one photopolymerized polymer has a bending modulus when hydrated of 100 MPa or greater and 2200 MPa or less.

4. The method of claim 1, wherein the hydrated orthodontic article contains 0.2 weight percent (wt. %) or more water, based on the total mass of the hydrated orthodontic article, 0.3 wt. % or more, 0.4 wt. % or more, 0.5 wt. % or more, 0.6 wt. % or more, 0.8 wt. % or more, 1.0 wt. % or more, 2 wt. % or more, 3 wt. % or more, 4 wt. % or more, or 5 wt. % or more, based on the total mass of the hydrated orthodontic article; and 8 wt. % or less water, based on the total mass of the hydrated orthodontic article.

5. The method of claim 1, wherein the article is exposed to water for 0.5 hours or more, 1 hour or more, 2 hours or more, 3 hours or more, 4 hours or more 5 hours or more, 6 hours or more, 8 hours or more, 10 hours or more, 12 hours or more, 14 hours or more, 16 hours or more, 18 hours or more, 20 hours or more, 22 hours or more, 24 hours or more, 30 hours or more, or 36 hours or more.

6. The method of claim 1, prior to step c), further comprising f) removing excess first composition from the article by washing with at least one solvent.

7. The method of claim 1, prior to step c), further comprising g) subjecting the article to actinic radiation to photopolymerize uncured photopolymerizable composition.

8. The method of claim 1, prior to step c), further comprising h) subjecting the article to heat.

9. The method of claim 1, wherein the photopolymerizable composition comprises at least one of a (meth)acryl component, a polyalkylene component, a polyalkylene oxide component, a polyester component, a polycarbonate component, a urethane component, a polyamide component, at least one ethylenically unsaturated compound with acid functionality, or combinations thereof.

10. The method of claim 1, wherein a water content of the hydrated article reaches a plateau after exposure to water for 20 hours or less, 18 hours, 16 hours, 14 hours, 12 hours 10 hours, 8 hours, 6 hours, or 4 hours or less.

11. A hydrated orthodontic article prepared by the method of claim 1.

12. A hydrated orthodontic article comprising:
a) a plurality of layers of one photopolymerized polymer in the shape of an orthodontic article; and
b) water contained in the hydrated orthodontic article in an amount of 0.2 wt. % or greater, based on the total mass of the hydrated orthodontic article, wherein a sheet of the photopolymerized polymer has a bending modulus when hydrated of 100 MPa or greater and 2200 MPa or less.

13. The hydrated orthodontic article of claim 12, wherein the at least one photopolymerized polymer comprises a urethane (meth)acryl polymer, a polyalkylene oxide (meth)acryl polymer, a polyalkylene oxide urethane (meth)acryl polymer, a polyester urethane (meth)acryl polymer, a polycarbonate urethane (meth)acryl polymer, or a polyamide polymer.

14. The hydrated orthodontic article of claim 12, wherein a sheet of the at least one photopolymerized polymer exhibits a decrease in bending modulus of 15% or greater from before exposure to water to 0.5 hours of exposure to water, measured at 2% strain at 37° C.

15. The hydrated orthodontic article of claim 12, wherein the article is free of a water-resistant coating disposed thereon.

16. The hydrated orthodontic article of claim 12, wherein the orthodontic article is an aligner, a splint, or a retainer.

17. A kit comprising:
a) a container;
b) an orthodontic article disposed in the container, the orthodontic article comprising a plurality of layers of one photopolymerized polymer in the shape of an orthodontic article; and
c) instructions for exposing the orthodontic article to water to hydrate the orthodontic article,
wherein a sheet of the photopolymerized polymer has a bending modulus when hydrated of 100 MPa or greater and 2200 MPa or less.

18. The kit of claim 17, wherein the instructions state to expose the orthodontic article to water for 0.5 hours or more, 1 hour or more, 2 hours or more, 3 hours or more, 4 hours or more 5 hours or more, 6 hours or more, 8 hours or more, 10 hours or more, 12 hours or more, 14 hours or more, 16 hours or more, 18 hours or more, or 20 hours or more.

19. A kit comprising:
a) a container; and
b) a hydrated orthodontic article hermetically sealed in the container, the hydrated orthodontic article comprising a plurality of layers of at least one photopolymerized polymer in the shape of an orthodontic article,
wherein a sheet of the at least one photopolymerized polymer has a bending modulus when hydrated of 100 MPa or greater and 2200 MPa or less.
